(19) United States
(12) Patent Application Publication
(10) Pub. No.: US 2012/0325162 A1
(43) Pub. Date: Dec. 27, 2012

(54) FLOORING CHALLENGE SYSTEMS FOR CULLING POULTRY

(75) Inventor: Robert F. Wideman, JR., Fayetteville, AR (US)

(73) Assignee: BOARD OF TRUSTEES OF THE UNIVERSITY OF ARKANSAS, Little Rock, AR (US)

(21) Appl. No.: 13/471,665

(22) Filed: May 15, 2012

Related U.S. Application Data
(60) Provisional application No. 61/499,954, filed on Jun. 22, 2011.

(51) Int. Cl. A01K 29/00

(52) U.S. Cl. 119/713

(57) ABSTRACT

Flooring challenge systems for culling poultry that induce lameness attributable to osteochondrosis and osteomyelitis of the proximal femur and tibia in poultry. The flooring challenge systems induce unstable or insecure footing for poultry reared in pens by adding torque, stress and strain on key leg joints in order to exacerbate and accelerate the development of bacterial chondronecrosis with osteomyelitis lesions and lameness. The flooring challenge systems utilize one or more portable panels or sections that can be constructed in a wide range of sizes and configurations for installation in commercial poultry pens. In addition, the flooring challenge systems may utilize a device suspended a predetermined distance above the apex of the flooring challenge panel to subject the poultry's legs to asymmetric twisting and enhanced instability by forcing the birds to straddle opposing slopes near the apex of the flooring challenge panel.

### CROSS-REFERENCE TO RELATED APPLICATIONS

This application claims priority to U.S. Provisional Application Ser. No. 61/499,954, filed Jun. 22, 2011, which is incorporated herein by reference in its entirety.

### BACKGROUND OF THE INVENTION

1. Field of the Invention

This invention relates generally to flooring challenge systems for culling poultry, and in particular to flooring challenge systems that induce lameness attributable to osteochondrosis and osteomyelitis of the proximal femur and tibia in broiler chickens and the like. The flooring challenge systems induce unstable or insecure footing for poultry reared in pens by adding torque, stress and strain on key leg joints in order to exacerbate and accelerate the development of bacterial chondronecrosis with osteomyelitis lesions and lameness.

2. Description of the Related Art

Broilers having an apparently normal gait nevertheless can exhibit substantial incidences of sub-clinical lesions in the proximal epiphysis (the rounded end of a bone) and metaphysis (the wide portion of the bone adjacent to the epiphysis) of the femur and tibia. The pattern of lesion development is characteristic of osteochondrosis, a group of orthopedic diseases that typically occur in rapidly growing animals. Osteochondrosis is defined as a focal disruption of ossification (mineralization) within the rapidly multiplying columns of chondroblasts and chondrocytes (cartilage cells) in the proximal epiphyseal plate (physis or growth plate), or in the metaphysis. Osteochondrosis has been attributed to a failure of chondrocyte differentiation or maturation, but most evidence points toward an interruption of the blood supply to the epiphysis, followed by localized necrosis (cell death) in the subchondral bone (bone that forms in the epiphyseal plate underlying the articular cartilage). Categories of osteochondrosis lesions include: avascular necrosis of the femoral head (Legg-Calvé-Perthes disease); osteochondrosis latens (lesion restricted to epiphyseal cartilage); osteochondrosis manifesta (includes cartilage lesions and delayed ossification); and, osteochondrosis dissecans (formation of cracks and clefts in the articular cartilage and adjacent bone). Osteochondrosis dissecans is thought to be initiated when deprivation of blood flow to the subchondral bone causes bone cell death (avascular necrosis) that undermines the support for the articular cartilage. The resulting fragmentation (dissection) of both cartilage and bone allows osteochondral fragments to move within the joint, causing focal pain and further damage. Osteochondrosis dissecans occurs in several animal species, and has been attributed to heredity, feeding for forced growth, and selective breeding for increased size.

Early (sub-clinical) osteochondrotic lesions develop in the proximal epiphyses of the femur and tibia of broiler chickens (broilers). These lesions consist of microscopic voids or clefts arising at the boundary between the articular cartilage and the proximal epiphyseal plate. In the femur these voids or clefts appear to expand along the entire surface of the growth plate, rendering the articular cartilage easily detachable from the epiphyseal plate, a condition termed epiphyseolysis or femoral head separation (FHS). Micro-fractures develop in the epiphyseal cartilage and subchondral bone, accompanied by localized necrosis of the adjacent metaphyseal bone. The proximal epiphysis of the tibia also can exhibit microscopic void or cleft formation between the articular cartilage and the proximal epiphyseal plate, but epiphyseolysis typically does not occur in the tibia. Instead, necrosis in the subchondral bone creates voids or holes that are associated with clinical lameness when they extend from the metaphysis into the epiphyseal plate and articular cartilage (tibial head necrosis, THN). Evidently these THN voids undermine the support for the cartilage, resulting in the development of micro-fractures in the epiphyseal plate and subchondral bone. THN voids may develop as isolated pockets or islands of necrosis among the spicules of bone in the metaphysis, or they may be contiguous with the red marrow forming within the core of the diaphysis (main shaft) of the tibia. In this regard, THN lesions may represent pathological sites of focal osteochondrosis within the subchondral and metaphyseal bone, or they may reflect precocious ectopic saltations (extensions) of the red marrow that typically develops more distally in the hollow diaphysis of avian long bones. Regardless, when the THN voids acutely destabilize the epiphyseal plate, then mechanical torque during standing or walking is likely to create micro-fractures that disrupt the cartilage layer.

In the absence of pathogen involvement, the discomfort caused by epiphyseolysis and micro-fracture formation per se may be expressed as clinical lameness in broilers. It has been indicated that the clefts, voids and micro-fracture zones within the proximal epiphyses of the femur and tibia of broilers can serve as niches in which translocated bacteria (bacteria that enter the bloodstream from the respiratory or gastrointestinal tract) can escape adequate surveillance by the immune system and thereby establish proliferating colonies. Indeed gross macroscopic evidence of bacterial infection frequently can be surmised from the presence of caseous exudates in the obviously degenerating proximal femoral and tibial epiphyses of clinically lame broilers. These lesions have been named “Bacterial Chondronecrosis with Osteomyelitis” (BCO, formerly Femoral Head Necrosis or FHN) to acknowledge the presence of osteochondrosis of both the femur (FHN) and the tibia (THN), in combination with the presence of a primary (causative) or secondary (opportunistic) pathogen infection (typically Escherichia coli or Staphylococcus aureus in broilers). Osteomyelitis refers to infection and inflammation of the bone or bone marrow, and can be subclassified on the basis of the causative organism (pyogenic bacteria or mycobacteria), the route, duration and anatomic location of the infection. In general, microorganisms may infect bone through three pathways: via the bloodstream, contiguously from local areas of infection, or via penetrating trauma. Once the bone is infected, leukocytes enter the infected area, and, in their attempt to engulf the infectious organisms, release enzymes that lyse the bone. Pus (caseous exudate) spreads into the blood vessels, impairing blood flow. The vascular architecture renders the tibia, femur, and humerus especially susceptible to osteomyelitis in humans.

The cause(s) of cartilage clefts and void formation in the proximal epiphysis of the femur and tibia of broilers is not currently known. These sub-clinical lesions are detected in relatively few chicks at 7 days of age, but the incidence typically increases dramatically during the ensuing weeks. The most likely cause is inadequate or interrupted blood flow. The possibility also exists that cartilage biochemistry is deranged, or that simple mechanical torque exerted on the elongated column of cartilage cells causes progressive tearing culminating in epiphyseolysis in fast growing birds. Broilers exhibiting the earliest symptoms of lameness typically do not exhibit gross (macroscopic) evidence of osteomyelitis, but if they develop clinical lameness to the point of immobility then BCO including caseous exudates usually is evident upon necropsy. We do not know if the pathogen's role is primary (causative) or secondary (opportunistic).

High incidences of lameness occasionally develop in flocks of rapidly growing commercial broilers. Low incidences of lameness typically are observed in most commercial broiler flocks. Lameness includes all birds that become unwilling or unable to walk due to a variety of innate or induced pathologies affecting their musculoskeletal systems. The primary causes of lameness in commercial broiler flocks are BCO including FHN and THN, as described above. Lameness caused by BCO previously has been difficult to trigger at significant levels in research flocks, thereby hindering the development and testing of prophylactic or therapeutic treatments. Genetic selection for improved resistance to lameness also has been hindered by the absence of a suitable model or methodology for exposing sub-clinical susceptibilities to lameness in elite breeding populations.

It is therefore desirable to provide a flooring challenge system and method for culling poultry, namely for inducing lameness attributable to osteochondrosis and osteomyelitis of the proximal femur and tibia in broiler chickens and the like.

It is further desirable to provide flooring challenge systems to induce unstable or insecure footing for poultry reared in pens by adding torque, stress and strain on key leg joints in order to exacerbate and accelerate the development of bacterial chondronecrosis with osteomyelitis lesions and lameness.

It is still further desirable to provide flooring challenge systems that utilize at least one portable panel or panel sections constructed in a wide range of sizes and configurations (e.g., flat panel, sloping ramp, A-Frame, Speed Bump, etc.) for installation in commercial rearing pens.

It is yet further desirable to provide flooring challenge systems that permit poultry to remain in existing rearing pens and, unlike cage-based systems, permit the birds to exercise and move freely about their pens.

It is yet further desirable to provide flooring challenge systems where the slope of the flooring challenge panel(s) and/or the percentage of the pen floor that is covered with flooring challenge panel(s) versus traditional litter materials can be adjusted to increase or decrease the relative incidence of lameness.

It is yet further desirable to provide flooring challenge systems that provide asymmetric torque (twisting) and shear (lateral/side-to-side) stresses induced by walking on the flooring challenge panel(s) or attempting to stand upright while straddling opposing slopes near the apex of the flooring challenge panel(s).

It is further desirable to provide flooring challenge systems configured so that a device or structure is suspended a predetermined distance above the apex of the flooring challenge panel(s) in order to amplify the challenge imposed on the legs of susceptible poultry.

It is further desirable to provide flooring challenge systems configured with an array of nipple waters, a limbo bar or a pagoda top suspended a predetermined distance above the apex of the flooring challenge panel(s) to cause asymmetric twisting and enhanced instability by forcing the birds to straddle opposing slopes near the apex of the flooring challenge panel(s), such as while attempting to maintain an upright posture with their neck extended to drink from the waterers.

### SUMMARY OF THE INVENTION

In general, in a first aspect, the invention relates to a system for culling poultry. The system comprises a poultry rearing pen at least one flooring challenge panel installed in the rearing pen. The flooring challenge panel is constructed to induce unstable or insecure footing within the rearing pen in order to add torque, stress and strain on key joints of the legs of the poultry reared in the rearing pen. The flooring challenge panel may be portable and/or a flat panel, a sloping ramp, an A-Frame and/or a speed bump. In addition, the flooring challenge panel may be sloped at a predetermined angle in excess of 30%, such as by configuring the flooring challenge panel to have an apex with a height between approximately 6 inches and approximately 12 inches. The flooring challenge panel can further include a framework and a covering. The framework may be any suitable building material, such as wood, metal, plastic and/or fiberglass, and the covering may be metal, plastic, fiberglass, rubber, plastic coated wire, rubber coated wire and/or expanded metal mesh.

The system can further include the rearing pen having at least one feeder and/or at least one waterer installed therein. For example, the feeder may be separated from the waterer in a manner to induce the poultry reared in the pen to traverse over the flooring challenge panel or the waterers may be suspended a predetermined distance above an apex of the flooring challenge panel. In addition, the flooring challenge panel can also include a device or overhanging structure for amplifying the challenge imposed on the legs of the poultry reared in the rearing pen. The device or overhanging structure can be constructed to induce asymmetric twisting torque and lateral/side-to-side shear stresses on key joints of the legs of the poultry reared in the rearing pen. Moreover, the device can be constructed to induce the poultry reared in the rearing pen to stand upright while straddling opposing slopes near the apex of the flooring challenge panel. The device or overhanging structure may be a limbo bar, pagoda top or an array of nipple waterers installed in the rearing pen a predetermined distance above an apex of the flooring challenge panel.

In general, in a second aspect, the invention relates to a flooring challenge system for inducing lameness attributable to osteochondrosis and osteomyelitis of the proximal femur and tibia in poultry. The flooring challenge system includes a poultry rearing pen having at least one poultry attractant, at least one flooring panel installed in the rearing pen, and an overhanging device installed in the rearing pen a predetermined distance above an apex of the flooring panel. The flooring challenge system is constructed to induce unstable or insecure footing within the rearing pen in order to cause asymmetric twisting torque and lateral/side-to-side shear stresses on key joints of the legs of the poultry reared in the rearing pen.

Similarly, the flooring challenge panel may be portable and/or a flat panel, a sloping ramp, an A-Frame and/or a speed bump. In addition, the flooring challenge panel may be sloped at a predetermined angle in excess of 30%, such as by configuring the flooring challenge panel to have an apex with a height between approximately 6 inches and approximately 12 inches. The flooring challenge panel can further include a framework and a covering. The framework may be any suitable building material, such as wood, metal, plastic and/or fiberglass, and the covering may be metal, plastic, fiberglass, rubber, plastic coated wire, rubber coated wire and/or expanded metal mesh.

The poultry attractant may be at least one feeder, at least one waterer or a combination of feeders and waterers. The feeder may be separated from the waterer in a manner to induce the poultry reared in the pen to traverse over the flooring panel and underneath the overhanging device, such as a limbo bar or a pagoda top. Additionally, the overhanging device, such as is an array of waterers, can be constructed to induce the poultry reared in the rearing pen to stand upright while straddling opposing slopes near an apex of the flooring panel.

In general, in a third aspect, the invention relates to a method of culling poultry. The method includes installing at least one flooring challenge panel in an poultry rearing pen, rearing the poultry in the pen with the panel installed therein, inducing lameness attributable to osteochondrosis and osteomyelitis of the proximal femur and tibia in the poultry reared in the pen, and then after a suitable incidence of lameness has been induced, removing the panel from the pen. The method may further include constructing the flooring challenge panel, such as in the configuration of a flat panel, a sloping ramp, an A-Frame or a speed bump. In addition, the relative incidence of lameness induced may be controlled during the method, such as by changing at least a portion of the flooring challenge panel to a sloping angle of about at least 30%.

The method may also inducing the poultry to traverse over the flooring challenge panel installed in the pen and/or installing at least one overhanging device above the flooring challenge panel. A feeder and a waterer may be separated in the pen to induce the poultry to traverse over the panel and underneath the overhanging device installed in the pen. Moreover, an array of nipple waterers may be installed a predetermined distance above an apex of the flooring challenge panel.

Furthermore, a therapeutically effective amount of a probiotic may be administered to the poultry while rearing the poultry in the pen with the flooring challenge panel in order to prevent or attenuate lameness. Similarly, a therapeutically effective amount of an antimicrobial can be administered to the poultry while rearing the poultry in the pen with the flooring challenge panel installed therein in order to prevent or attenuate lameness.

### BRIEF DESCRIPTION OF THE DRAWINGS

FIGS. 1A and 1B illustrate an example of a rearing pen configured with a sloping ramp and floor litter in accordance with an illustrative embodiment of the flooring challenge systems for culling poultry disclosed herein;

FIGS. 2A and 2B illustrate another example of a poultry rearing pen configured with a single flat flooring panel elevated from and covering the entire pen floor in accordance with another illustrative embodiment of the flooring challenge systems disclosed herein;

FIGS. 3A and 3B illustrate yet another example of a rearing pen configured with multiple flat flooring panels placed side by side for covering the entire pen floor in accordance with another illustrative embodiment of the flooring challenge systems disclosed herein;

FIGS. 4A and 4B illustrate still another example of a rearing pen with two flooring panels arranged in an A-Frame configuration covering the entire pen floor in accordance with another illustrative embodiment of the flooring challenge systems disclosed herein;

FIGS. 5A and 5B illustrate another example of a pen with flooring panels covering the entire pen floor, with one panel placed flat and the other panel configured as a sloping ramp in accordance with another illustrative embodiment of the flooring challenge systems disclosed herein;

FIGS. 6A and 6B illustrate another example utilizing a speed bump (modified from the A-Frame configuration shown in FIG. 4) installed in a pen in which the floor is initially covered with traditional wood shavings litter in accordance with another illustrative embodiment of the flooring challenge systems for culling poultry disclosed herein;

FIG. 7a is cross-sectional view of an illustrative embodiment of a speed bump of the flooring challenge systems disclosed herein;

FIG. 7b is a perspective, partial cutaway view of the speed bump shown in FIG. 7b;

FIG. 8 is a graphical representation of comparisons of the cumulative incidences of Kinky Back among the six Line×Treatment groups;

FIG. 9 is a graphical representation of comparisons of the cumulative incidences of Femoral Head Separation & Femoral Head Degeneration (FHS&FHD) among the six Line×Treatment groups;

FIG. 10 is a graphical representation of comparisons of the cumulative incidences of Femoral Head Necrosis (FHN) among the six Line×Treatment groups;

FIG. 11 is a graphical representation of comparisons of the combined cumulative incidences of Femoral Head Separation & Femoral Head Degeneration plus Femoral head necrosis (FHS&FHD+FHN) among the six Line×Treatment groups;

FIG. 12 is a graphical representation of comparisons of the Time Course of lameness attributable to the combined incidences of Femoral Head Separation & Femoral Head Degeneration plus Femoral head necrosis (FHS&FHD+FHN) among the six Line×Treatment groups;

FIG. 13 is a graphical representation of comparisons of the Time Course for all causes of lameness combined among the six Line×Treatment groups on traditional wood shavings litter, ramps, flat floor panels, and the A-Frame configuration;

FIG. 14 is a graphical representation of Time course of lameness (percentage incidence between 14 and 56 days of age) for broilers from two genetic lines (Line C and Line D) that were reared on traditional wood shavings floor litter (Floor Litter), or were reared in pens with flat wire flooring (Line C—Flat Wire Floor, Line D—Flat Wire Floor). The flat wire flooring configuration induced incidences of lameness that were significantly higher (P=0.001) than in the traditional floor litter pens within each line, respectively. Line C was demonstrated to be significantly more susceptible to lameness than Line D;

FIG. 15 illustrates pens with wire flooring (W) alternating with pens with floor litter (L). Chicks from Line B were placed in pens 1 through 11, and chicks from Line D were placed in pens 12 through 22. Within each line, chicks either remained in their original pens through 56 days of age (pens 1, 2, 11, 12, 13, 22), or they were switched reciprocally between wire and litter pens (arrows) at 21, 28, 35 and 42 days of age (as indicated to the right);

FIG. 16A is a graphical representation of the percentage incidences within each diagnostic category for clinically lame broilers from lines B or D, where Twisted=twisted leg (TW) or slipped tendon; TD=tibial dyschondroplasia; Kinky=kinky back (KB) or spondylolisthesis; LAME UNK=cause of lameness could not be determined; THN=tibial head necrosis; FHS=femoral head separation; FHT=femoral head transitional degeneration; FHN=femoral head necrosis; Total Lame=KB+TW+UNK+TD+FHS+FHT+FHN+THN;

FIG. 16B is a graphical representation of the percentage incidences within each of the major diagnostic category for clinically lame broilers from lines B or D, where LAME UNK=cause of lameness could not be determined; THN=tibial head necrosis; FHN=femoral head necrosis; Total Femur Head=FHS+FHT+FHN; Total Bone Necrosis=FHS+FHT+FHN+THN; Total Lame=KB+TW+UNK+TD+FHS+FHT+FHN+THN (as in FIG. 16);

FIG. 17 is a graphical representation of the cumulative percentage incidence of total lameness for broilers from Lines B or D that were constantly on wire flooring (8W) (upper panel) or that were constantly on floor litter (8L) (lower panel);

FIG. 18 is a graphical representation of the cumulative percentage incidence of total lameness for broilers from Line B that were constantly on wire flooring (8W) or floor litter (8L) (upper panel), and for broilers from Line D that were constantly on wire flooring (8W) or floor litter (8L) (lower panel);

FIG. 19 is a graphical representation of cumulative percentage incidence of total lameness for broilers from Line B that started on wire flooring (upper panel), or for broilers from Line B that started on floor litter (lower panel);

FIG. 20 is a graphical representation of cumulative percentage incidence of total lameness for broilers from Line B that started on wire flooring and then were moved to floor litter after weeks 3, 4, 5, or 6 (panels A-D, respectively);

FIG. 21 is a graphical representation of cumulative percentage incidence of total lameness for broilers from Line B that started on floor litter and then were moved to wire flooring after weeks 3, 4, 5, or 6 (panels A-D, respectively);

FIG. 22 is a graphical representation of cumulative percentage incidence of total lameness for broilers from Line D that started on wire flooring (upper panel), or for broilers from Line D that started on floor litter (lower panel);

FIG. 23 is a graphical representation of cumulative percentage incidence of total lameness for broilers from Line D that started on wire flooring and then were moved to floor litter after weeks 3, 4, 5, or 6 (panels A-D, respectively);

FIG. 24 is a graphical representation of cumulative percentage incidence of total lameness for broilers from Line D that started on floor litter and then were moved to wire flooring after weeks 3, 4, 5, or 6 (panels A-D, respectively);

FIG. 25 is a graphical representation of Gait score histogram (5 point Bristol system) for 44 day old broilers from Lines B or D that constantly remained on wire flooring (wire) or on floor litter (litter);

FIG. 26 illustrates the arrangement of 24 pens (10 ft×10 ft) in A364 East. Pens 1, 6, 12, 13, 18 and 24 have flat wire flooring (W). All remaining pens have clean wood shavings litter flooring (L, SB1, SB2, SB3). Beginning at 14 days of age, speed bumps with different slopes (approximately 33%, 50% and 67%) were inserted into the pens marked SB1, SB2 and SB3;

FIG. 27 is a graphical representation of cumulative percentage incidence of total lameness for all lines of broiler and floor treatments;

FIG. 28 is a graphical representation of cumulative percentage incidence of total lameness for broilers from Line M and Line G for floor litter, flat wire flooring and 6 in, 9 in and 12 in speed bumps at Day 57;

FIG. 29 is a graphical representation of the body weight comparisons by broiler line and gender at Day 57;

FIG. 30 is a graphical representation of body weights for female broilers from Line M and Line G for floor litter, flat wire flooring and 6 in, 9 in and 12 in speed bumps at Day 57;

FIG. 31 is a graphical representation of body weights for male broilers from Line M and Line G for floor litter, flat wire flooring and 6 in, 9 in and 12 in speed bumps at Day 57;

FIG. 32 is a graphical representation of the percentage of total lameness through 56 days of age in broilers grown on clean wood shavings litter and fed a control diet (Shavings-Control) or grown on wire flooring and fed: the control diet alone (Wire-Control); the control diet mixed the Biomin PoultryStar® probiotic beginning on day 1 (Wire-Biomin D1); or, the control diet on days 1-27 followed by the control diet mixed with the Biomin PoultryStar® probiotic beginning on day 28 (Wire-Biomin D28). Values with different superscripts differed significantly at P<0.05 using repeated Z-tests to compare all proportions;

FIG. 33 is a flow chart of the diagnostic sequence for clinically lame broilers;

FIG. 34 is a graphical representation of birds that did not develop clinical lameness (25 per each of the 4 treatment groups) that were necropsied on day 56 to evaluate the incidence of sub-clinical macroscopic lesions in proximal femoral and tibial heads. When pooled by diagnostic category independent of treatment group, no tendency was revealed for sub-clinical lesions to form preferentially in either the left or right leg;

FIG. 35 is a graphical representation of birds that did not develop clinical lameness (25 per each of the 4 treatment groups) that were necropsied on day 56 to evaluate the incidence of sub-clinical macroscopic lesions in proximal femoral and tibial heads. Within each diagnostic category, no tendency was revealed for sub-clinical lesions to form preferentially in either the left or right leg, or differentially among the treatment groups;

FIG. 36 is a graphical representation of birds that did not develop clinical lameness (25 per each of the 4 treatment groups) that were necropsied on day 56 to evaluate the incidence of sub-clinical macroscopic lesions in proximal femoral and tibial heads. Regardless of whether the proximal femur head was normal or exhibited femoral head separation (FHS) or femoral head transitional degeneration (FHT), within the same leg (right and left legs combined) the ipsilateral (same-side) proximal tibial head was significantly (Femur Normal, Femur FHS) or numerically (Femur FHT) more likely to remain normal than to exhibit macroscopic indications of THN;

FIG. 37 is a graphical summary of Biomin studies showing the percentage of total lameness through 56 days of age in broilers grown on clean wood shavings litter and fed a control diet (Control Feed+Wood Shavings) or grown on wire flooring and fed: the control diet alone (Control Feed+Wire Flooring); or, the control diet mixed the Biomin PoultryStar® probiotic beginning on day 1 (Probiotic Feed+Wire Flooring). Line C was used in study #1, whereas Line B was used for studies #2 and #3. Values with different superscripts differed significantly at P<0.05 using repeated Z-tests to compare all proportions within an experiment;

FIG. 38 is a graphical summary of Enrofloxacin study. Enrofloxacin is a widely efficacious antimicrobial agent. Incidence of lameness when broilers reared on wire flooring were provided with tap water (Tap Water d 14-34, Tap Water d 55-62) or enrofloxacin in the drinking water (Enrofloxacin d 35-54), and for the entire study combined (Enrofloxacin Total, Tap Water Total);

FIGS. 39A and 39B illustrate an example of a limbo bar speed bump (modified from the speed bump configuration illustrated in FIGS. 6 and 7) installed in a pen in which the floor is initially covered with traditional wood shavings litter in accordance with yet another illustrative embodiment of the flooring challenge systems for culling poultry disclosed herein;

FIG. 40 is a perspective, partial cutaway view of an example of a limbo bar speed bump in accordance with an illustrative embodiment of the flooring challenge systems disclosed herein;

FIGS. 41A and 41B illustrative another example of a flooring challenge systems utilizing a speed bump (speed bump configuration illustrated in FIGS. 6 and 7) installed underneath an array of nipple waterer in a pen in which the floor is initially covered with traditional wood shavings litter;

FIGS. 42A and 42B illustrate an example of a pagoda top speed bump (modified from the speed bump configuration illustrated in FIGS. 6 and 7) installed in a pen in which the floor is initially covered with traditional wood shavings litter in accordance with an illustrative embodiment of the flooring challenge systems disclosed herein;

FIG. 43 is a perspective, partial cutaway view of an example of a pagoda top speed bump in accordance with an illustrative embodiment of the flooring challenge systems disclosed herein;

FIG. 44 illustrates the rearing pen arrangement for Example 6, with pens 1, 6, 12, and 17 having flat wire flooring (W) with all remaining pens having clean wood shavings litter flooring. Pens 2, 7, 13 and 18 had litter flooring (L) throughout the experiment, whereas speed bumps were inserted in the rest of the pens on day 28. Normal 9″ speed bumps (SB9″N) were inserted into pens 3, 8, 14 and 19. A limbo bar was placed over the apex of 9″ (SB9″L) or 12″ (SB12″L) speed bumps in the center of pens 4, 9, 15 and 20. Normal 9″ speed bumps also were placed underneath the nipple waterers (SB9″W) in pens 5, 10, 16 and 21. Pens 11 and 22 had 9″ speed bumps with pagoda tops attached (SB9″P);

FIG. 45 is a graphical representation of lameness incidences by individual pen number, with line and floor treatments identified, where: Wire: flat wire flooring; Litter: wood shavings litter flooring; SB9″: normal 9″ speed bumps; SB9″LB: 9″ speed bumps with a limbo bar; SB9″Water: 9″ speed bumps placed underneath the nipple waterers; SB12″LB: 12″ speed bumps with a limbo bar; and, SB9″Pagoda: 9″ speed bumps with pagoda tops. Within a line across all floor treatments, values with different superscripts differed significantly at P≦0.05 (z-tests were used to compare proportions);

FIG. 46 is a graphical representation of lameness incidences pooled by floor treatment, independent of gender, pen and line, where: Wire: flat wire flooring; Litter: wood shavings litter flooring; SB9″: normal 9″ speed bumps; SB9″LB: 9″ speed bumps with a limbo bar; SB12″LB: 12″ speed bumps with a limbo bar; SB9″Water: 9″ speed bumps placed underneath the nipple waterers; and, SB9″Pagoda: 9″ speed bumps with pagoda tops. Across all floor treatments values with different superscripts differed significantly at P≦0.05 (z-tests were used to compare proportions);

FIG. 47 is a graphical representation of lameness incidences pooled within each line by: All Wire (Flat Wire+Speed Bump pens, combined) vs. All Litter; Flat Wire pens only; or, All Speed Bump pens pooled. All Wire vs. All Litter comparisons: values with different superscripts differed significantly at P≦0.05 (z-tests were used to compare proportions). Flat Wire comparisons between lines: values with different superscripts differed significantly at P≦0.05 (z-tests were used to compare proportions). Speed Bump comparisons between lines: values with different superscripts differed significantly at P≦0.05 (z-tests were used to compare proportions);

FIG. 48 is a graphical representation of the time course of cumulative total lameness from 14 through 55 days of age with all wire flooring treatments (All Wire: flat wire plus speed bumps) pooled by line. Beginning on day 37 and continuing through day 52, the broilers from Line B exhibited significantly more lameness than those from Line A. During the final week when necropsies were halted, the cumulative incidence for Line A began to converge on that of Line B. Values for floor treatments with different superscripts differed significantly at P≦0.05 (z-tests were used to compare proportions);

FIG. 49 are graphical representations of necropsy diagnoses for the proximal femora comparing: Clinically healthy birds by line (upper left panel); Lame birds by line (upper right panel); Healthy vs. Lame in Line A (lower left panel); and, Healthy vs. Lame in Line B (lower right panel. Diagnostic categories include: Normal Femur; FHS=femoral head separation; FHT=femoral head transitional degeneration; FHN=femoral head necrosis; FHS+FHT+FHN=total femoral lesions. Within a panel and category, values with different superscripts differed significantly at P≦0.05 (z-tests were used to compare proportions);

FIG. 50 are graphical representations of necropsy diagnoses for the proximal tibiae comparing clinically healthy birds by line (upper left panel); lame birds by line (upper right panel); healthy vs. lame in Line A (lower left panel); and healthy vs. lame in Line B (lower right panel. Diagnostic categories include: Normal Tibia; THN=mild tibial head necrosis; THNs=severe tibial head necrosis; THNc=caseous tibial head necrosis; TD=tibial dyschondroplasia; THN+THNs+THNc=total tibial lesions. Within a panel and category, values with different superscripts differed significantly at P≦0.05 (z-tests were used to compare proportions); and

FIG. 51 are graphical representations of necropsy diagnoses for the proximal femora (left panel) and proximal tibiae (right panel) comparing all clinically healthy birds vs. all clinically lame birds (lines pooled). Diagnostic categories include: Normal Femur; FHS=femoral head separation; FHT=femoral head transitional degeneration; FHN=femoral head necrosis; FHS+FHT+FHN=total femoral lesions; Normal Tibia; THN=mild tibial head necrosis; THNs=severe tibial head necrosis; THNc=caseous tibial head necrosis; TD=tibial dyschondroplasia; THN+THNs+THNc=total tibial lesions. Within a panel and category, values with different superscripts differed significantly at P≦0.05 (z-tests were used to compare proportions).

Other advantages and features of the flooring challenge systems for culling poultry will be apparent from the following description and from the claims.

### DETAILED DESCRIPTION OF THE INVENTION

The systems and methods discussed herein are merely illustrative of specific manners in which to make and use this invention and are not to be interpreted as limiting in scope.

While the systems and methods have been described with a certain degree of particularity, it is to be noted that many variations and modifications may be made without departing from the spirit and scope of this disclosure. It is understood that the systems and methods are not limited to the embodiments set forth herein for purposes of exemplification.

Flooring challenge systems and methods for culling poultry are disclosed herein. The flooring challenge systems induce broilers chickens and the like to express significantly higher levels of lameness when compared with poultry reared on traditional floor litter (e.g., wood shavings). Specific sub-clinical and clinical lesions in the proximal heads of the femur and tibia correlated with lameness are triggered by the flooring challenge systems. The flooring challenge systems induce lameness attributable to osteochondrosis and osteomyelitis of the proximal femur and tibia in broiler chickens and the like by subjecting poultry reared in pens to unstable or insecure footing by adding torque, stress and strain on key leg joints in order to exacerbate and accelerate the development of bacterial chondronecrosis with osteomyelitis lesions and lameness. In particular, the flooring challenge systems induce asymmetric torque (twisting) and shear (lateral/side-to-side) stresses by forcing the birds to maintain an upright posture while straddling opposing slopes near the apex of the flooring challenge system. The flooring challenge systems can be arranged to create flat and/or ramped configurations to induce broilers to express higher levels of lameness attributable to BCO when compared with broilers reared on traditional wood shavings floor litter. Utilizing the flooring challenge systems, the relative incidences of lameness can be varied as desired by (a) changing the percentage of the pen floor that is covered with wire flooring versus traditional litter materials; (b) changing the slope of the flooring challenge system; (c) changing the duration of exposure to the flooring challenge system; (d) changing the age at which broilers are exposed to the flooring challenge system; and/or (e) suspending a device a predetermined distance above the apex of the flooring challenge panel(s).

The flooring challenge systems may be portable and can be adapted to a wide range of floor pen sizes, thereby permitting selection for resistance to lameness to be conducted on a commercially practical scale, using a wide variety of approaches (e.g., pedigree testing, sib testing, progeny testing, and direct selection of clinically healthy survivors). The flooring challenge systems permit development of efficacious prophylactic or therapeutic treatments. The flooring challenge systems also permit identification of biomarkers, genes and genomic relationships that are correlated with the relative susceptibility to lameness. In addition, the flooring challenge systems permit the identification of nutritional formulations or strategies for minimizing or eliminating lameness in broiler chickens and the like.

The flooring challenge systems may utilize one or more portable panels or panel sections that can be constructed in a wide range of sizes and configurations, such as flat panel, sloping ramp, A-Frame, speed bump, etc., for installation in commercial broiler pens of virtually any size. In addition, an array of nipple waterers may be suspended a predetermined distance above the apex of the portable panels to force the boilers to extend their neck to get a drink as they straddle opposing slopes near the apex of the flooring challenge system. Alternatively, a limbo bar, pagoda top or the like may be utilized to force the birds to walk much more carefully and methodically up and down the sloped panels of the flooring challenge system. After a suitable incidence of lameness has been induced, the flooring challenge system can be removed to facilitate cleanout of the facility. The flooring challenge systems and methods permit broilers to remain in existing pens and, unlike cage-based systems, permit the birds to exercise and move freely about their pens.

The flooring panels can be constructed of any flooring material and configuration suitable for use in a commercial boiler application and which induces unstable or insecure footing for added torque, stress and strain on key leg joints, thereby exacerbating and accelerating the development of clinical lameness. For example, the flooring panels can be constructed of wood frameworks covered with wire mesh; however, for commercial applications (for improved durability and sanitizing between uses), the flooring challenge panel can be constructed from a variety of materials, such as frameworks with cross-members constructed of metal, plastic, fiberglass, or the like, and coverings constructed of metal, plastic, fiberglass, rubber, plastic coated wire, rubber coated wire, expanded metal mesh, or the like. The coverings are fastened to the frameworks and cross-members.

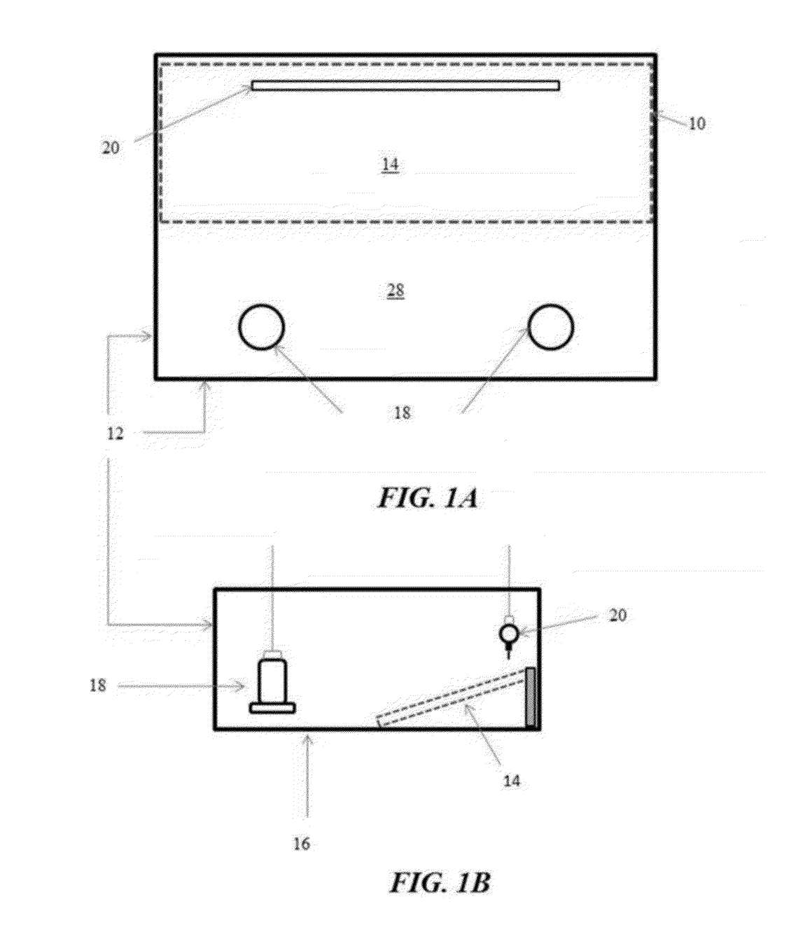

Referring now to the figures of the drawings, wherein like numerals of reference designate like elements throughout the several views, and initially to FIG. 1, the flooring challenge system 10 is installed in a poultry rearing pen 12 having a flooring panel 14 covering half of the pens' floor 16. The pen 12 also includes feeders 18 and nipple waterers 20 installed at opposing sides of the pen 12 to force the chicks (not shown) to traverse the flooring panel 14 repeatedly as they eat and drink. Initially the flooring panel 14 lies flat with wood shavings litter, thereby training the birds to traverse the flooring panel 14 to drink from the nipple waterers 20 on one side of the pen 12, and to eat from the feeders 18 on the opposite side of the pen 12. When the chicks reach an appropriate age, namely 2 to 3 weeks of age, the edge of the flooring panel 14 may be elevated to create the sloping ramp flooring panel 14 illustrated in FIG. 1 having an approximate slope of at least 30%.

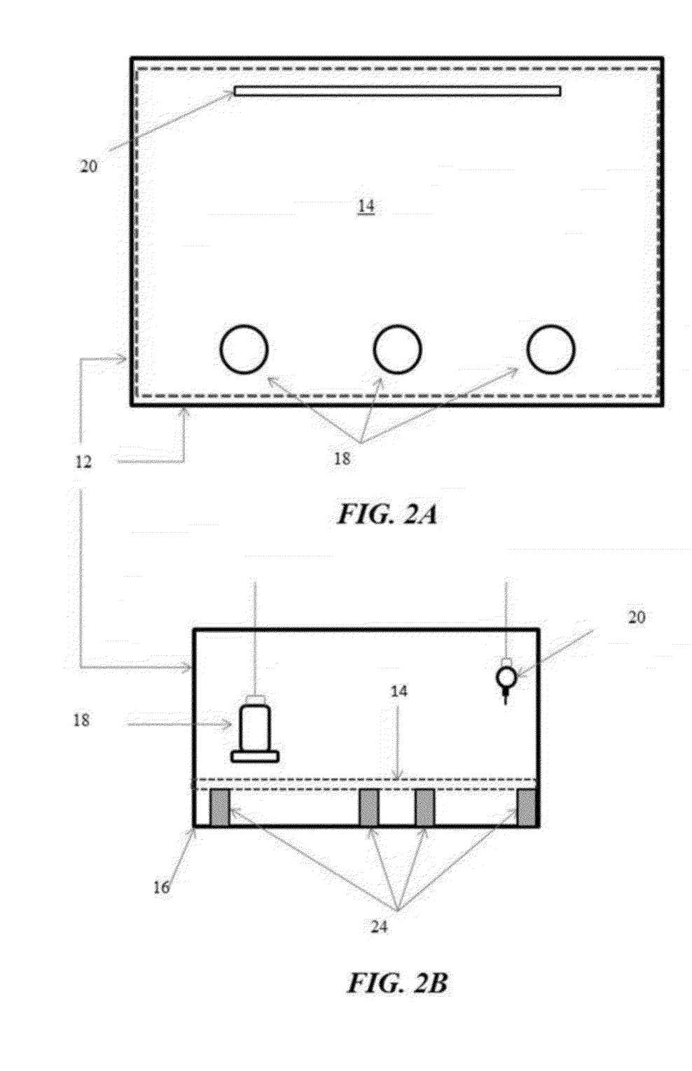

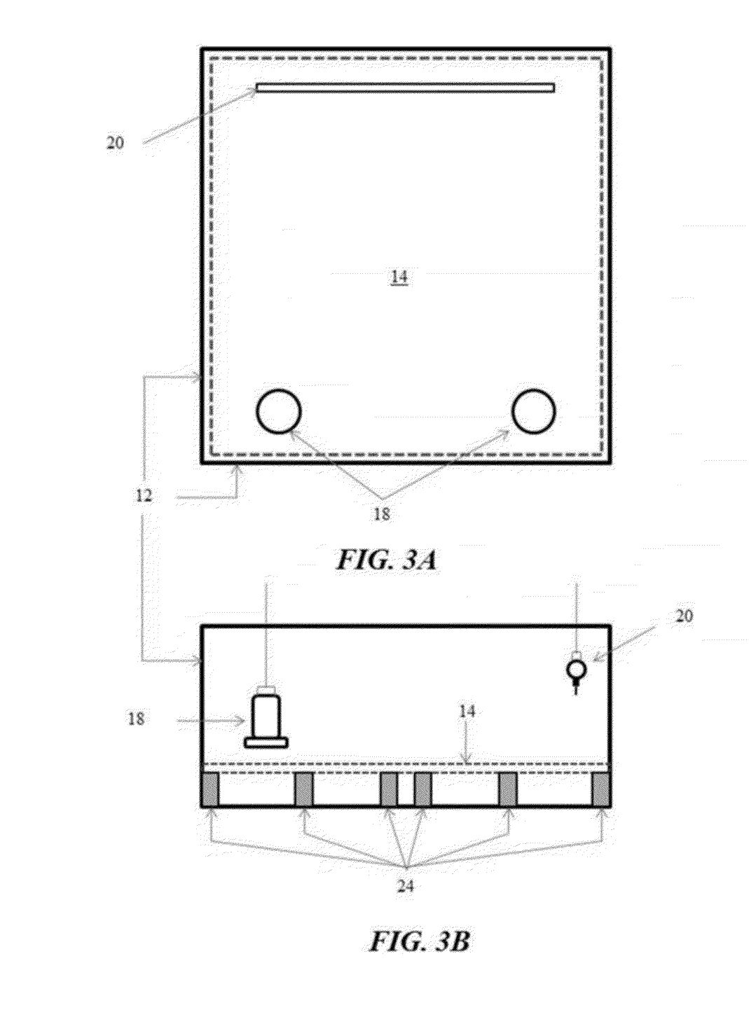

FIGS. 2 and 3 illustrate examples of the flooring challenge systems 10 utilizing a whole pen flat wire flooring panel design. In FIG. 2, the flooring panel 14 comprises a single flat wire flooring panel 14 covering the entire floor 16 of the pen 12, whereas in FIG. 3, the flooring panel 14 comprises multiple portable flat wire flooring panels 14 placed side by side and covering the entire floor 16. The feeders 18 and waterers 20 are arranged at opposite sides of the pen 12 to fore the broilers to traverse the flooring panel 14 repeatedly as they eat and drink. The broilers do not access to floor litter in these examples, and the flooring panel(s) 14 may be further elevated from the floor 16 of the pen 12 using a series of supports 24. Additionally, the flooring panel(s) 14 remains flat without slope throughout the method.

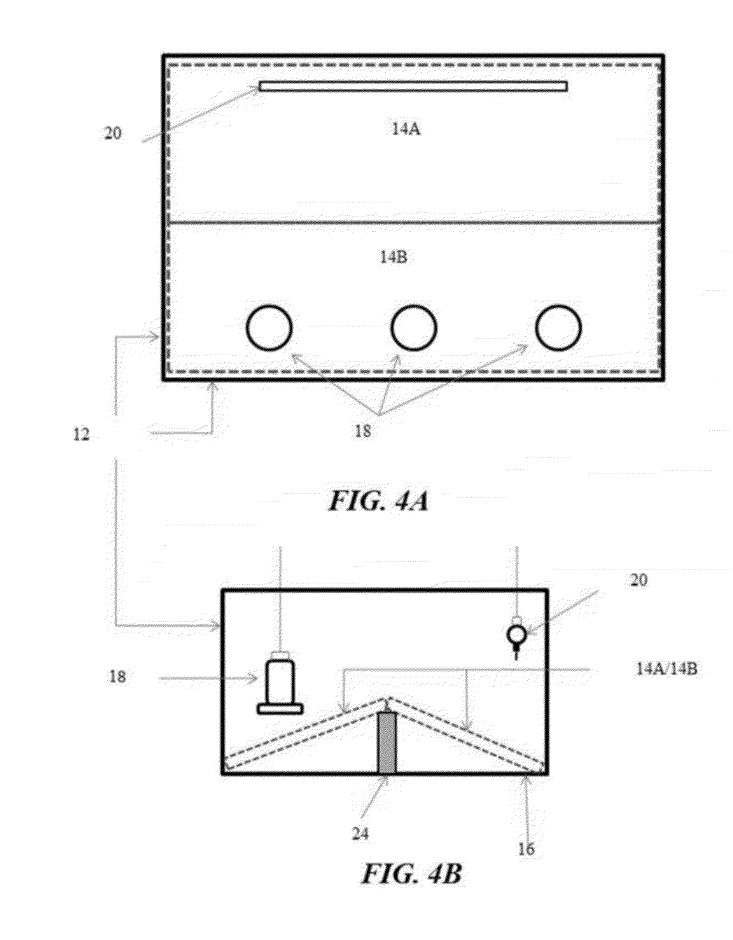

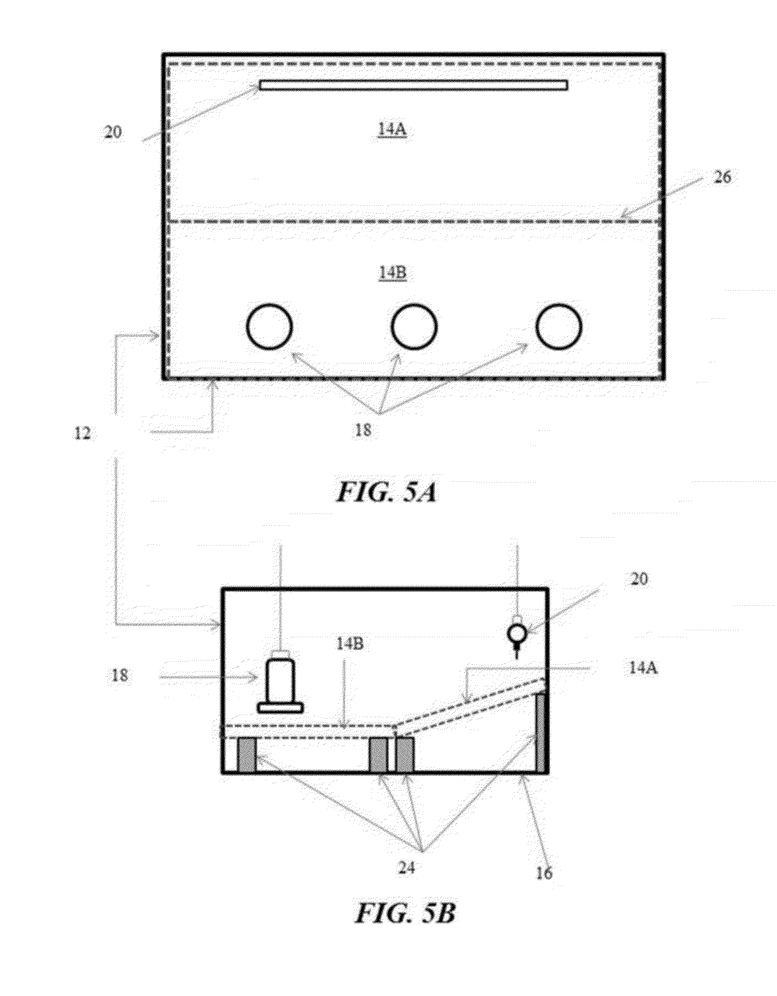

FIG. 4 exemplifies the flooring challenge systems 10 having an A-Frame configuration with a pair of flooring panels 14A and 14B hingedly joined along a center line 26. Similarly to the sloping ramp exemplified in FIG. 1, initially both of the flooring panels 14A and 14B lie flat on the pen floor 16, with the waterers 20 and feeders 18 located on opposite ends of the pen 12. At an appropriate age, again namely 2 to 3 weeks of age, the center line 26 of the flooring panels 14A and 14B may be elevated to create a slope, such as 30% or greater, to the peak from both directions. The center line 26 may be supported with a center support 24. Alternatively as illustrated in FIG. 5, the flooring challenge systems 10 may be configured with one panel 14B placed flat above the pen floor 16 and the other panel 14A configured as a sloping ramp. Rather than elevating the center line 26 to form the A-Frame configuration, one of the flooring panels, such as the panel 14A under the waterers 20, is raised to form the sloping ramp, while the other panel, such as the panel 14B under the feeders 18, remains flat with the covering of the flooring panel 14B elevated from the pen floor 16.

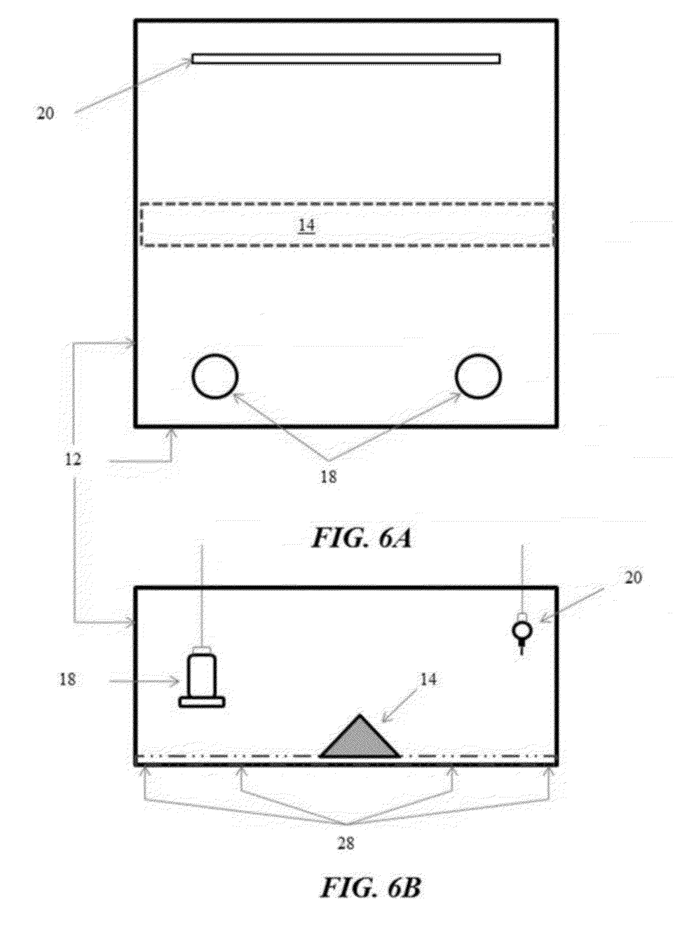

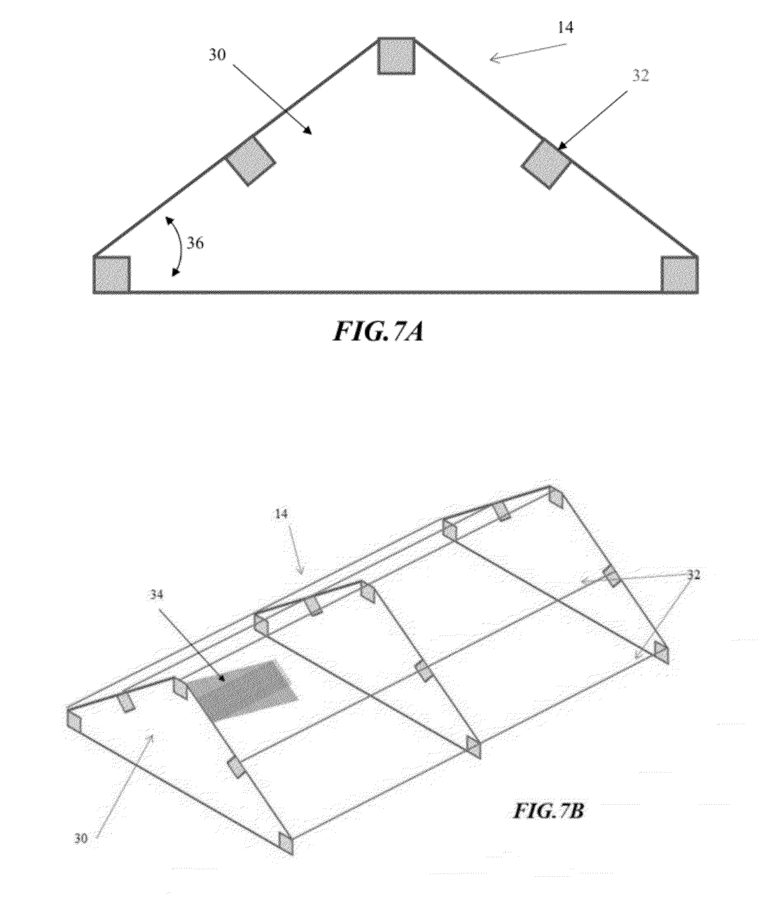

Turning now to FIG. 6, the flooring challenge systems 10 can utilize a flooring panel 14 constructed in the form of a speed bump, which is inserted into the pen with traditional wood shavings litter 28. The speed bump 14 is installed intermediate of the feeders 18 and the waterers 20 in the pen 12 to force the broilers to traverse the speed bump 14 as they repeatedly eat and drink. The speed bump 14 configuration is similar to the A-Frame configuration illustrated in FIG. 4, but is more easily portable and adaptable to large commercial broiler pens in large poultry production facilities. As shown in FIGS. 7a and 7b, the speed bump 14 may include a series of ribs 30 and stringers 32 constructed of suitable materials, such as a frame from wood, aluminum or polyvinyl chloride (PVC), and a covering 34 of mesh wire hardware cloth or other suitable materials. For the purpose of demonstration rather than limitation, the ribs 30 of the speed bump 14 may be spaced at 16 in. or 24 in. centers, with 48 in. or 60 in. section lengths. The height of the speed bumps 14 may vary, such as approximately 6, 9 or 12 in., to attain a desired slope 36, such as approximately 33%, 50% and 67%, respectively. The construction of and the materials selection for the speed bump 14 should be such that the speed bump 14 is easily portable from pen to pen (such as having by having a weight of less than 40 pounds), and capable of being reissued.

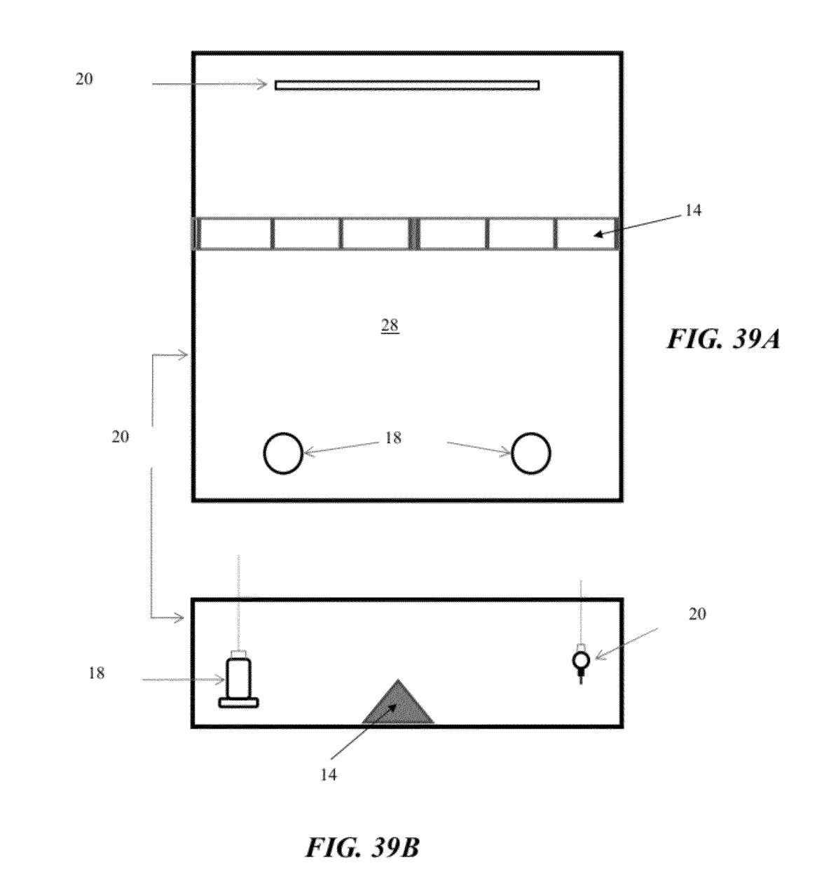

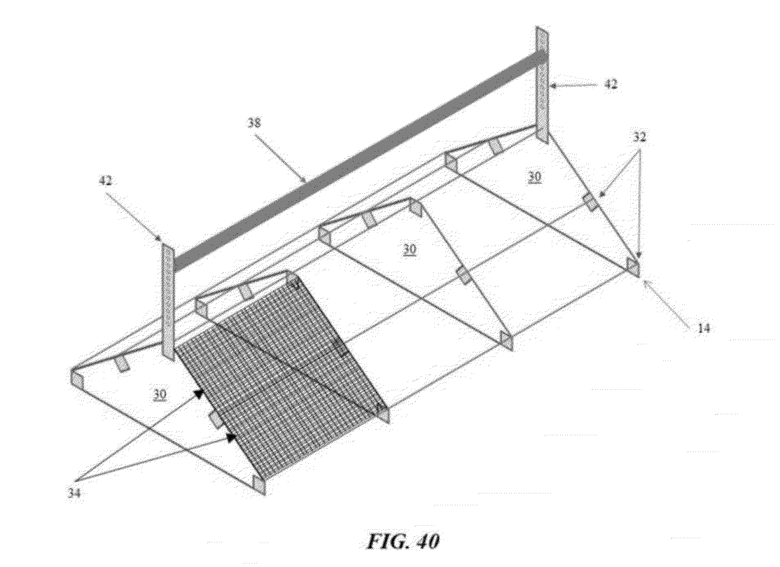

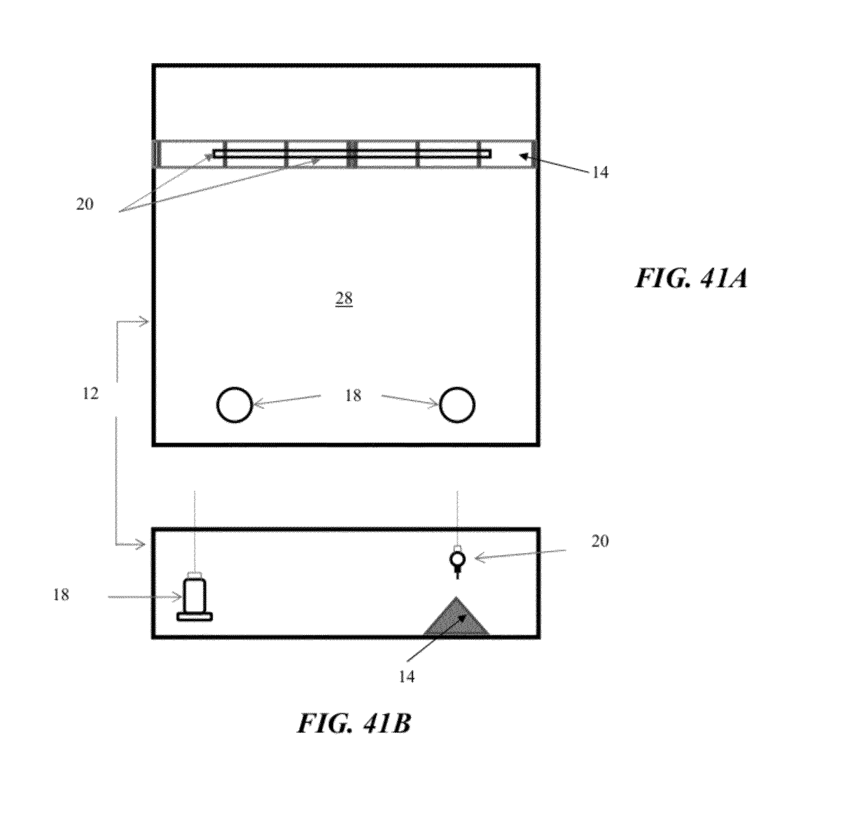

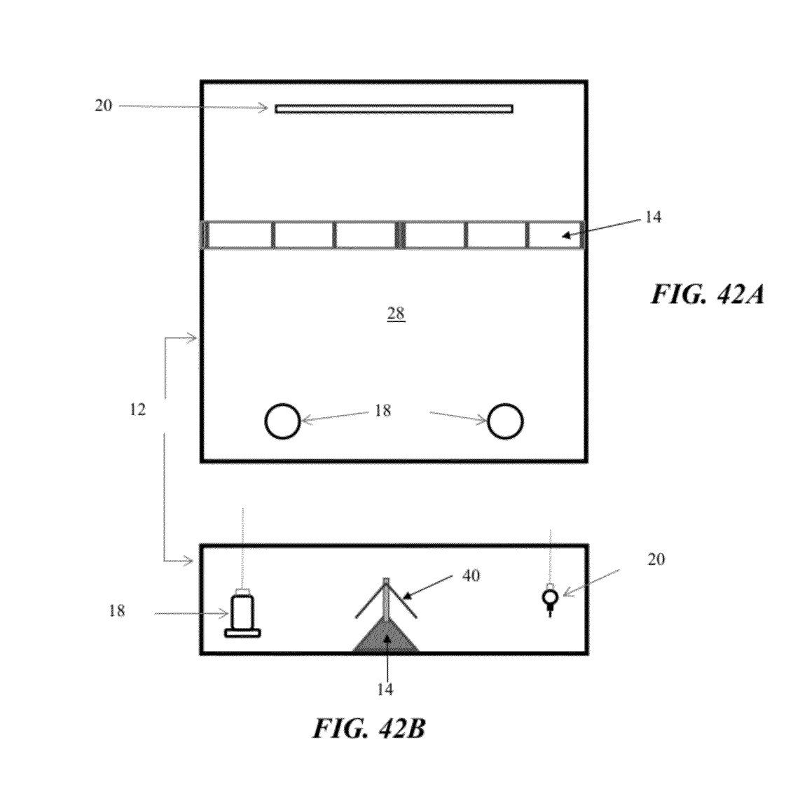

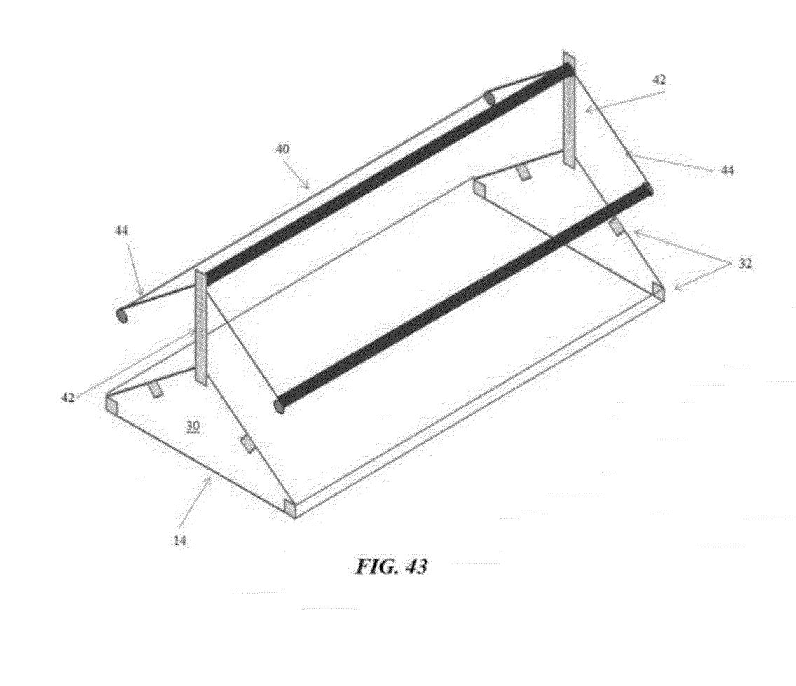

Referring now to FIGS. 39 through 43, the flooring challenge systems 10 and methods for culling poultry may further include an additional device to amplify the challenge imposed on the legs of susceptible boilers. As illustrated in FIG. 41, an array of nipple waterers 20 are suspended above a speed bump 14 to subject the broilers' legs to asymmetric twisting and enhanced instability by forcing the birds to straddle opposing slopes near the apex of the speed bump 14, while the birds attempted to maintain an upright position with their neck extended to drink from the waterers 20. Similar to above, the desired slope/height of the speed bump 14 and/or the distance between the waterers 20 and the speed bump 14 may be adjusted. Alternatively, as illustrated in FIGS. 39 and 40, the flooring challenge systems 10 and methods may utilize a limbo bar 38 mounted over the speed bump 14, or as illustrated in FIGS. 42 and 43, the flooring challenge systems 10 may utilize a pagoda top 40 constructed over the speed bump 14. The modified flooring challenge system 10 forces the birds to walk much more carefully and methodically up and down the sloping wire floor panels 14. The limbo bar 38 and the pagoda top 40 may be supported by at least one support 42, thereby allowing the height of the limbo bar 38 or the pagoda top 40 to be adjusted in relation to the apex of the speed bump 14. For example, the limbo bar 38 may be positioned low enough to force the birds to squat underneath as they cross the speed bump's 14 apex, or the eaves 44 of the pagoda top 40 may be positioned to force the birds to duck-walk up and down the speed bump's 14 slopes. It will be appreciated that the flooring challenge systems 10 and methods disclosed herein can be utilized in other flooring configurations to cause asymmetric torque (twisting) and shear (lateral/side-to-side) stresses induced by walking on flat wire flooring or attempting to stand upright while straddling opposing slopes near an apex.

### EXAMPLES

The flooring challenge systems for culling poultry disclosed herein are further illustrated by the following examples, which are provided for the purpose of demonstration rather than limitation.

### Example 1

The objective of this experiment was to develop a model for inducing a reliably high incidence of lameness in fast growing broilers. To accomplish this, wire flooring panels were constructed to create sporadic unstable footing in broiler pens. Rectangular frameworks were constructed from 5 cm×5 cm lumber. Each frame was 3.05 m long and 1.52 m wide, with 5 cm×5 cm cross members added for support. Hardware cloth (1.3 cm×2.54 cm mesh) was fastened to the frame and cross-members. Ten pens (3.05 m×3.05 m) were set up with floor litter only and ten pens were set up with half litter and half wire-frame floors (FIG. 1). In addition, one half-sized pen (1.52 m×3.05 m) was setup with a flat all wire flooring panel (FIG. 2), and a standard sized pen (3.05 m×3.05 m) was setup with an A-Frame all wire floor (FIG. 4).

For the first 2 weeks all flooring panels were flat on the pen floor. Three tube feeders were positioned on one side of the pen and a nipple waterer were positioned on the opposite side of the pen above the flooring panel. Initially, 960 male chicks from Line C and 1,150 male chicks from Line D were utilized, with chicks initially being placed at a density of >90 per pen (approximately 1 ft² per bird) and were grown as rapidly as possible (23 hours of light, full feed, optimal temperature and ventilation conditions). During the first two weeks, high chick mortality due to unknown causes was encountered, and by 14 days of age, 56 chicks from Line C and 88 chicks from Line D had died. On day 14 the chicks in 2 pens per line were redistributed to achieve the following allocations: 4 pens of 100 chicks each (Line C—Floor); 4 pens of 104 chicks each (Line C—Wire); 1 pen of 52 chicks (Line C—Flat Wire); 4 pens of 113 chicks each (Line D—Floor); 4 pens of 113 each (Line D—Wire); and, 1 pen of 114 chicks (Line D—“A” Wire). Also at 14 days of age, the flooring panels were elevated to a 30% slope (18 inches of elevation for the 5 foot width, including both frames in the A-Frame pen), forcing the chicks to walk up and down the sloping wire to drink.

The pens were numbered and observations on leg problems and mortality were recorded by pen number. When a cause of mortality could not be determined the birds were categorized as Unknown Mortality (primarily occurring during the first 3 weeks of age). Birds dying with an obvious posture characteristic of sudden death syndrome or with pulmonary hypertension syndrome were categorized as having SDS or Ascites, respectively. Birds were determined to be “lame” when they could not walk or stand. At that time they were euthanized and necropsied to evaluate the cause of the lameness using the following categories: Lame—Unknown (cause of lameness was not evident); Twisted Leg (3 birds during the first 2 weeks of age); TD (tibial dyschondroplasia); Kinky Back or Spondylolisthesis; FHS&FHD (femoral head separation or degeneration); and, FHN (femoral head necrosis). Body weights were recorded by pen for birds surviving on Day 56; the birds were weighed in groups of 7 in tared bins. The live weight was divided by the number of birds weighed per pen to calculate the average body weight in pounds per bird.

Table 1 represents body weights and cumulative percentage incidences for days 15 through 56 within various diagnostic categories. The body weight data were compared across the 4 main line×treatment combinations by one-way ANOVA. Lesion incidences were calculated as percentages of the number of birds in the respective treatment pens on day 15 (“n” values shown in Table 1) and were compared using the z-test (Sigma-Stat). Significance was declared for P≦0.05.

TABLE 1
Body Weights and cumulative percentage incidences for days 15 through 56
within various diagnostic categories.

| | Line C- | Line C- | Line C- | Line D- | Line D- | Line D-“A” |
|---|---|---|---|---|---|---|
| | Floor | Wire | Flat Wire | Floor | Wire | Wire |
| | (4 pens, n = | (4 pens, n = | (1 pen, n = | (4 pens, n = | (4 pens, n = | (1 pen, n = |
| Category | 400) | 416) | 52) | 452) | 452) | 114) |
| Body Wt | 8.19 ± 0.21^{a} | 7.19 ± 0.15^{b} | 7.16 | 7.39 ± 0.21^{b} | 6.50 ± 0.09^{c} | 6.36 |
| (lbs) | | | | | | |
| Unknown | 0.50 | 0.24 | 0 | 0.22 | 0.22 | 1.75 |
| Mort. | (2/400) | (1/416) | (0/52) | (1/452) | (1/452) | (2/114) |
| SDS | 2.00 | 3.13 | 1.92 | 0.44 | 0.88 | 1.75 |
| (Flipover) | (8/400) | (13/416) | (1/52) | (2/452) | (4/452) | (2/114) |
| Ascites | 0.25 | 0.48 | 0 | 0.44 | 0.88 | 0 |
| | (1/400) | (2/416) | (0/52) | (2/452) | (4/452) | (0/114) |
| Lame- | 1.75 | 3.13 | 0 | 0.22 | 0.88 | 2.63 |
| Unknown | (7/400) | (13/416) | (0/52) | (1/452) | (4/452) | (3/114) |
| Twisted | 0.0 | 0 | 0 | 0 | 0.44 | 0‘0 |
| Leg | (0/400) | (0/416) | (0/52) | (0/452) | (2/452) | (0/114) |
| TD | 1.00 | 0.96 | 3.85 | 0 | 0.44 | 0.88 |
| | (4/400) | (4/416) | (2/52) | (0/452) | (2/452) | (1/114) |
| Kinky | 1.00 | 1.92 | 5.77 | 0.88 | 0.66 | 2.63 |
| Back | (4/400)^{b} | (8/416)^{ab} | (3/52)^{a} | (4/452)^{b} | (3/452)^{b} | (3/114)^{a} |
| FHS&FHD | 3.25 | 5.77 | 23.08 | 1.33 | 2.21 | 3.51 |
| | (13/400)^{b} | (24/416)^{b} | (12/52)^{a} | (6/452)^{c} | (10/452)^{c} | (4/114)^{b} |
| FHN | 3.75 | 14.90 | 28.85 | 1.99 | 4.42 | 38.60 |
| | (15/400)^{c} | (62/416)^{b} | (15/52)^{a} | (9/452)^{c} | (20/452)^{c} | (44/114)^{a} |
| FHS&FHD + | 7.00 | 20.67 | 51.92 | 3.32 | 6.64 | 42.11 |
| FHN¹ | (28/400)^{c} | (86/416)^{b} | (27/52)^{a} | (15/452)^{d} | (30/452)^{c} | (48/114)^{a} |
| All Lame | 10.75 | 26.68 | 61.54 | 4.42 | 9.07 | 48.25 |
| Combined | (43/400)^{c} | (111/416)^{b} | (32/52)^{a} | (20/452)^{d} | (41/452)^{c} | (55/114)^{a} |

¹FHS&FHD + FHN are combined to reflect the likelihood that these categories are different stages in the pathogenesis of the same femoral head lesion.
²All Lame Combined = Lame Unknown + Twisted Leg + TD + Kinky Back + FHS&FHD + FHN.

Between 3 and 8 weeks of age, bird densities of ≦1 ft² per bird were achieved, particularly for Line D in which culling for lameness was low, and litter quality was poor for both lines.

Table 1 above summarizes the body weights and diagnostic categories for the six Line×Treatment groupings. Within each line the birds grown on floor litter were significantly heavier at 8 weeks of age than those grown in pens with a wire floor. The single pen values for the Line C—Flat Wire group (7.16 lbs) and the Line D—“A” Wire group (6.36 lbs) were not compared statistically, but both values fell well within the range of values for the respective ‘Line C—Wire’ or ‘Line D—Wire’ groups. Birds from Line C were significantly heavier than those from Line D when compared on floor litter (8.19 vs. 7.39 lbs, respectively) or on wire (7.19 vs. 6.50 lbs, respectively). Perhaps increased exercise associated with the wire ramps reduced BW gain. Alternatively, perhaps birds with “sore” legs did not climb the ramp as frequently to drink and thus did not eat as much as their counterparts in the floor pens. However, the birds in the Line C—Flat Wire group would not have experienced more exercise nor would they have needed to climb a ramp to drink. Accordingly a third possibility was considered—that direct exposure to or consumption of litter somehow improves BW gain and/or resistance to lameness. Finally it is possible that the fastest growing birds developed lameness more readily and thus the heavier individuals had been significantly depleted from the wire-floor pens by 8 weeks of age.

As shown in Table 1, the six Line×Treatment groupings did not differ with regard to their cumulative incidences of: mortality due to Unknown Causes; Ascites; Sudden Death Syndrome; undiagnosed Lameness; Twisted legs, or Tibial Dyschondroplasia.

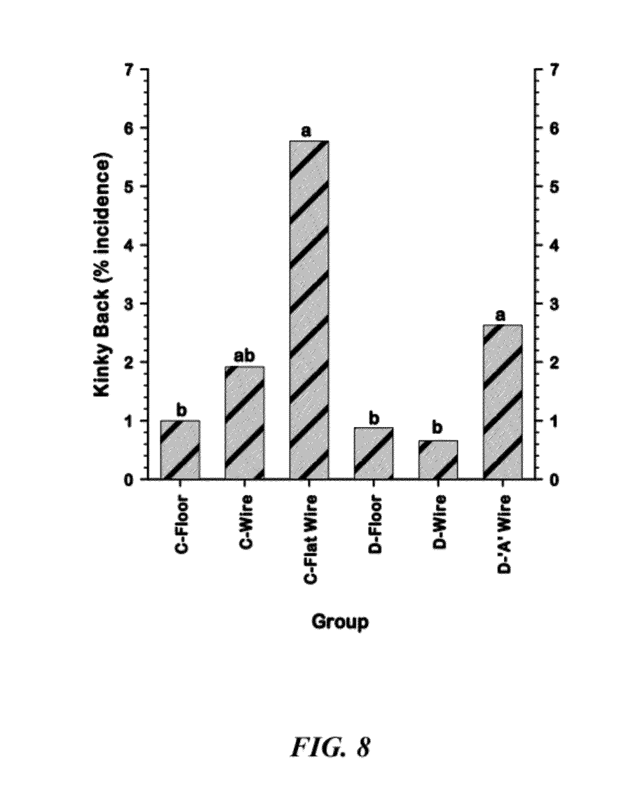

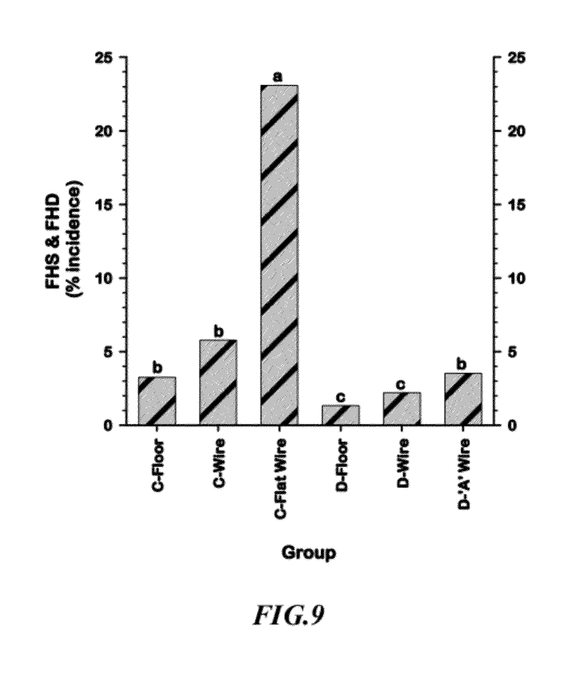

As shown in Table 1 and FIG. 8, the incidence of Kinky Back was significantly higher when birds from both Lines were grown on all-wire floors (Line C—Flat Wire and Line D “A” Wire groups). Kinky Back appears to have a high heritability and appears to be specifically amplified by the all-wire floor research model.

FIG. 9 shows the cumulative incidence of Femoral Head Separation or Degeneration (FHS&FHD) for the six Line×Treatment groups. Line C was significantly more susceptible than Line D within each of the treatment categories. The incidence of FHS&FHD was significantly higher when birds from both Lines were grown on all-wire floors (Line C—Flat Wire and Line D “A” Wire groups).

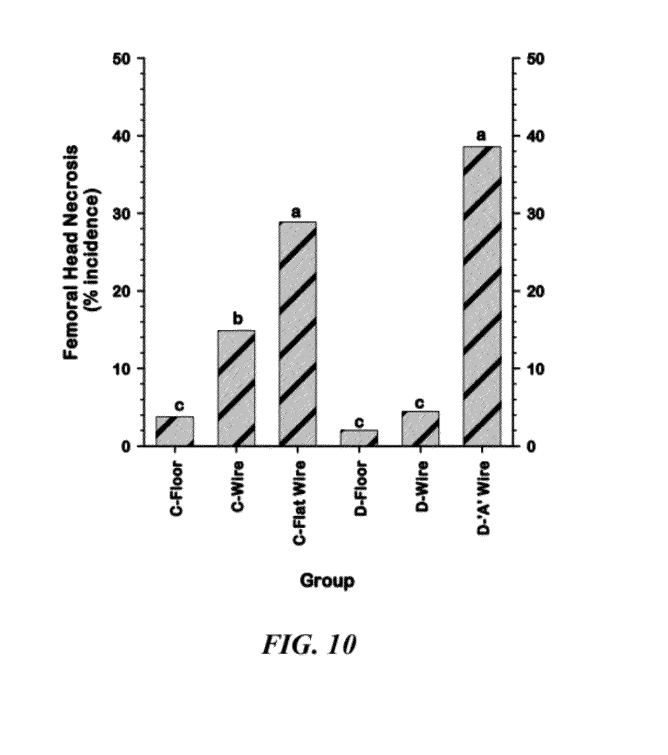

FIG. 10 shows the cumulative incidence of Femoral Head Necrosis (FHN) for the six Line×Treatment groups. Line C was significantly more susceptible than Line D within the wire ramp pens (C-Wire vs. D-Wire), and the incidence of FHN was highest when birds from both Lines were grown on all-wire floors (Line C—Flat Wire and Line D—“A” Wire groups).

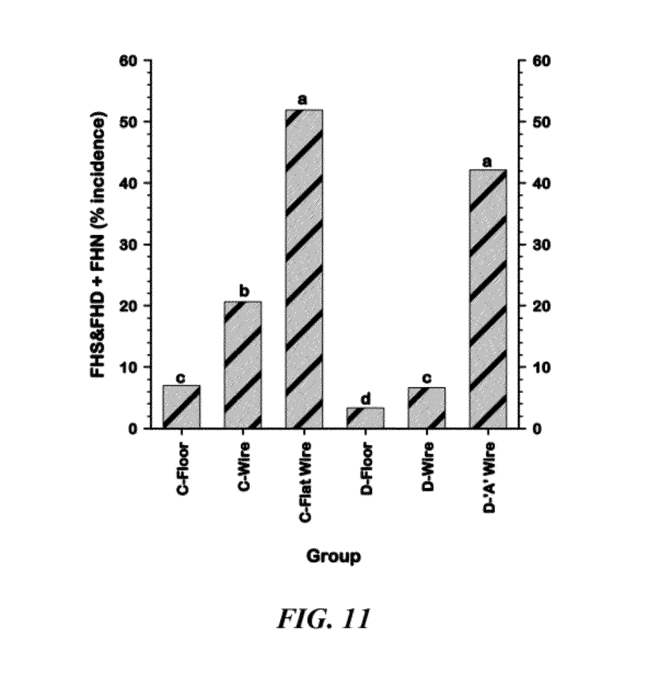

FIG. 11 shows the combined cumulative incidences of FHS&FHD+FHN among the six Line×Treatment groups. These categories were combined based on our observations that there seems to be a direct progression from FHS&FHD to FHN, indicating these are early and later stages of the same pathophysiological progression. Line C was significantly more susceptible than Line D within both the Floor and Wire Ramp treatment categories. The incidence of FHS&FHD+FHN was highest when birds from both Lines were grown on all-wire floors (Line C—Flat Wire and Line D “A” Wire groups).

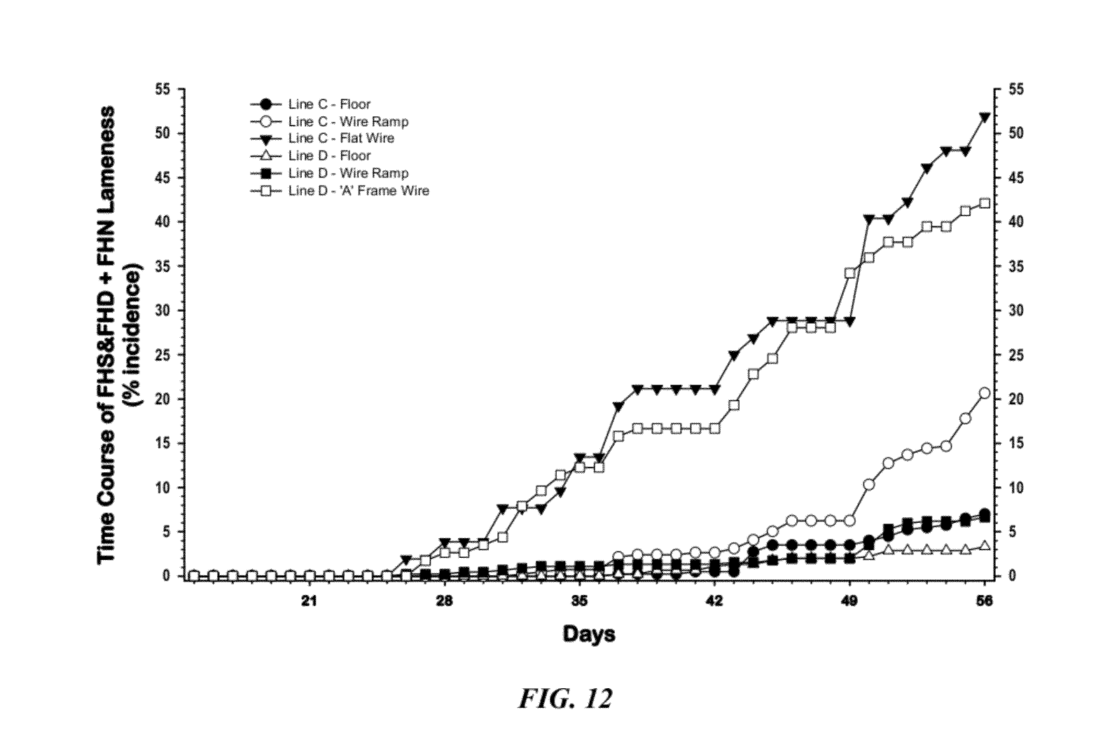

FIG. 12 compares the Time Course of lameness attributable to the combined incidences of FHS&FHD+FHN among the six Line×Treatment groups. The all-wire floor treatments greatly accelerated the onset and cumulative incidences of lameness attributable to FHD+FHN in both lines.

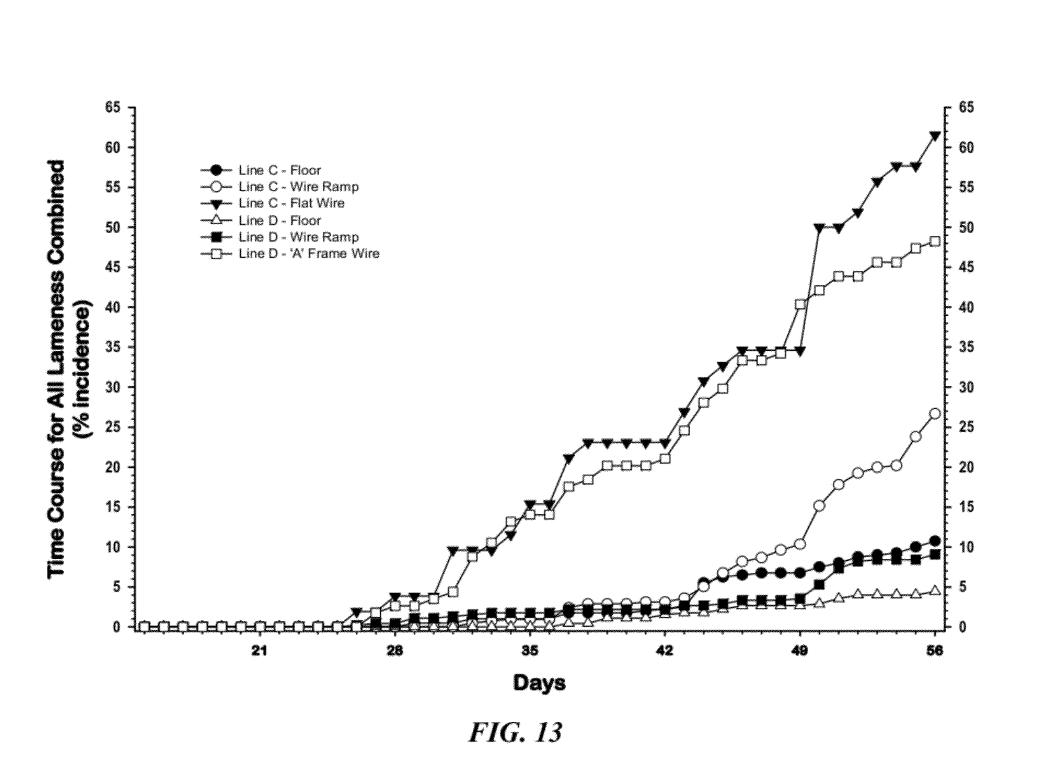

FIG. 13 compares the Time Course of lameness attributable to the combined incidences of all causes among the six Line×Treatment groups. The all-wire floor treatments greatly accelerated the onset and cumulative incidences of lameness in both lines. As illustrated, time course of lameness (percentage incidence between 14 and 56 days of age) for broilers from two genetic lines (Line C and Line D) that were reared on traditional wood shavings floor litter (Line C-Floor, Line D-Floor), or were reared in pens with: the wire flooring ramp with a 30% slope (Line C—Wire Ramp; Line D—Wire Ramp); the flat wire flooring (Line C—Flat Wire); or, the A-Frame configuration (Line D—“A” Frame Wire). Within each respective line, the flat wire flooring configuration and the A-Frame flooring configuration both induced incidences of lameness that were significantly higher (P=0.001) than in the wire ramp configuration, which in turn induced significantly higher incidences of lameness than the traditional floor litter. An independent study indicated that a wire ramp with a 20% slope did not induce significantly more lameness than traditional floor litter. The anticipated incidence of lameness can be regulated (as desired) by adjusting the slope of the ramp or by adjusting the percentage of the pen floor that is covered by litter vs. wire flooring.

Although due to culling for lameness the birds in the all-wire pens reached a much lower density toward the end of the experiment but nevertheless they clearly continued to exhibit daily increments in lameness attributable to FHS&FHD+FHN (FIG. 12) as well as to all causes combined (FIG. 13). Line C was substantially more susceptible to lameness than was Line D (FIG. 11). Nevertheless, being reared on the “A”-wire floor clearly exposed susceptibility to Kinky Back (FIG. 8) and lameness (FIGS. 12 and 13) in Line D. The FHS&FHD appears to be directly correlated with lameness. Unilateral or bilateral FHS&FHD was detected in numerous birds that were obviously lame and immobilized. FHS&FHD was not seen in birds that had died or were culled for SDS or ascites. FHS&FHD appeared to be a prelude to or an early stage of FHN. In over 20 cases where FHS&FHD or FHN were diagnosed, no evidence of TD was found in the legs of the birds. FHS&FHD rarely was observed in Kinky Back birds. Based solely on gross, macroscopic necropsy observations, the FHN appeared to be overwhelmingly “metabolic” in origin, with no evidence of the focal yellow areas of caseous exudates that should be evident if the pathogenesis involved bacterial chondronecrosis and osteomyelitis. These birds grew rapidly to a heavy final body weight, yet the incidences of ascites and SDS were negligible. Visual evidence of cyanosis was difficult to detect in any of the birds. SDS mortality may have been attenuated by the high bird density situation. The all-wire floor treatment permits the induction of virtually linear percentage increases in lameness over time (FIGS. 12 and 13).

In summation, cumulative incidences of lameness were compared for 2 to 8 wk old broilers using a z-test, with significance declared at P<0.05. The incidence of lameness induced by the 20% sloping wire floor (6.8%; 34/500 birds) did not differ from the spontaneous occurrence of lameness on litter alone (5.8%; 29/500 birds). The incidence of lameness induced by the 30% sloping wire floor (26.7%; 111/416 birds) was significantly higher (P=0.01) than the spontaneous occurrence of lameness on litter alone (10.7%; 43/400 birds).

### Example 2

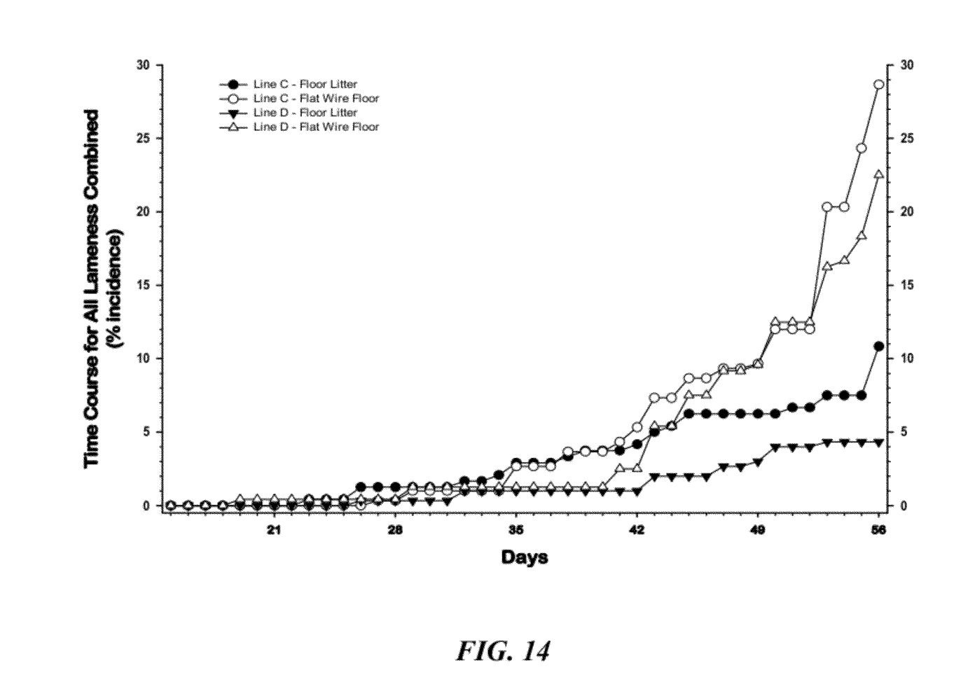

A study was conducted to evaluate the incidence of lameness in broilers from Lines C and D grown to 56 days of age in pens with either wood shavings litter or flat wire frames covering the entire floor. A significantly higher incidence of lameness was demonstrated for broilers grown on flat wire flooring than for broilers grown on litter (26% vs. 7%, respectively; lines pooled), and the incidence of lameness was higher in Line C than in Line D (21% vs. 12%, respectively; floor treatments pooled). FIG. 14 graphically illustrates the time course of lameness (percentage incidence between 14 and 56 days of age) for broilers from two genetic lines (Line C and Line D) that were reared on traditional wood shavings floor litter (Floor Litter), or were reared in pens with flat wire flooring (Line C—Flat Wire Floor, Line D—Flat Wire Floor). The flat wire flooring configuration induced incidences of lameness that were significantly higher (P=0.001) than in the traditional floor litter pens within each line, respectively. Line C was demonstrated to be significantly more susceptible to lameness than Line D.

Another study was conducted to compare the susceptibility to lameness of pedigreed male and female chicks from Lines B and D when grown to 56 days of age in pens with flat wire flooring. In this study, leg scores and gait scores were recorded at 5 and 6 weeks of age, respectively, to evaluate potential predictive relationships between traditional selection parameters and the subsequent incidence of lameness. Broilers from Line B developed a significantly higher incidence of total lameness (50%) than broilers from Line D (39%) when grown on flat wire flooring, and within each line males and females exhibited virtually identical percentages of total lameness. Leg scores based on leg morphology (e.g., “Bowed In”, “Bowed Out” and “Rotated”) did not reliably predict lameness caused by lesions of the proximal femoral head. In contrast, the 5 point gait scoring system appeared to yield results that qualitatively reflected Line differences in susceptibility to lameness. The present study was conducted to compare the incidences of lameness in male broilers from Lines B and D when they were transferred from litter to wire flooring, or from wire flooring to litter, at different ages and for different durations. Also in this study, leg scores, C-GAP scores and gait scores were recorded by wing band number so that potential predictive relationships between these non-invasive scoring systems could be compared with the subsequent incidence of clinical lameness.

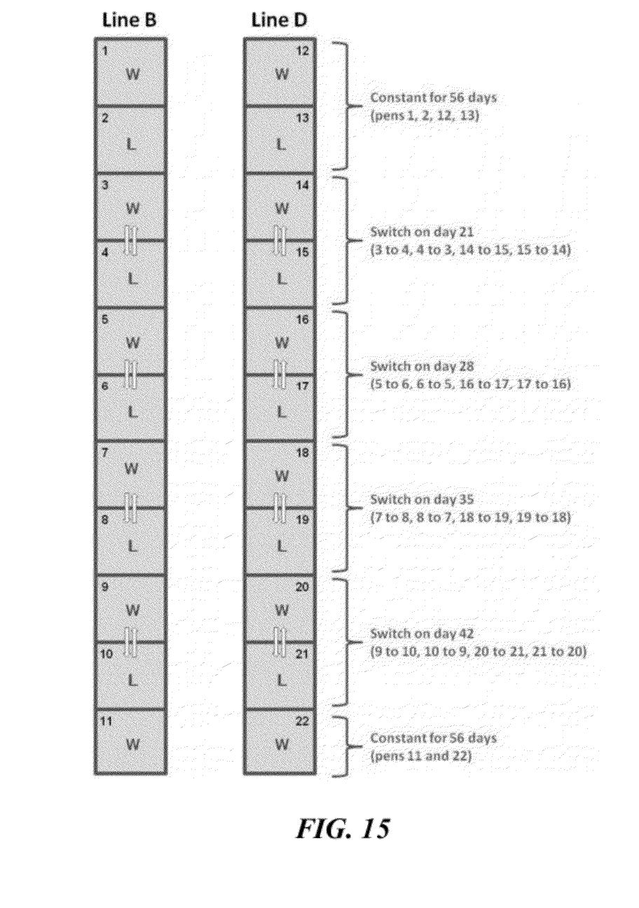

Building A364 East on the University of Arkansas Poultry Research Farm was set up with 22 standard-sized pens (3.05 m×3.05 m) having either floor litter or flat wire flooring, as diagrammed in FIGS. 3 and 15. Tube feeders were placed at the front and nipple waterers were positioned at the rear of each pen, forcing the birds to traverse the length of the floor to eat and then drink. Male chicks from Line B were placed in pens 1 through 11 and male chicks from line D were placed in pens 12 through 22. Initially 88 chicks were placed per pen, and on day 14 the chick density was culled to 75 per pen. As indicated in FIG. 15, the birds either remained in their original pens through 56 days of age (pens 1, 2, 11, 12, 13, 22), or they were switched reciprocally between wire and litter pens at 21, 28, 35 and 42 days of age. Hereafter these treatments are designated as follows:

8W: remained on wire flooring for the entire 8 weeks (pens 1, 11, 12, 22)

8L: remained on litter for the entire 8 weeks (pens 2 and 13)

3W5L: 3 weeks on wire followed by 5 weeks on litter (initially pens 3, 14)

3L5W: 3 weeks on litter followed by 5 weeks on wire (initially pens 4, 15)

4W4L: 4 weeks on wire followed by 4 weeks on litter (initially pens 5, 16)

4L4W: 4 weeks on litter followed by 4 weeks on wire (initially pens 6, 17)

5W3L: 5 weeks on wire followed by 3 weeks on litter (initially pens 7, 18)

5L3W: 5 weeks on litter followed by 3 weeks on wire (initially pens 8, 19)

6W2L: 6 weeks on wire followed by 2 weeks on litter (initially pens 9, 20)

6L2W: 6 weeks on litter followed by 2 weeks on wire (initially pens 10, 21)

All chicks were grown as rapidly as possible throughout the experiment, with 23 hours of light per day, ad libitum feed, thermoneutral temperatures, and adequate ventilation throughout. All birds were fed the standard Cobb-Vantress starter feed (crumbles) through 42 days of age, and the standard Cobb-Vantress finisher feed (pellets) thereafter. On day 37 Cobb-Vantress personnel assessed Leg Scores and C-GAP scores in the 8W and 8L pens for both lines. On Day 44 Cobb-Vantress personnel used the 5 point Bristol method to gait score the same pens. These scores were recorded by wing band number to permit correlation with any subsequent onset of lameness.

Birds in all pens were “walked” and observed for lameness every two days beginning on Day 15. Birds were diagnosed as being lame and were humanely euthanized (cervical dislocation or CO₂ gas inhalation) when they were unable to walk. All birds that died or developed clinical lameness were recorded by wing band number and pen number, necropsied, and assigned to one of the following categories:

Normal=Femur head and proximal tibia appear entirely normal

Cull=Runts and individuals that failed to thrive or appeared to be clinically ill

U=Unknown cause of death

NE=Necrotic Enteritis

SDS=Sudden Death Syndrome (Flipover, Heart Attacks)

PHS=Pulmonary Hypertension Syndrome, Ascites

KB=Kinky Back (Spondylolisthesis)

TW=Twisted Leg or Slipped Tendon (Perosis)

TD=Tibial Dyschondroplasia

Lame-UNK=Lameness for undetermined reasons

FHS=Proximal Femoral Head Separation

FHT=Proximal Femoral head Transitional degeneration

FHN=Proximal Femoral Head Necrosis

TNH=Proximal Tibial Head Necrosis

Total Lame=KB+TW+UNK+TD+FHS+FHT+FHN+THN

Only clinically lame birds that do not have obvious lesions of the proximal femur head were evaluated for TD and THN. Final body weights were not recorded in this experiment, nor were any survivors necropsied after day 56 to assess sub-clinical lesion categories. All birds remaining alive after 56 days of age were processed; no FCR or yield data were obtained. Lameness incidences or proportions were compared using repeated Z-tests (Sigma-Stat).

Table 2 below provides the total chick mortality and SDS incidence during days 1-14. Early chick mortality averaged approximately 7% regardless of line or floor type. Most of this mortality included obvious cull or runt-type chicks. The “extra” Line D chicks that were removed from wire flooring and floor litter pens on day 14 were transferred to floor litter in an environmental chamber in the Poultry Environmental Research Lab. Groups of these “extra” chicks were euthanized with CO₂ gas and necropsied on days 14, 21 and 28 to evaluate the incidence of proximal femoral head and proximal tibial head lesions (Table 3). The percentages of birds with sub-clinical lesions increased step-wise from a total of 8% on day 14 to 47% FHS on day 28. None of these chicks appeared to be lame prior to necropsy. Previous experience has shown that early chick quality issues (Table 2) typically are associated with early evidence of FHN (Table 3). This is the rationale for culling the population on day 14, as a means of using putatively healthy birds at the beginning the day 14-56 experimental comparison of lines or floor types.

TABLE 2
Early mortality by floor type and by line.

| Floor Type | Day 1-14 Total | |
|---|---|---|
| or Line | Mortality | Day 1-14 SDS |
| All Litter | 6.8% (71/1041) | 0.8% (8/1041) |
| All Wire | 7.0% (95/1359) | 0.5% (7/1359) |
| All Line B | 7.2% (86/1201) | 1.0% (12/1201) |
| All Line D | 6.7% (80/1199) | 0.3% (3/1199) |

TABLE 3
Necropsy results for “extra” broilers from Line D
at 2, 3 and 4 weeks of age, independent of floor type.

| Diagnostic | Day 14 | | Day 21 | | Day 28 | |
|---|---|---|---|---|---|---|
| Category | (n = 163) | | (n = 25) | | (n = 74) | |
| Normal | 92.0% | (150/163) | 76.0% | (19/25) | 52.7% | (39/74) |
| FHS | 3.0% | (5/163) | 20.0% | (5/25) | 47.3% | (35/74) |
| FHT | 0.6% | (1/163) | 4.0% | (1/25) | 0% | (0/74) |
| FHN | 4.3% | (7/163) | 0% | (0/25) | 0% | (0/74) |
| THN | 0% | (0/163) | 0% | (0/25) | 0% | (0/74) |

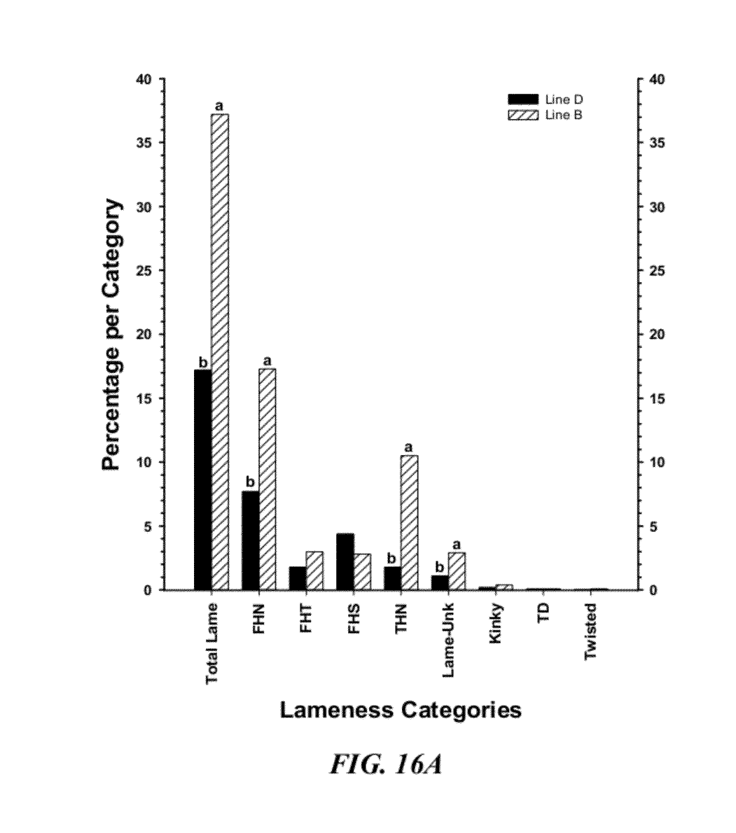

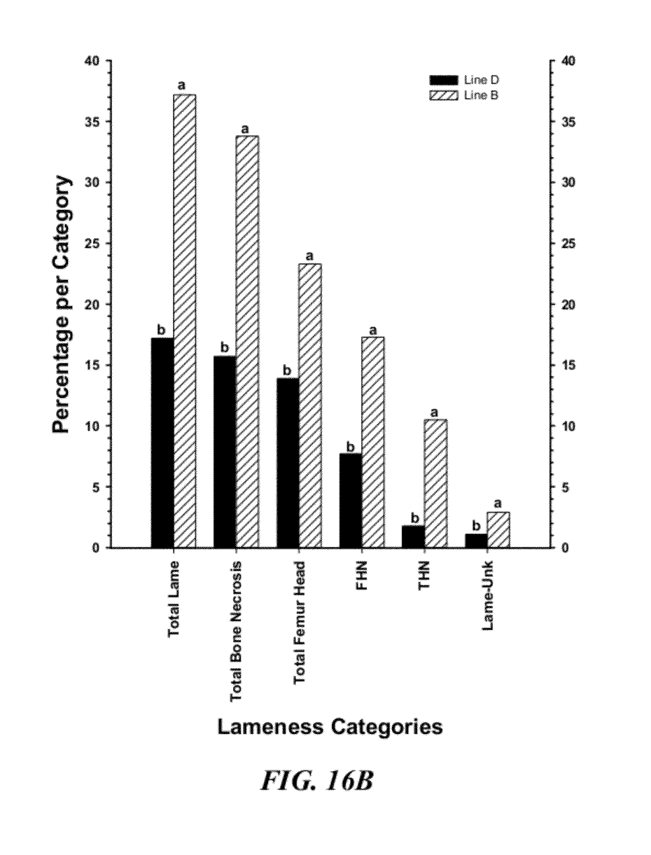

Table 4 shows the percentages of birds within the various diagnostic categories (days 14-56) for the four Floor Type×Line groups as well as for the Lines independent of floor types. The Floor Type×Line “groups” reflect all mortality or clinical lameness that occurred when the birds either were on wire flooring (e.g., in pens 1, 3, 5, 7, 9 and 11 for Line B) or were on floor litter (e.g., in pens 2, 4, 6, 8 and 10 for Line B), regardless of whether the birds started in those pens or were transferred into those pens later (FIG. 15). Mortality attributable to “unknown causes of death” and “NE” was negligible (not shown: 9/825 for Line B; 0/825 for Line D). The combined mortality from PHS and SDS was <2% for Line B and <1% for Line D. Lameness attributed to twisted leg/slipped tendon (not shown) TD and kinky back also was negligible regardless of Line. During necropsies of clinically lame birds in the present experiment, when no obvious lesions of the proximal femur head were detected (e.g., FHS, FHT, FHN), then we consistently evaluated the proximal tibial head for evidence of “THN.” The results shown in Table 4 below demonstrate a primary association between “THN” and clinical lameness in significant numbers of birds, particularly in Line B. It appears likely that “THN” comprised a major portion of the “Lame-UNK” category in previous experiments. Accordingly in the present experiment, “THN” was included in the “Total Lame” category. Within the five diagnostic categories associated with 99% of the total clinical lameness (Lame UNK, FHS, FHT, FHN, THN), birds from Line B had significantly higher incidences in the “Lame-UNK,” “FHN” and “THN” categories when compared with birds from Line D. These line differences were most dramatic for birds that were started/reared on wire flooring. Differences attributable to Line and Floor Type were readily apparent within the “Total Lame” category (Table 4, FIG. 16). As shown in FIG. 16A, more than 90% of the total clinical lameness can be attributed to the cumulative “Bone Necrosis” categories calculated as the sum of FHS+FHT+FHN+THN. All remaining categories combined (Lame-UNK, Kinky, TD, Twisted) represent <10% of the total lameness for both lines.

TABLE 4
Percentage incidences (%) within each diagnostic category¹ for broilers from lines B
or D while they were in pens having wire flooring (Wire) or while they were in pens having wood shavings litter (Litter).

| Floor | | | | | LAME | | | | | | | Total |
|---|---|---|---|---|---|---|---|---|---|---|---|---|
| Type | Line | N² | PHS % | SDS % | UNK % | TD % | KB % | FHS % | FHT % | FHN % | THN % | Lame %³ |
| Wire | B | 450 | 0.7 | 1.1 | 5.1^{a} | 0 | 0.4 | 4.2 | 5.3 | 28.4^{a} | 17.1^{a} | 60.7% |
| | | | | | | | | | | | | (273/450)^{a} |
| Litter | B | 375 | 0 | 1.9 | 0.3^{bc} | 0.3 | 0.3 | 1.1 | 0.3 | 4.3^{c} | 2.7^{b} | 9.3% |
| | | | | | | | | | | | | (35/375)^{c} |
| Wire | D | 450 | 0 | 0.9 | 1.8^{b} | 0.2 | 0.4 | 6.9 | 3.3 | 12.9^{b} | 2.9^{b} | 28.4% |
| | | | | | | | | | | | | (128/450)^{b} |
| Litter | D | 375 | 0 | 0.5 | 0^{c} | 0 | 0 | 1.3 | 0 | 1.6^{c} | 0.5^{c} | 3.5% |
| | | | | | | | | | | | | (13/375)^{d} |
| Litter & | All B | 825 | 0.4 | 1.5 | 2.9^{x} | 0.1 | 0.4 | 2.8 | 3.0 | 17.5^{x} | 10.5^{x} | 37.3% |
| Wire | | | | | | | | | | | | (308/825)^{x} |
| Litter & | All D | 825 | 0 | 0.7 | 0^{y} | 0.1 | 0.2 | 4.4 | 1.8 | 7.7^{y} | 1.8^{y} | 17.2% |
| Wire | | | | | | | | | | | | (142/825)^{y} |

¹PHS: pulmonary hypertension syndrome (ascites); SDS: sudden death syndrome; LAME UNK: cause of lameness could not be determined = unknown; TD: tibial dyschondroplasia; KB: kinky back or spondylolisthesis; FHS: femoral head separation; FHT: femoral head transitional degeneration; FHN: femoral head necrosis; THN: tibial head necrosis.
²Each group was culled to 75 chicks/pen on day 14; Line B-Litter = 6 pens; Line B-Wire = 5 pens; Line D-Litter = 6 pens; Line D-Wire = 5 pens.
³Total Lame = KB + TW + UNK + TD + FHS + FHT + FHN + THN.
^{a,b,c,d or x,y}Values with different superscripts differed significantly at P ≦ 0.05 using repeated Z-tests to compare all proportions.

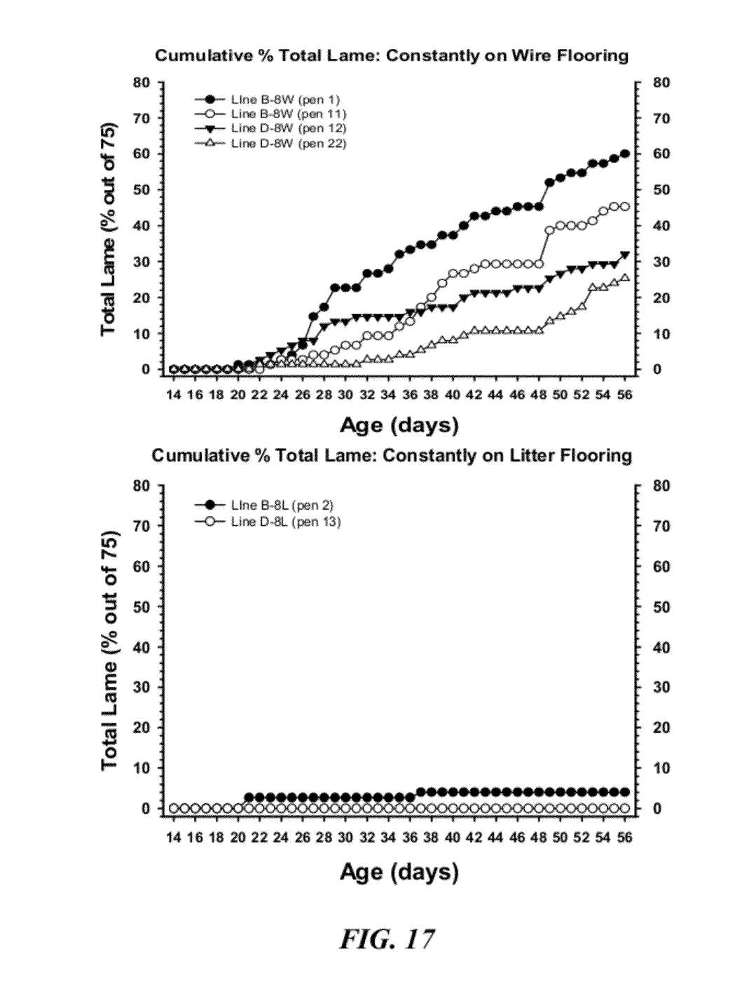

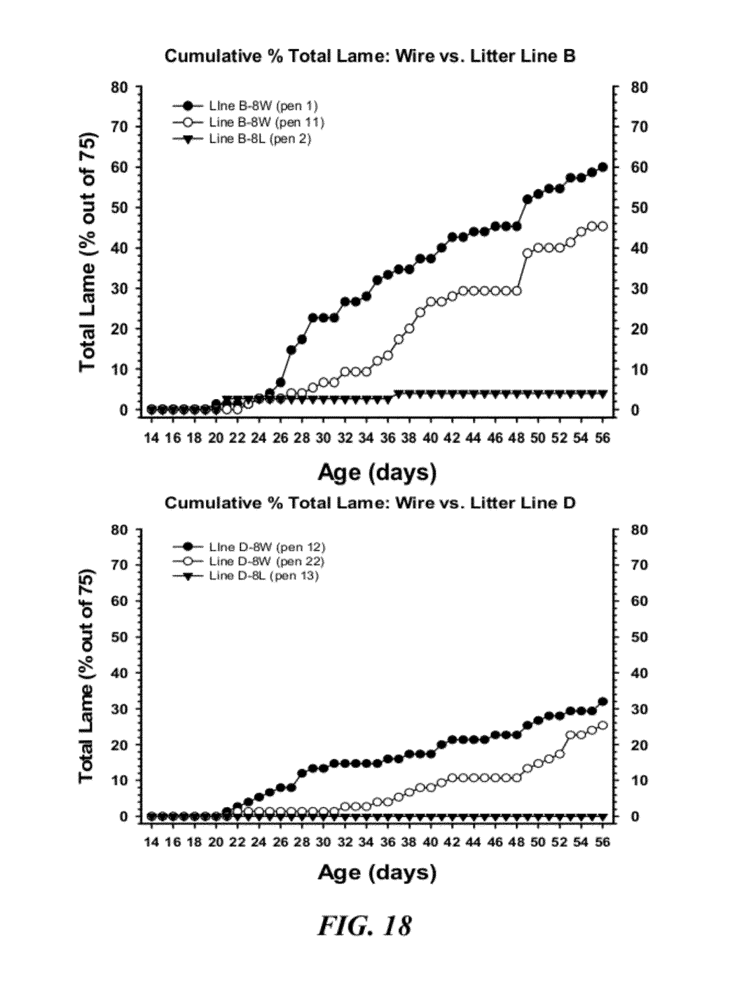

FIG. 17 illustrates the cumulative percentages of total lameness for birds from Lines B or D that constantly remained on wire flooring (8W groups, upper panel) or on floor litter (8L groups, lower panel). FIG. 18 illustrates the same data sorted by line rather than by floor treatment. As has been noticed in previous experiments, pens with wire flooring located nearest the cool cell air inlets in Building A364 East (pens 1-3 and 12-14) tend to exhibit a earlier-onset and higher overall incidence of clinical lameness when compared with pens with wire flooring located nearer the exhaust fan outlets (pens 9-11 and 20-22). This longitudinal stratification associated with pen location was quite clear in the present study: lameness began earlier and a higher total lameness incidence was attained in the 8W “upstream” pens (pen 1 for Line B, pen 12 for Line D) when compared with the respective 8W “downstream” pens (pen 11 for Line B, pen 22 for Line D). This effect is believed to be related to temperature stratification and the fact that the chicks grown on wire have their underbellies constantly exposed to circulating air. Temperature stratification was unavoidable because the present experiment was conducted during the summer when tunnel ventilation had to be maintained throughout most of the daylight hours. A pen-location effect also may have influenced the total incidence of clinical lameness within the floor treatments, as the pens for these incremental age and duration studies were arranged sequentially along the length of the house (FIG. 15). Acknowledging these limitations, nevertheless in subsequent figures the total lameness percentages for pens 1 (B-8W) and 12 (D-8W) are used as benchmarks for maximal responses to be expected from the respective Lines B and D.

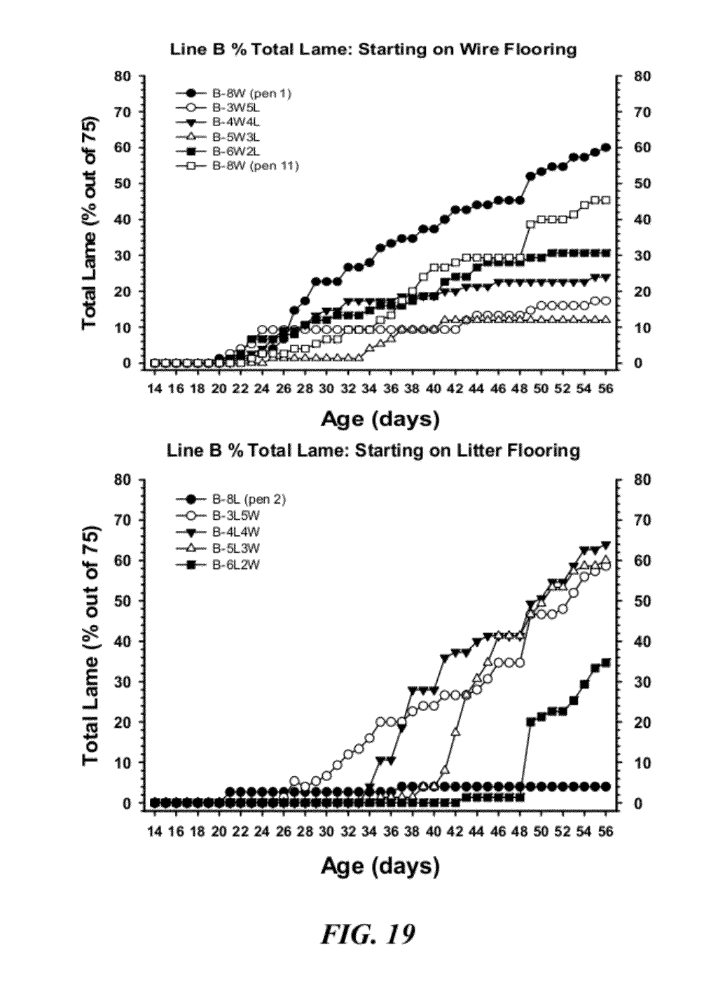

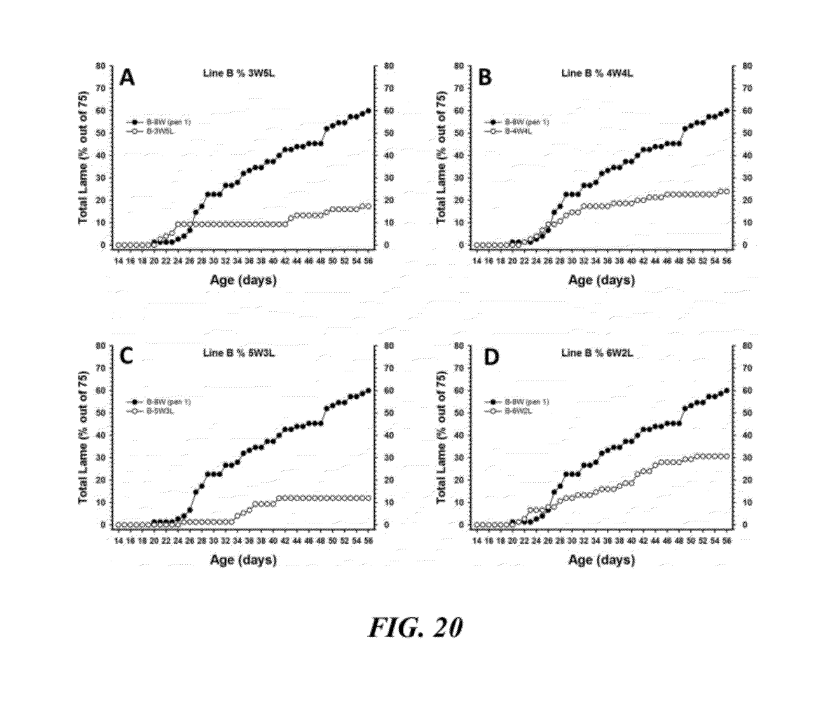

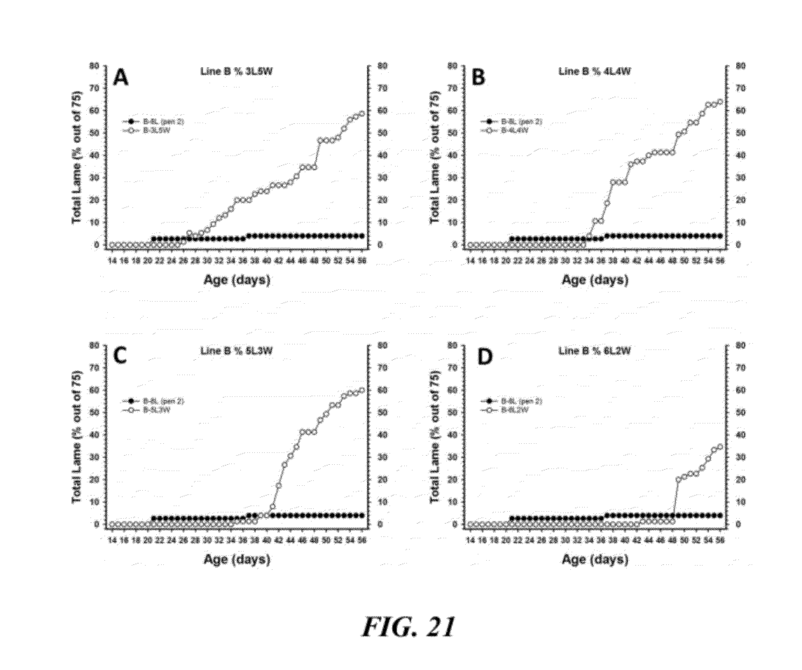

Cumulative percentages of total lameness for all Line B treatments in which the chicks initially were placed on wire flooring or on floor litter are shown as upper and lower panels, respectively, in FIG. 19, or as individual treatments in FIG. 20 (initial wire treatments) and FIG. 21 (initial litter treatments). The upper panel of FIG. 19 graphically illustrates the time course of lameness (percentage incidence between 14 and 56 days of age) for broilers from Line B that: remained on wire flooring for the entire 8 weeks (8W pen 1, 8W pen 11); stayed 3 weeks on wire followed by 5 weeks on litter (3W5L); stayed 4 weeks on wire followed by 4 weeks on litter (4W4L); stayed 5 weeks on wire followed by 3 weeks on litter (5W3L); or, stayed 6 weeks on wire followed by 2 weeks on litter (6W2L). The lower panel of FIG. 19 graphically illustrates the time course of lameness (percentage incidence between 14 and 56 days of age) for broilers from Line B that: remained on floor litter for the entire 8 weeks (8L pen 2); stayed 3 weeks on litter followed by 5 weeks on wire (3L5W); stayed 4 weeks on litter followed by 4 weeks on wire (4L4W); stayed 5 weeks on litter followed by 3 weeks on wire (5L3W); or, stayed 6 weeks on litter followed by 2 weeks on wire (6L2W). As such, the relative incidences of lameness can be varied as desired by changing the duration of exposure to wire flooring and by changing the age at which broilers are exposed to wire flooring.

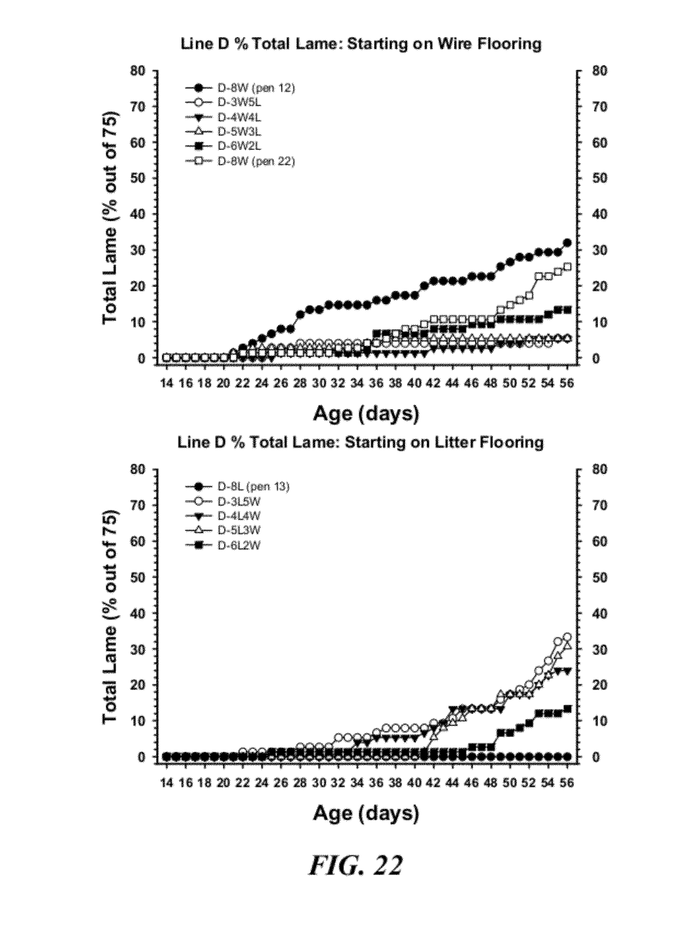

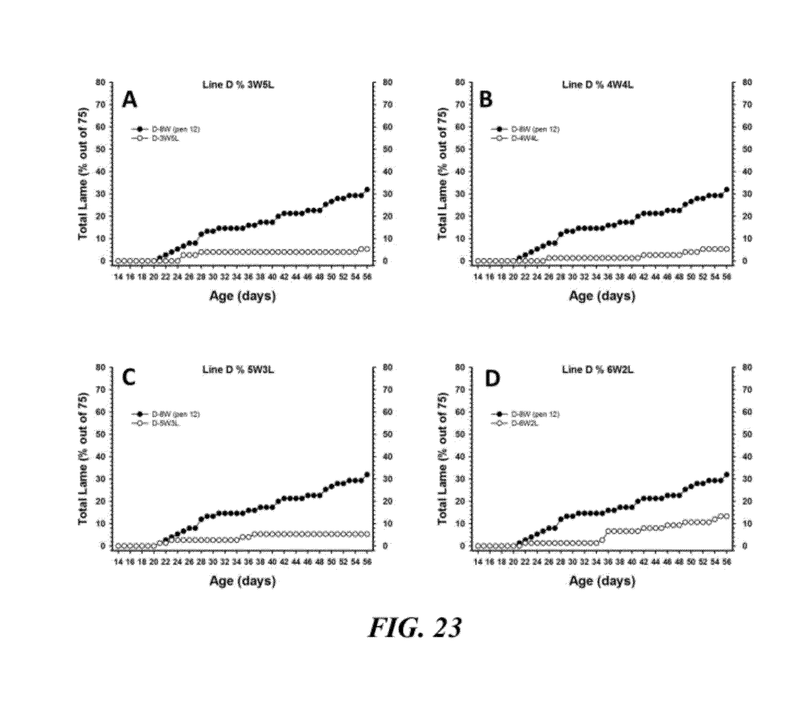

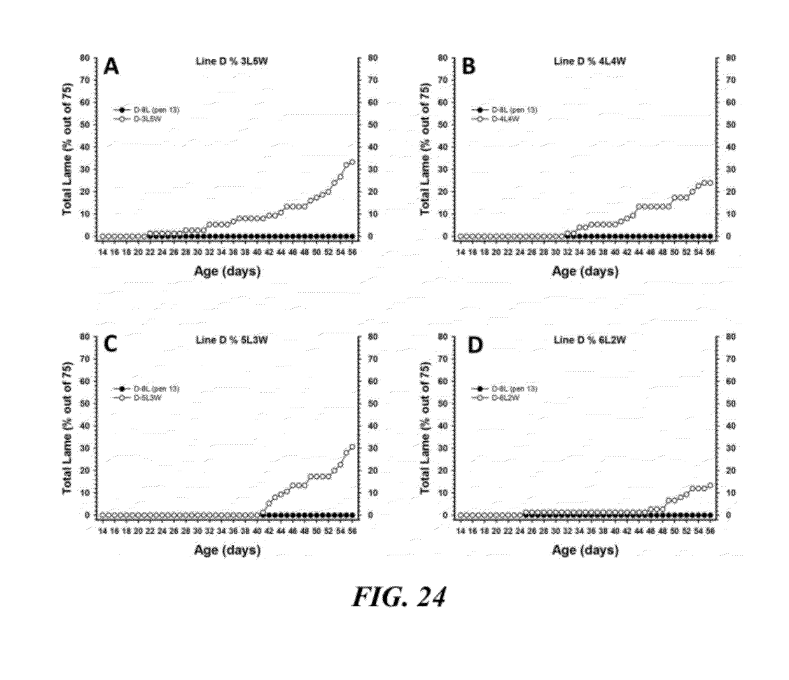

Cumulative percentages of total lameness for all Line D treatments in which the chicks initially were placed on wire flooring or on floor litter are shown as upper and lower panels, respectively, in FIG. 22, or as individual treatments in FIG. 23 (initial wire treatments) and FIG. 24 (initial litter treatments). When chicks from both lines were started on wire and then transferred to litter, lameness incidences were induced in approximate proportion to the duration of residence on the wire flooring. Within 2 days after these chicks were transferred to litter the incidence of lameness either did not increase further, or increased only very gradually through 56 days of age (upper panels in FIGS. 19 and 22; FIGS. 20A-20D and 23A-23D). This approach has potential for development as a selection protocol, the duration of which is adjustable to accommodate line differences in susceptibility and/or the desired level of selection pressure. For example, chicks from Line B can initially be placed on wire flooring from days 1 to 21 (FIG. 20A) or days 1 to 28 (FIG. 20B), and then transferred to floor litter to achieve overall lameness incidences ranging from 10 to 25%. In contrast, chicks from Line D that were initially placed on wire flooring from days 1 to 21 (FIG. 23A) or days 1 to 28 (FIG. 23B) exhibited overall lameness incidences of less than 10%.

When chicks from both lines were started on litter and then transferred to wire, clinical lameness began developing 5 to 7 days after the transfer. With the exception of the 6L2W treatment, the total lameness incidences for all other transfer treatments (3L5W, 4L4W, 5L3W) converged by day 56 at approximately 60% for Line B (FIG. 19, lower panel; FIG. 21A, B, C) or at approximately 30% for Line D (FIG. 22, lower panel; FIG. 24A, B, C). Evidently the initial (day 1) placement on litter masked sub-clinical susceptibility to lameness, but this overall susceptibility was expressed emphatically within a week after the birds were transferred to wire. The slope of the cumulative lameness incidence curves increased in proportion to the age at which the birds were transferred from litter to wire flooring, up to 5 weeks of age (FIGS. 21 and 24).

Table 5 compares the Leg Scores assigned on Day 37 to broilers from Line B and Line D versus the fate of the same individuals as they subsequently either developed clinical lameness or remained able to walk (normal) through 56 days of age. Within each of the Leg Score categories for Line B, ≦38% of the birds subsequently developed clinical lameness, whereas ≧62% were judged to walk reasonably normally through Day 56. Within the Leg Score categories for Line D that included >7 birds, ≦28% of the birds subsequently became lame and ≧72% were judged to walk reasonably normally through Day 56. For birds in the “Normal” Leg Score category, 29% in Line B and 25% in Line D subsequently developed clinical lameness, whereas 71% in Line B and 85% in Line D were judged to walk normally through Day 56. A “Normal” Leg Score was almost as good as any of the other indices in predicting the subsequent onset of clinical lameness in Line B (Table 5). The C-GAP scores on day 37 were poorly predictive of the subsequent fate of birds challenged with wire flooring (Table 6). Within each line, birds that failed the C-GAP test were numerically more likely to remain normal than were birds that passed the C-GAP test.

TABLE 5
Comparison of leg scores assigned on Day 37 to broilers from lines B and
D versus their subsequent fate (lame or clinically normal) by day 56.¹

| | Line B | | | | Line D | | | |
|---|---|---|---|---|---|---|---|---|
| Day 37 Leg Score | Lame | | Normal | | Line D Lame | | Line D Normal | |
| Normal | 28.8% | (17/59)^{x} | 71.2% | (42/59)^{a} | 14.8% | (8/54)^{x} | 85.2% | (46/54)^{a} |
| 14 (bowed in - | 33.3% | (11/33)^{x} | 66.7% | (22/33)^{a} | 27.9% | (12/43)^{x} | 72.1% | (31/43)^{a} |
| mild) | | | | | | | | |
| 15 (bowed in - | 25.0% | (1/4)^{x} | 75.0% | (3/4)^{a} | 27.3% | (3/11)^{x} | 72.7% | (8/11)^{a} |
| severe) | | | | | | | | |
| B4 (bowed out - | 0% | (0/2) | 100% | (2/2) | 0% | (0/7) | 100% | (7/7) |
| mild) | | | | | | | | |
| B5 (bowed out - | 0 | | 0 | | 0 | | 0 | |
| severe) | | | | | | | | |
| J4 (rotated tibia - | 37.5% | (6/16)^{x} | 62.5% | (10/16)^{a} | 6.7% | (1/15)^{x} | 93.3% | (14/15)^{a} |
| mild) | | | | | | | | |
| J5 (rotated tibia - | 0% | (0/1) | 100% | (1/1) | 50.0% | (1/2) | 50.0% | (1/2) |
| severe) | | | | | | | | |

¹Values are shown only for birds grown for 8 weeks in wire flooring in pens 1, 11, 12 and 22; none of the broilers in floor litter pens 2 and 13 developed lameness subsequent to being scored on day 37.
^{x,x or a,a}Values with similar superscripts within a Line and column did NOT differ significantly (P > 0.183) using repeated Z-tests to compare all proportions.

TABLE 6
Comparison of C-GAP pass/fail assignment on Day 37 for broilers from lines B
and D versus their subsequent fate (lame or clinically normal) by day 56.¹

| Floor Type & C- | Line B | | | | Line D | | | |
|---|---|---|---|---|---|---|---|---|
| GAP Score | Lame | | Normal | | Line D Lame | | Line D Normal | |
| Wire Floor: 0 = | 29.7% | (33/111)^{x} | 70.3% | (78/111)^{a} | 18.4% | (21/114)^{x} | 81.6% | (93/114)^{a} |
| Passed | | | | | | | | |
| Wire Floor: 1 = | 25.0% | (1/4)^{x} | 75.0% | (3/4)^{a} | 12.5% | (2/16)^{x} | 87.5% | (14/16)^{a} |
| Failed | | | | | | | | |
| Floor Litter: 0 = | 0% | (0/65) | 100% | (65/65) | 0% | (0/69) | 100% | (69/69) |
| Passed | | | | | | | | |
| Floor Litter: 1 = | 0% | (0/5) | 100% | (5/5) | 0% | (0/5) | 100% | (5/5) |
| Failed | | | | | | | | |

^{x,x or a,a}Values with similar superscripts within a Line and column did NOT differ significantly (P > 0.720) using repeated Z-tests to compare all proportions.
¹None of the broilers in floor litter pens 2 and 13 developed lameness subsequent to being scored on day 37.

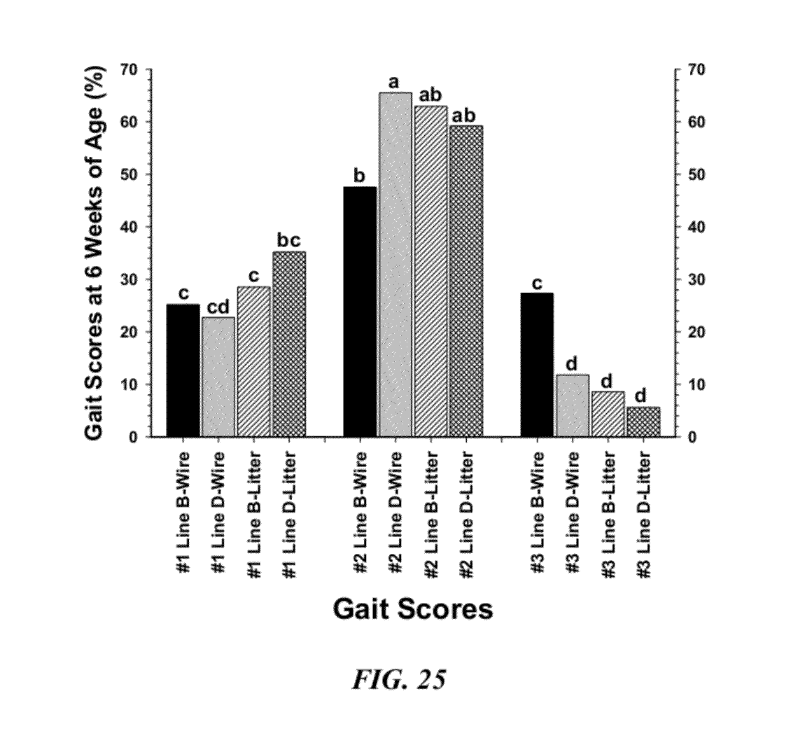

Gait Scoring using the 5 point Bristol system again appeared to reflect differences in susceptibility between birds from Lines B and D that were grown on wire flooring (FIG. 25). Line D is less susceptible than Line B to lameness induced by wire flooring. When compared with Line B, Line D had a significantly higher percentage of birds in Gait Score category #2 and a significantly lower percentages of birds in Gait Score of #3 (FIG. 25). No bird in either line was awarded a gait score of #4 or #5. Diagnostic categories correlated with gait scores for individual birds are summarized in Table 7. For Line B, most (75 to 80%) of the birds awarded gait scores of 1, 2 or 3 remained clinically normal. Increasing gait scores in Line B tended to reflect small numerical increases in FHT, FHN and THN. For Line D, increasing gait scores of 1, 2 or 3 denoted significant step-wise reductions in the numbers of birds that remained clinically normal (e.g., 96% normal for a gait score of #1 vs. 64% normal for a gait score of #3). Gait scores of #3 in Line D tended to reflect a numerical but non-significant increased incidence of FHS.

TABLE 7
Gait scores (1 to 5 system) assigned to broilers from Lines B and D on
day 44 versus the diagnosis categories¹ for those that
subsequently remained clinically normal or developed
lameness by day 56.²

| | | Diagnostic Categories | | | | | |
|---|---|---|---|---|---|---|---|
| Gait | | | LAME | | | | |
| Scores | N | Normal | UNK | FHS | FHT | FHN | THN |
| Line B | | | | | | | |
| 1 | 25 | 80.0% | 4.0% | 0 | 0 | 8.0% | 8.0% |
| | | (20/25)^{x} | (1/25) | | | (2/25)^{x} | (2/25) |
| 2 | 47 | 74.5% | 0 | 2.1% | 2.1% | 10.6% | 10.6% |
| | | (35/47)^{x} | | (1/47) | (1/47) | (5/47)^{x} | (5/47) |
| 3 | 27 | 77.8% | 0 | 0 | 7.4% | 14.8% | 0 |
| | | (21/27)^{x} | | | (2/27) | (4/27)^{x} | |
| 4 | 0 | 0 | 0 | 0 | 0 | 0 | 0 |
| Line D | | | | | | | |
| 1 | 27 | 96.3% | 0 | 3.7% | 0 | 0 | 0 |
| | | (26/27)^{a} | | (1/27)^{x} | | | |
| 2 | 78 | 87.2% | 1.3% | 1.3% | 0 | 10.3% | 0 |
| | | (68/78)^{ab} | (1/78) | (1/78)^{x} | | (8/78) | |
| 3 | 14 | 64.3% | 0 | 28.6% | 0 | 7.1% | 0 |
| | | (9/14)^{b} | | (4/14)^{x} | | (1/14) | |
| 4 | 0 | 0 | 0 | 0 | 0 | 0 | 0 |

¹LAME UNK: cause of lameness could not be determined = unknown; FHS: femoral head separation; FHT: femoral head transitional degeneration; FHN: femoral head necrosis; THN: tibial head necrosis.
²Values are shown only for birds grown for 8 weeks in wire flooring in pens 1, 11, 12 and 22; none of the broilers in floor litter pens 2 and 13 developed lameness subsequent to being gait scored on day 44.
^{x,x or a,a}Values with similar superscripts within a Line and column did NOT differ significantly (P > 0.72 for ^{x,x} or P > 0.71 for ^{a,a}) using repeated Z-tests to compare all proportions.
^{a,b}Within a Line and diagnostic category, values with different superscripts differed significantly at P ≦ 0.05 using repeated Z-tests to compare all proportions.

Placing broilers on wire flooring on days 1-21 or 1-28 induced manageable levels of clinical lameness (10% to 25% in Line B). Thereafter, transferring the survivors to litter either stopped additional birds from developing lameness or the incidence of lameness only increased at very gradual rates. This approach, briefly exposing young chicks to wire flooring then transferring them to litter, potentially might be useful for eliminating the most susceptible individuals from breeding populations.

The experiment revealed innate susceptibility to lameness when birds in the 3L5W, 4L4W and 5L3W treatments were transferred from litter to wire. The incidences of clinical lameness converged by day 56 to approximately 60% for Line B or to approximately 30% for Line D. Placement on litter clearly masked the susceptibility to lameness in many individuals, but this susceptibility began to be revealed within a week after the transfer to wire flooring. It can be speculated that starting chicks on litter permits them to develop a more natural/normal pattern of locomotion that does not unduly stress sub-clinical weaknesses in the proximal leg joints. Sub-clinical weaknesses in the proximal leg joints also appear to increase with age (Table 3). Subsequently transferring the same birds to wire flooring likely imposes an unstable/unfamiliar footing that poses a severe challenge to the leg joints.

THN was analyzed based on reports that lame broilers can exhibit macroscopic and microscopic evidence of necrosis in the proximal head of the tibia even when necrosis is not apparent in the proximal head of the femur. Based on the results of the present study, “macroscopic evidence” of THN is added to diagnostic categories, to be considered when both of the proximal femur heads appear to be normal in clinically lame broilers. THN likely was an important lesion in clinically lame birds that we previously categorized as “Lame-UNK”.

Over the course of these studies evidence continues to accumulate that management and environmental factors can significantly influence the incidence of lameness. For example, in the present study the earliest cases of lameness were recorded prior to day 28 in the 8W treatments (FIG. 17) whereas in previous studies using one or both of the same lines, lameness did not develop on wire flooring until after day 35. Chick quality has an impact on the overall incidence of lameness: so-called “E. Coli runt” can develop rampant FHN within the first week post-hatch. In addition, the present study implicates pen location with respect to cool-cell air inlets (and presumably chilling) as having a measurable impact on the incidence of lameness.

Non-invasive Leg scores based on leg morphology, C-GAP scores and Gait Scores did not reliably predict the subsequent onset of clinical lameness (Tables 5 to 7). These observations do not address the potential usefulness of these leg scoring systems as a selection tool for maintaining the optimal stance and conformation of broilers undergoing selection. Instead, the present data suggest that the onset of lameness attributable to the primary lesions occurring in broilers grown on wire flooring cannot be predicted reliably using non-invasive scoring systems per se. The gait scoring system again appeared to yield results that reflected differences in total lameness between Lines B and D (FIG. 25), but gait scoring curiously was more predictive of the subsequent onset of lameness in individual broilers from Line D than from Line B (Table 7).

### Example 3

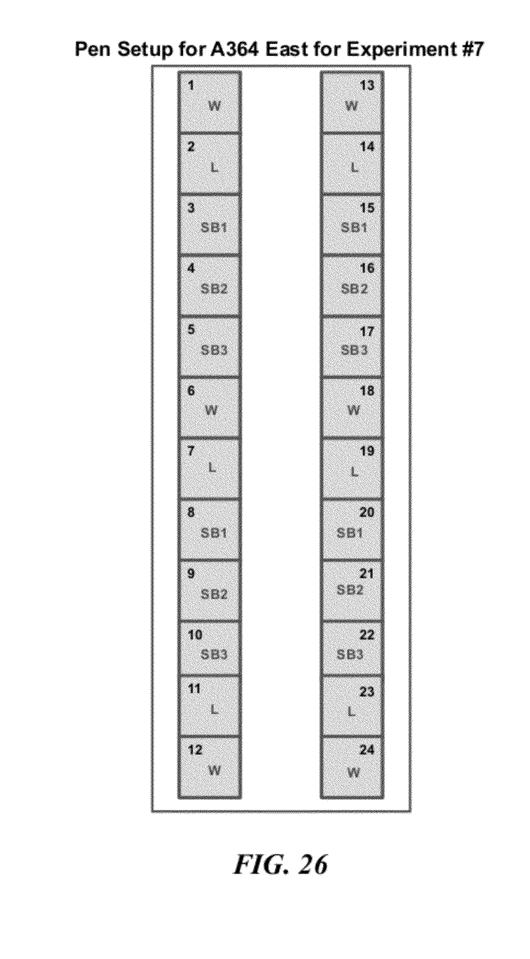

Building A364 East on the University of Arkansas Poultry Research Farm was set up with 24 standard-sized pens (3.05 m×3.05 m). As shown in FIG. 26, pens 1, 6, 12, 13, 18, and 24 were set up with flat wire flooring. All of the remaining pens were set up with clean wood shavings litter. Tube feeders will be provided on one side of the pen and nipple waterers were positioned on the other side of the pen. This arrangement forces the chicks to traverse the floor repeatedly to drink and eat. Chicks initially were placed at 65 per pen and then culled to 60 per pen on day 14. Also at 14 days of age speed bumps having a height of approximately 6 in, 9 in, and 12 in were inserted into the pens designated in FIG. 26 as SB1 (33% slope), SB2 (50% slope) and SB3 (66% slope), respectively. Pens 2, 7, 11, 14, 19, and 23 have floor litter only. All chicks were grown as rapidly as possible throughout the experiment (23 hours of light, full feed, optimal temperature and ventilation conditions). Thermoneutral temperatures were maintained throughout: 90° F. for days 1 to 3, 88° F. for days 4 to 6, 85° F. for days 7 to 10, 80° F. for days 11 to 14, and 75° F. thereafter.

Necropsy observations on dead and lame birds were recorded by day/date, gender and pen number. Birds in all pens were “walked” and observed for lameness every two days beginning on day 15. All birds that develop clinical lameness were humanely euthanized, necropsied, and assigned to one of the following categories:
Normal=Femur head and proximal tibia appear entirely normal
Cull=Runts and individuals that failed to thrive or appeared to be clinically ill
U=Unknown cause of death
NE=Necrotic Enteritis
SDS=Sudden Death Syndrome (Flipover, Heart Attacks)
PHS=Pulmonary Hypertension Syndrome, Ascites
KB=Kinky Back (Spondylolisthesis)
TW=Twisted Leg or Slipped Tendon (Perosis)
TD=Tibial Dyschondroplasia
Lame-UNK=Lameness for undetermined reasons
FHS=Proximal Femoral Head Separation (epiphyseolysis)
FHT=Proximal Femoral Head Transitional degeneration
FHN=Proximal Femoral Head Necrosis (bacterial chondronecrosis with osteomyelitis, BCO)
TNH=Proximal Tibial Head Necrosis
Total Lame=KB+TW+UNK+TD+FHS+FHT+FHN+THN

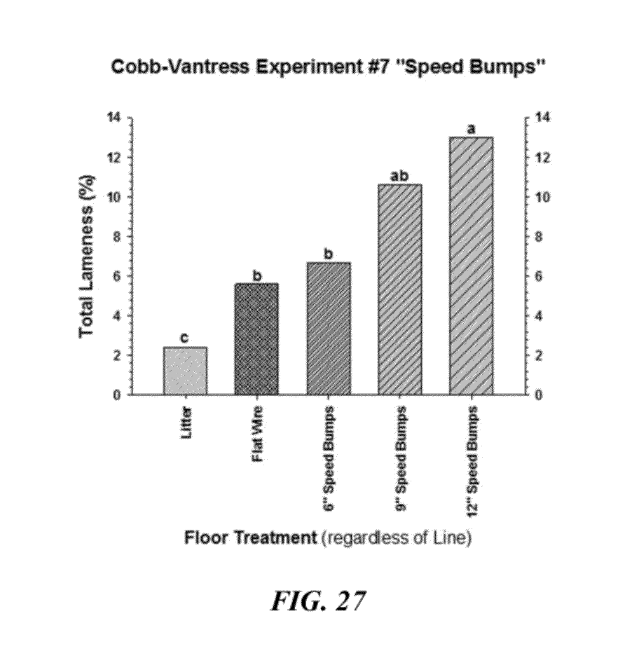

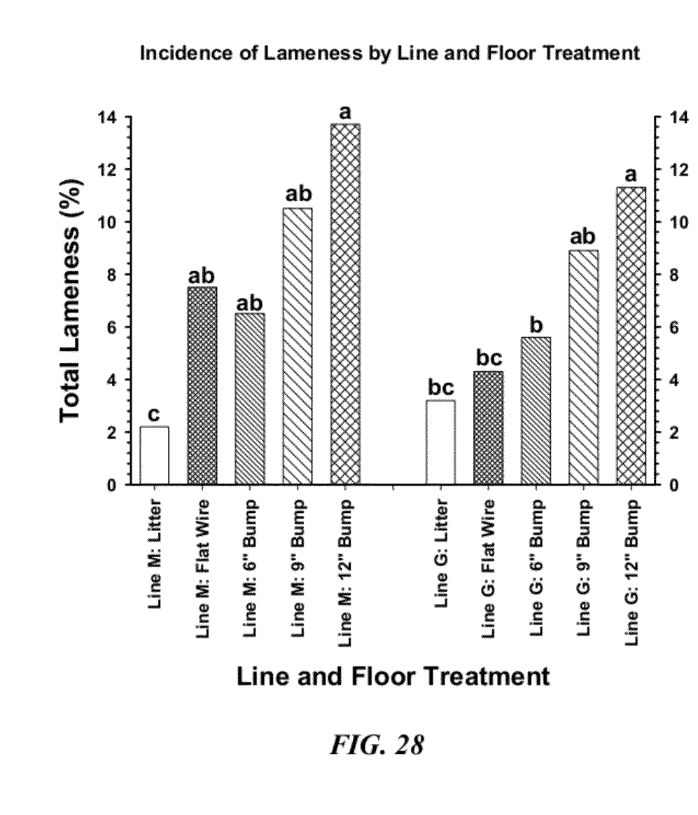

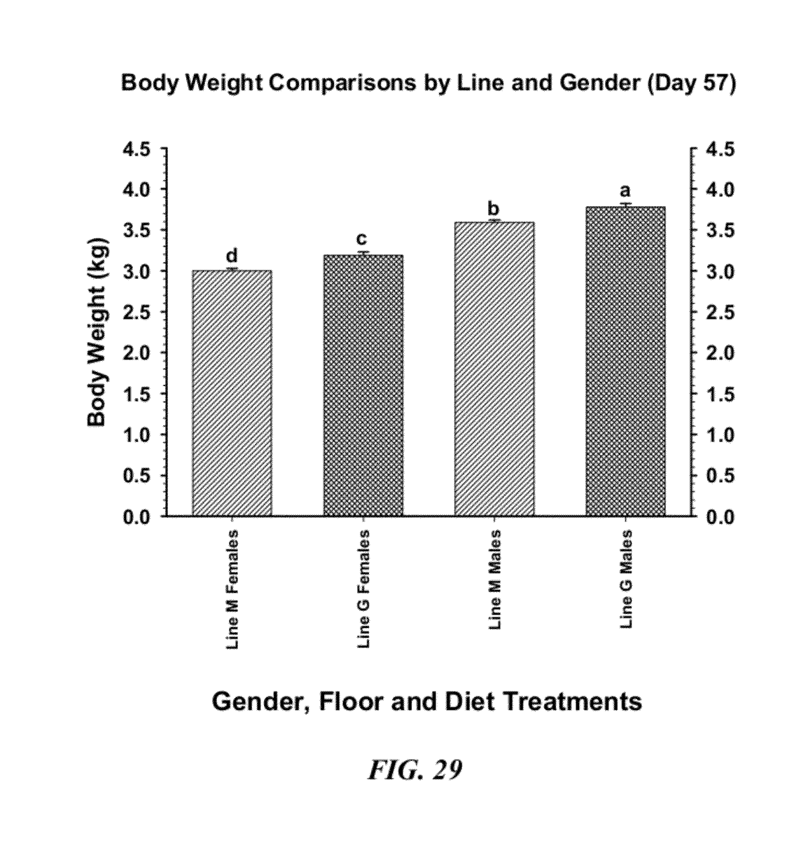

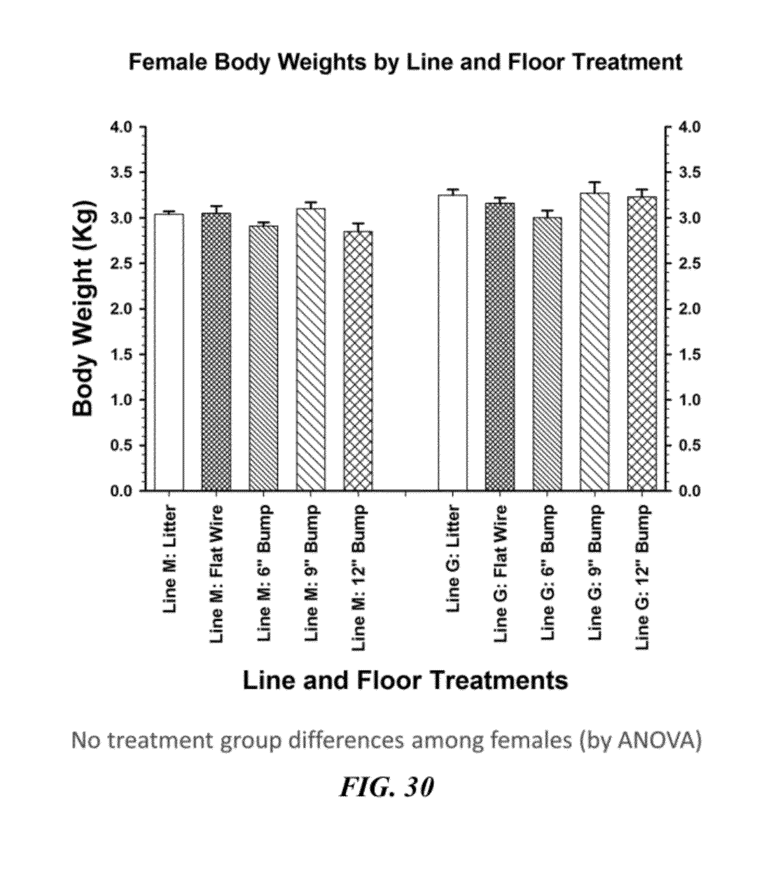

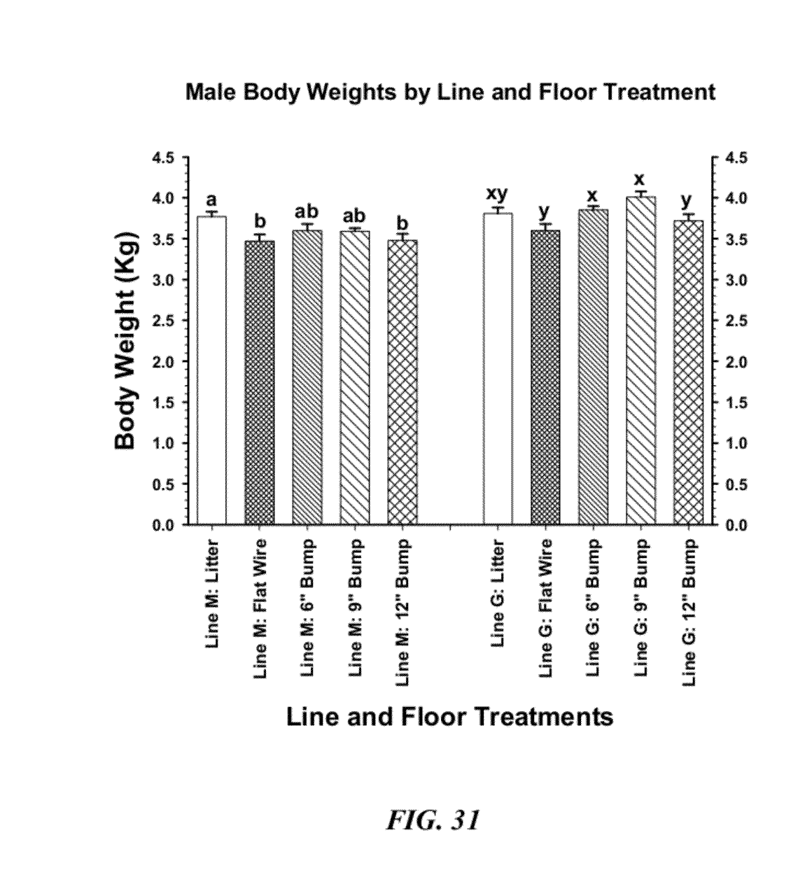

THN is diagnosed when necrotic voids in the subchondral bone extended from the metaphysis proximally up to or into the epiphyseal plate, thereby to undermining the bony structural support for the epiphyseal plate and articular cartilage. The 9 in and 12 in speed bumps generated approximately twice as much lameness than with the flat wire flooring, which in turn generated about twice as much lameness than on the wood shavings litter. Even with a very low incidence of lameness in these lines, nevertheless the “speed bumps” are numerically more effective than our standard flat wire flooring panels (FIGS. 27 through 31).

### Example 4

In an initial study, 51% of the broilers in Line C and 28% of those in Line D developed lameness when grown on wire (P=0.007 when all diet treatments were combined). Furthermore, for broilers from Line C grown on wire, adding the Biomin probiotic PoultryStar® to the feed reduced the percentage of lameness by half when compared with broilers that received the control diet alone (P=0.011). A second study was conducted to determine if the Biomin probiotic would again reduce lameness in broilers from Line B reared on wire flooring, and to compare the efficacy of Biomin probiotic alone or in combination with clean wood shavings added to the feed as a prebiotic. When all of the lameness categories were pooled as the “Lame Total”, the highest lameness percentage (28%) occurred in birds that were fed the control diet while being reared on wire flooring, whereas birds fed the same diet but grown on wood shavings had the lowest lameness percentage (8%). Adding the Biomin probiotic to the feed reduced the total lameness percentage to 8% for broilers grown on wire flooring (P=0.01), which equaled the 8% incidence observed in broilers in the Shavings-Control group. Adding wood shavings to the feed tended to reduce the efficacy of the Biomin probiotic (16% total lameness). As expected, males were significantly heavier than females on day 56 but there were no gender differences in Total Lameness, and there was no evidence that sub-clinical femoral head lesions tended to occur in the heaviest individuals within each gender. Absolute body weight per se evidently is not the sole determining factor responsible for the development of sub-clinical femoral head lesions that subsequently can evolve into definitive clinical lameness.

In both of the prior studies, the chicks were placed on wire flooring beginning at 1 day of age, and the Biomin probiotic was included in the feed from days 1 through 56. The primary objective of this experiment was to determine if the Biomin probiotic could effectively reduce lameness when added to the feed 28 days after the chicks were placed on wire flooring.

Environmental chambers 7, 8, 9 and 10 (dimensions: 3.7 m long×2.5 m wide×2.5 m high) within the Poultry Environmental Research Lab at the University of Arkansas Poultry Research Farm (Building A304) were used for this study. These chambers utilize single-pass ventilation at a constant rate of 6 m³ per minute. The photoperiod was set for 23 h light:1 h dark for the entire experiment. Thermoneutral temperatures were maintained throughout: 32° C. for days 1 to 3, 31° C. for days 4 to 6, 29° C. for days 5 to 10, 26° C. for days 11 to 14, and 24° C. thereafter. One pen with the dimensions of 5×10 feet was set up in each chamber. The pen in chamber 7 had with fresh wood shavings litter on the floor to serve as the control treatment in which the lowest incidence of lameness was anticipated. The three remaining pens had raised wire flooring. Two tube-type feeders and one row of nipple waterers were provided per pen. Cobb-Vantress starter feed (crumbles) was provided ad libitum as the control diet in Chambers 7 and 8. In chamber 9 the Biomin probiotic Poultry Star® was mixed with the feed throughout the experiment (50 lb of the control diet mixed with 12.5 g Biomin probiotic Poultry Star®; mixed at 500 g/ton of feed). In chamber 10, chicks were fed the control feed until day 28, after which the Biomin probiotic was mixed with the feed for the remainder of the experiment (50 lb of the control diet mixed with 12.5 g Biomin probiotic Poultry Star®).

Male broilers from Line B were wing banded on day 1, and 60 were placed in each chamber. All chambers were culled to 50 birds/pen on day 14. Birds in all pens were “walked” and observed for lameness every two days beginning on Day 15. Birds were diagnosed as being lame and were humanely euthanized (CO2 gas inhalation) when they were unable to walk. All birds that died or developed clinical lameness were recorded by wing band number and pen number, necropsied, and assigned to one of the following categories:

U=Unknown cause of death

NE=Necrotic Enteritis

SDS=Sudden Death Syndrome, Flipover, Heart Attacks

PHS=Pulmonary Hypertension Syndrome, Ascites

KB=Kinky Back=Spondylolisthesis

TW=Twisted Leg or Slipped Tendon (Perosis)

TD=Tibial Dyschondroplasia

Lame-UNK=Lameness for unspecified reasons

FHS=Proximal Femoral Head Separation

FHT=Proximal Femoral Head Transitional degeneration

FHN=Proximal Femoral Head Necrosis

THN=Proximal Tibial Head Necrosis

Twenty-five birds per chamber that survived to day 56 without developing clinical lameness were humanely euthanized with CO₂ gas and necropsied to evaluate the incidence of sub-clinical macroscopic lesions in each proximal femoral head and each proximal tibial head. Lameness incidences and proportions were compared using repeated Z-tests (Sigma-Stat).

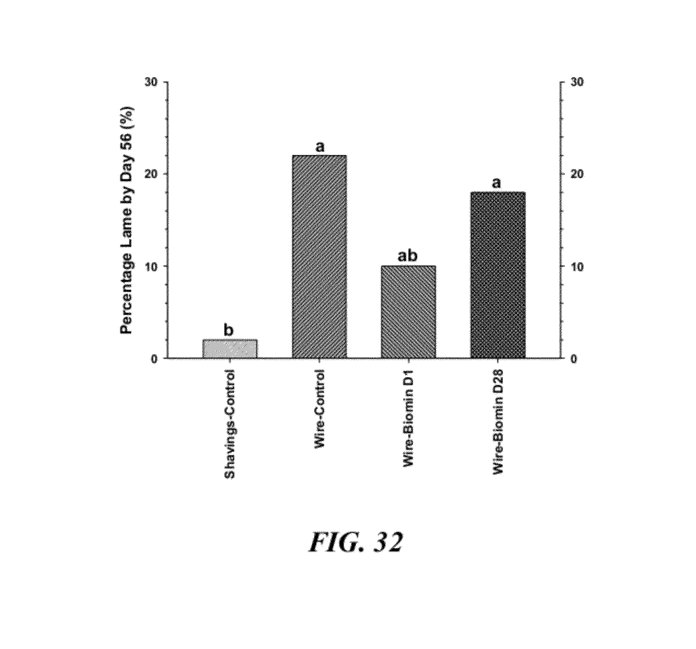

Table 8 below summarizes the necropsy data by treatment and diagnostic category for birds that developed clinical lameness from 14 to 56 days of age. The most prevalent diagnoses for lame birds were THN, FHN and Lame-UNK. When all of the separate lameness categories were pooled as the “Lame Total” (Table 8, FIG. 32), the highest lameness percentage (22%) occurred in birds that were fed the control diet while being reared on wire flooring (Wire-Control group), whereas birds fed the same diet but grown on wood shavings (Shavings-Control group) had the lowest lameness percentage (2%; P=0.006). Adding the Biomin probiotic to the feed beginning on day 1 reduced the total lameness percentage to 10% for broilers grown on wire flooring (Wire-Biomin D1 group), which was intermediate (P=0.173) between the Shavings-Control and Wire-Control groups. Adding the Biomin probiotic at 28 days of age (Wire-Biomin D28 group) resulted in 18% total lameness, which did not differ from the 22% value for the Wire-Control group (P=0.803). Lameness due to TW (twisted Leg/Slipped Tendon) technically is not a lesion of the proximal femur or tibia. However, even if deleting this category can be justified, nevertheless the resulting 8% total lameness for the Wire-Biomin D1 group still did not differ from the 22% incidence for the Wire-Control group (P=0.09).

TABLE 8
Diagnostic categories¹ for clinically lame male broilers from Line B
that from day 1 through day 56 were reared on wood shavings litter or
wire flooring and were fed the control feed alone or control feed mixed
with Biomin probiotic beginning at 1 or 28 days of age¹

| | | Lame | | | | | | Lame |
|---|---|---|---|---|---|---|---|---|
| Floor | Feed | UNK | TW | FHS | FHT | FHN | THN | Total² |
| Shav- | Control | 0 | 0 | 0 | 0 | 1 | 0 | 2% |
| ings | | | | | | | | (1/50)^{b} |
| Wire | Control | 2 | 0 | 2 | 1 | 2 | 4 | 22% |
| | | | | | | | | (11/50)^{a} |
| Wire | Biomin | 1 | 1 | 0 | 0 | 3 | 0 | 10% |
| | Day 1 | | | | | | | (5/50)^{ab} |
| Wire | Biomin | 2 | 0 | 0 | 0 | 1 | 6 | 18% |
| | Day 28 | | | | | | | (9/50)^{a} |

¹LAME UNK: cause of lameness could not be determined = unknown; TW: twisted leg/slipped tendon; FHS: femoral head separation; FHT: femoral head transitional degeneration; FHN: femoral head necrosis; THN: tibial head necrosis.
²Each group began with 50 chicks on day 14.
^{a,b}Values with different superscripts differed significantly at P ≦ 0.05 using repeated Z-tests to compare all proportions.

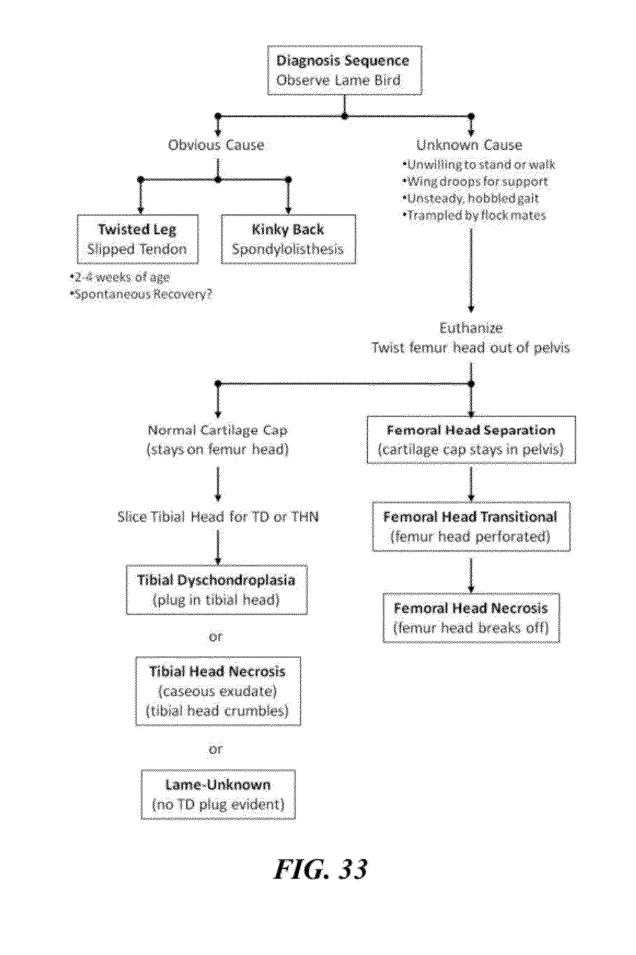

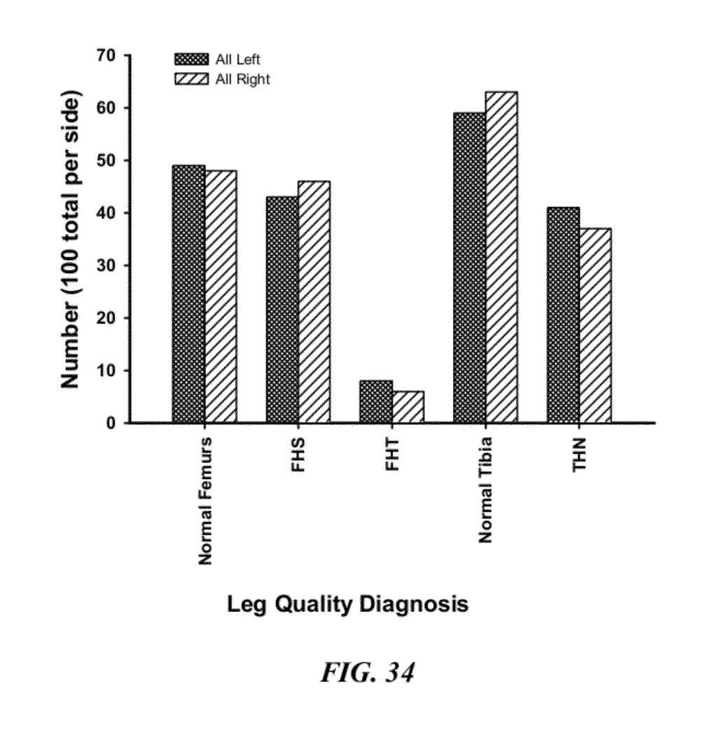

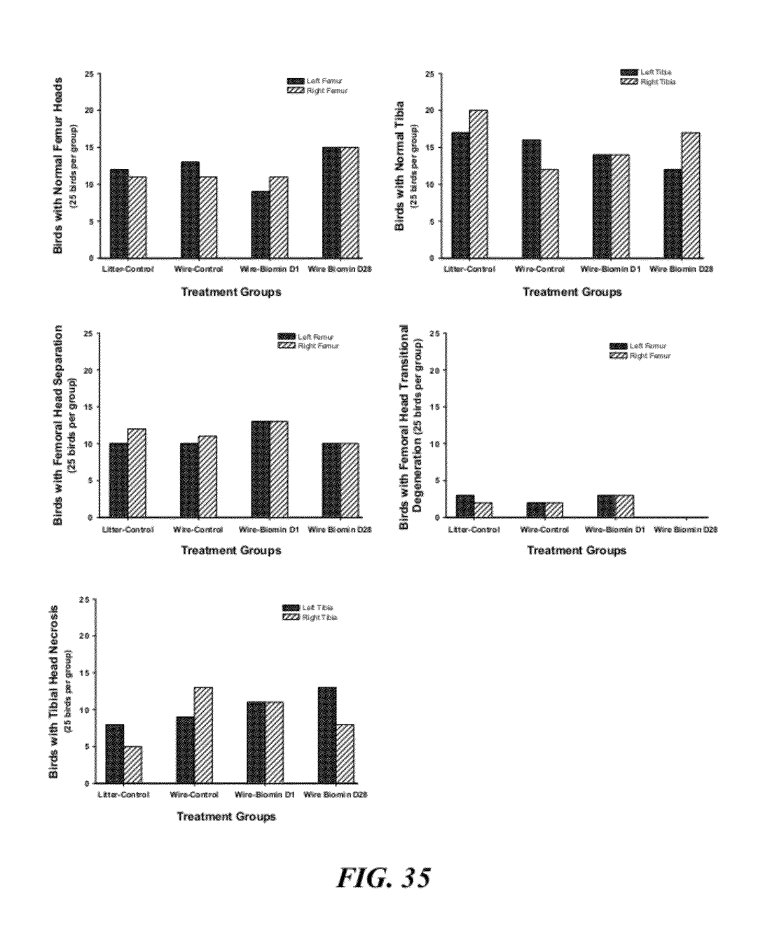

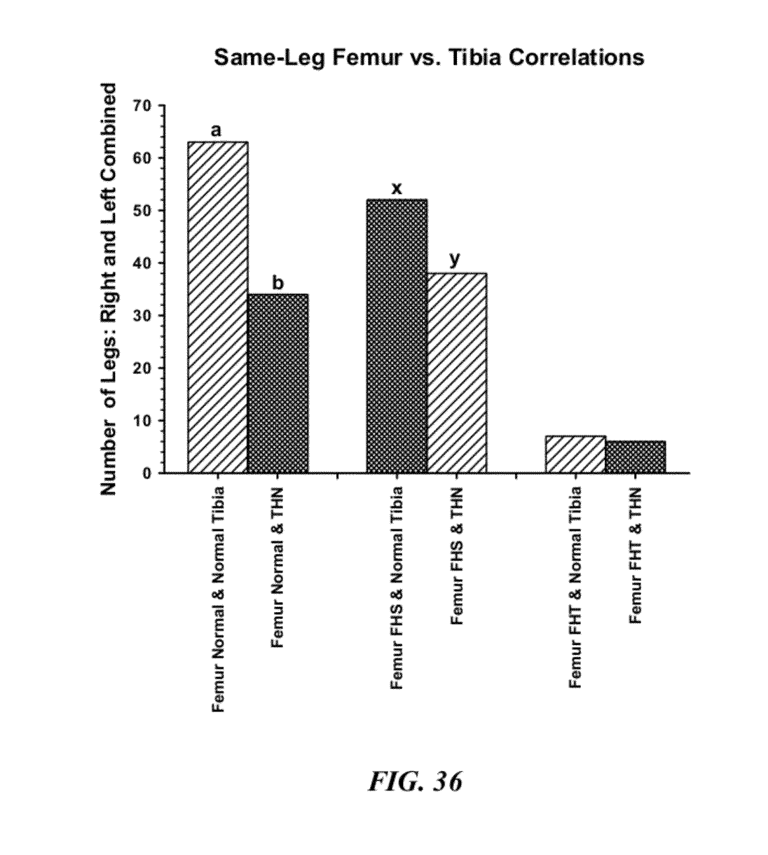

Based on the normal diagnostic sequence (FIG. 33), only clinically lame birds that do not have obvious lesions of the proximal femur head typically would be evaluated for TD and THN. In the present study, 25 birds per chamber that did not develop clinical lameness were necropsied on day 56 to evaluate the incidence of sub-clinical macroscopic lesions in each proximal femur head and each proximal tibial head. When pooled by diagnostic category independent of treatment group, there was no evidence that any of the sub-clinical lesions preferentially formed in either the left or right leg (FIG. 34). Within each diagnostic category, there was no evidence that sub-clinical lesions formed differentially among the treatment groups (FIG. 35). Regardless of whether the proximal femur head was normal or exhibited femoral head separation (FHS) or femoral head transitional degeneration (FHT), within the same leg (right and left legs combined) the ipsilateral (same-side) proximal tibial head was significantly (Femur Normal, Femur FHS) or numerically (Femur FHT) more likely to remain normal than to exhibit macroscopic indications of THN (FIG. 36).

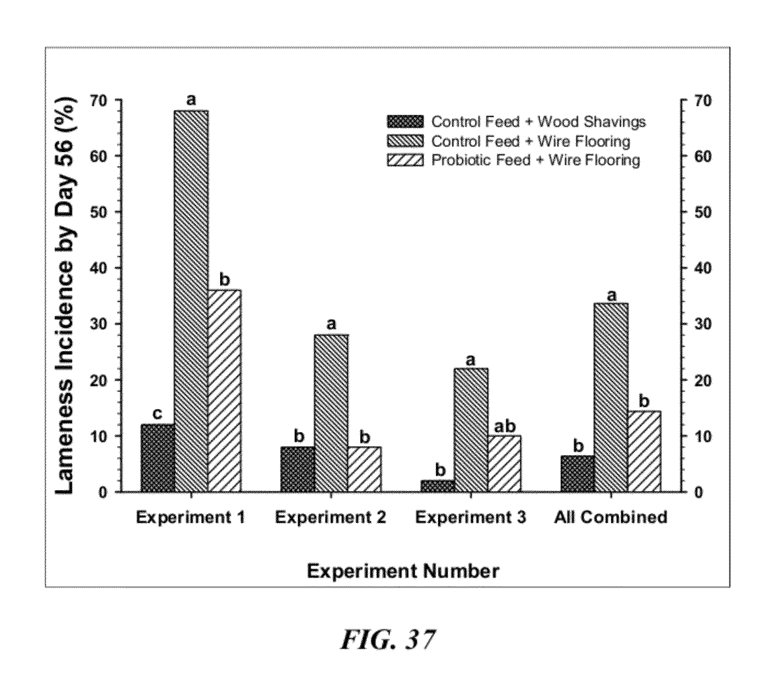

The most significant results of these Biomin studies are shown in Table 9 and FIG. 37. Adding the probiotic to the feed beginning at 1 day of age consistently and significantly reduced but did not completely eliminate the subsequent onset of lameness. Undoubtedly the wire flooring model is a difficult challenge to overcome. Nevertheless, the probiotic treatment was consistently efficacious in three separate studies, regardless of line or gender.

TABLE 9
Percentage incidence of lameness in broilers from two lines (B or C) that
were fed control broiler starter feed (Control Feed) or the same feed
containing Poultry Star probiotic (Probiotic Feed) while being reared
on wood shavings litter or wire flooring from 1 through 56 days of age.

| | | | Control Feed + | | Control Feed + | | Probiotic Feed + | |
|---|---|---|---|---|---|---|---|---|
| Experiment | Line | Gender | Wood Shavings | | Wire Flooring | | Wire Flooring | |
| 1 | C | M & F | 12% | (3/25)^{b} | 68% | (17/25)^{a} | 36% | (9/25)^{b} |
| 2 | B | M & F | 8% | (4/50)^{b} | 28% | (14/50)^{a} | 8% | (4/50)^{b} |
| 3 | B | M | 2% | (1/50)^{b} | 22% | (11/50)^{a} | 10% | (5/50)^{ab} |
| Combined | C & B | M & F | 6.4% | (8/125)^{c} | 33.6% | (42/125)^{a} | 14.4% | (18/125)^{b} |

^{a,b,c} Values with different superscripts within an experiment differ significantly (P ≦ 0.05).

In experiment 3, the highest total lameness percentage (22%) developed when birds from Line B were fed the control diet while being reared on wire flooring (Wire-Control group), whereas birds fed the same diet but grown on wood shavings (Shavings-Control group) had the lowest total lameness percentage (2%; P=0.006). Adding the Biomin probiotic PoultryStar® to the control feed beginning at 1 day of age reduced the total lameness percentage to 10%, a level that was statistically intermediate between the Shavings-Control and Wire-Control values. Adding Biomin probiotic PoultryStar® to the control feed beginning at 28 days of age led to an 18% incidence of lameness, which was not statistically different from the 22% Wire-Control values, but was significantly higher (P=0.036) than the 2% Shavings-Control value. These data support the need to include the Biomin probiotic in the feed beginning at a very early age. The probiotic is not an “antibiotic” and seems unlikely to be effective if administered only after lameness has developed in a flock.

In this study the incidence of sub-clinical macroscopic lesions in each proximal femoral head and each proximal tibial head of 25 surviving broilers per treatment group at 56 days of age was also evaluated. Sub-clinical lesions were equally likely to develop in left and right legs (FIG. 34). Furthermore, the status of the proximal femoral head (normal, FHS or FHT) did not consistently determine the status of the ipsilateral (same-side) proximal tibial head (normal or THN) (FIG. 36). These observations are not consistent with uniform (systemic) pathogen distribution throughout all proximal leg joints. Instead, these observations suggest that sub-clinical mechanical or physiological damage can occur to one proximal head of a leg bone, and that this damage then becomes susceptible to inflammation and infection.

The necropsy results for 25 birds per group on day 56 did not reveal differential incidences of sub-clinical lesions such as FHS, FHT or THN among the four treatment groups (FIG. 35). Accordingly, the Biomin probiotic does not appear to reduce the development of early femoral head lesions (FHS, FHT) or tibial head lesions (THN) in birds that are not clinically lame. These sub-clinical lesions may have primarily a mechanical or physiological etiology. Instead, the Biomin probiotic may prevent or attenuate the progressive deterioration of early femoral or tibial head lesions into the pathogen-associated degenerative changes that cause terminal lameness in broilers.

The cumulative data derived from these studies using different broiler lines provide encouraging support for the efficacy of the Biomin probiotic in reducing the incidence of lameness in two separate broiler lines and in both genders (Table 9, FIG. 37).

### Example 5

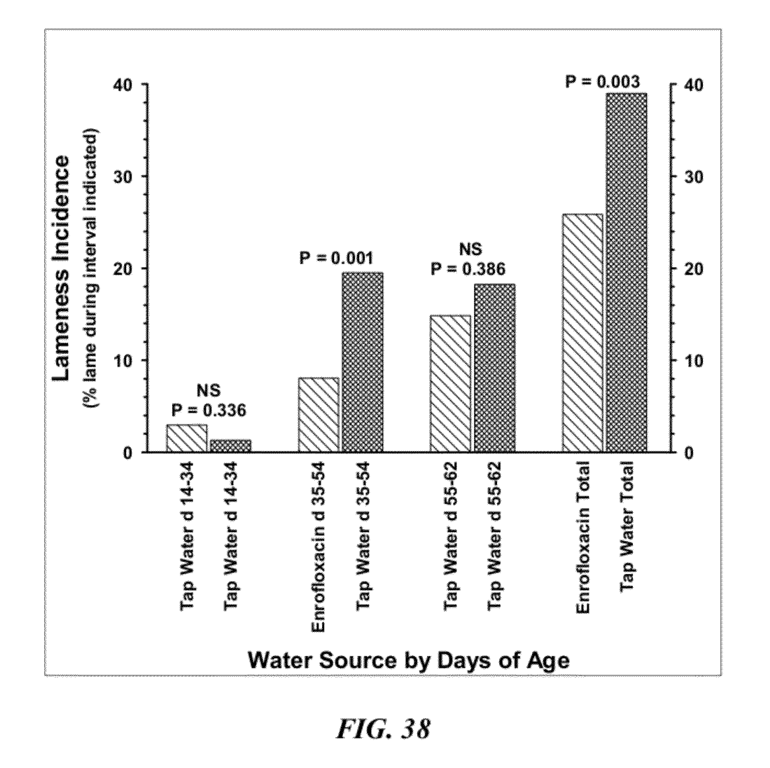

Enrofloxacin is a broad-spectrum fluoroquinolone antimicrobial that is used to treat diseases of bacterial or mycoplasmal origin. Enrofloxacin exerts toxic effects on articular-epiphyseal cartilage when administered at excessively high levels to rapidly growing animals. In a pilot study it was demonstrated that administering 150 mg enrofloxacin/kg BW/d for 5 d failed to trigger clinical lameness in broilers. Accordingly in the present study enrofloxacin was administered in the drinking water at approximately 15 mg/kg BW/d to evaluate its efficacy as a therapeutic treatment for lameness. Broiler chicks were placed at 1 d of age on 5 ft×10 ft flat wire floor panels within eight environmental chambers. They were provided ad libitum corn and soybean meal-based starter and finisher diets formulated to meet NRC standards for all ingredients. Each pen contained 59 clinically healthy chicks on d 14. The birds in all pens were walked and observed for lameness every two d starting on d 15 and continuing through d 62. After the onset of clinical lameness on d 35, enrofloxacin was added to the drinking water (60 mg/L) in the even numbered chambers (enrofloxacin group). Broilers in the odd numbered chambers continued to receive tap water (Control group). Birds unable or unwilling to walk were diagnosed as ‘clinically lame’, euthanized with CO₂ gas, and necropsied to assess leg lesions. The most prevalent diagnoses for lame birds were osteochondrosis and osteomyelitis of the proximal femur and tibia. The Control group developed more than twice the incidence of clinical lameness when compared with the enrofloxacin group on d 42 (P=0.005; z-test of proportions; chambers pooled), and this difference persisted until enrofloxacin administration ceased on d 54. The results this study as illustrated in FIG. 38 demonstrate that enrofloxacin is an effective therapeutic treatment for reducing the incidence of clinical lameness in broilers grown on wire flooring.

### Example 6

This experiment was to assess modifications to enhance the torque and shear stress imposed by speed bumps on broilers' legs. Forcing the broilers to walk on a wire slope is more stressful to their legs (and thus more likely to reveal susceptibility to lameness) than permitting them to fly up to, or jump down from, the apex of the speed bump. The objectives of this experiment were to: 1) continue developing the speed bump design as an easily portable challenge model for routinely inducing reasonable incidences of lameness; 2) compare the incidences of lameness in birds from Lines A (Line 12) and B (Line 58) reared on floor litter, flat wire flooring, or floor litter with speed bumps inserted at four weeks of age; and 3) evaluate modifications designed to improve the efficacy of speed bumps for triggering suitable incidences of lameness.

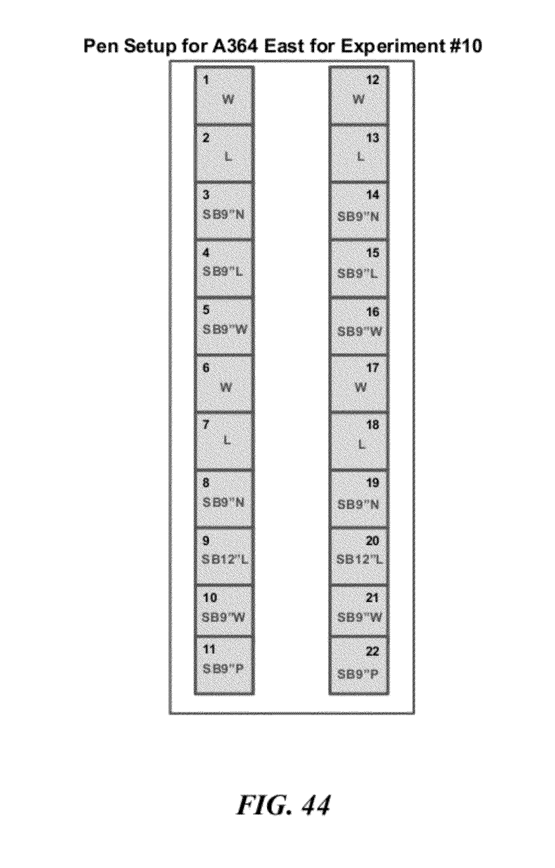

Animal procedures were approved by the University of Arkansas Institutional Animal Care and Use Committee (Protocol #11002). Building A364 East on the University of Arkansas Poultry Research Farm was set up with 22 pens (10′×10′) as diagrammed in FIG. 44. Pens 1, 6, 12, and 17 had flat wire flooring (W) (FIG. 3). All remaining pens had clean wood shavings litter flooring. Pens 2, 7, 13 and 18 had litter flooring throughout the experiment (L), whereas speed bumps were inserted in the remaining pens on day 28. Normal 9″ speed bumps were inserted into pens 3, 8, 14 and 19 (SB9″N) (FIG. 6). A limbo bar was placed over the apex of 9″ or 12″ speed bumps in the center of pens 4 and 15 (SB9″L) or 9 and 20 (SB12″L) between the feeders and waterers (FIGS. 39 and 40). As illustrated in FIGS. 39 and 40, the base may be a 9″ or 12″ speed bump, with vertical bar supports attached at each end. A row of holes in each support permits the height of the limbo bar to be adjusted as necessary to force the birds to stoop under the bar as they walked over the apex of the speed bump. By preventing the birds from attempting to “fly” up to the top of the speed bump and jumping down and forcing the birds to pause before going under the limbo bar, they are more likely to stress their leg joints by walking up and down on the sloping wire. Normal 9″ speed bumps also were placed underneath the nipple waterers in pens 5, 10, 16 and 21 (SB9″W) (FIG. 41). By forcing the birds to stand at the speed bump's apex to drink, they were repeatedly subjected to unstable footing from consistently walking up and down the sloping wire resulting in twisting and slippage caused by the unstable footing. Pens 11 and 22 had 9″ speed bumps with pagoda tops (SB9″P) (FIGS. 42 and 43). The top may be secured to the vertical supports to permit the height to be adjusted as needed to force birds to stoop under the overhanging eaves as they cross the apex of the speed bump. The top was kept low enough to force the birds to duck-walk up and down the sloping wire.

On day 1, male and female chicks from Lines A and B were delivered in excellent health. The chicks received standard hatchery vaccinations. Chicks from Line B were placed in pens 1 through 11 and chicks from Line A were placed in pens 12 through 22. The chicks initially were placed at 70 per pen, then on day 14 the bird density was reduced to 65 per pen. All chicks were grown as rapidly as possible, with 23 hours of light per day, ad libitum feed and water, and optimal ventilation throughout the experiment. Thermoneutral temperatures were maintained to the extent possible: 90° F. for days 1 to 3, 88° F. for days 4 to 6, 85° F. for days 7 to 10, 80° F. for days 11 to 14, and 75° F. thereafter. All birds were fed starter feed (crumbles) through 35 days of age, and finisher feed (pellets) thereafter. Birds in all pens were observed walking every 2 days beginning on day 15. The onset of lameness began on day 16. Affected broilers were reluctant to stand, exhibited an obvious limping gait while dipping one or both wing tips, and finally were completely immobilized. As was noted in the earlier examples, in the present study broilers, the speed bump pens received particular attention when they obviously lagged behind the growth performance of their pen mates. These smaller birds were gently encouraged (with a broom) to cross the speed bumps. If they were unable to do so, then they were classified as being clinically lame, regardless of whether they were able to stand and take several steps on the litter. This cohort accounted for at least 15% of the birds diagnosed as being “clinically lame” in pens with speed bumps. Lame birds were euthanized with CO₂ and necropsied. Birds that died spontaneously after day 14 also were necropsied. Clinically healthy birds in floor litter pens also were sampled, then the lame and clinically healthy birds were euthanized and necropsied. Birds were evaluated according to the following categories:

Cull=Runts and moribund individuals that failed to thrive

UNK=Unknown cause of death

SDS=Sudden Death Syndrome (Flipover, Heart Attacks)

PHS=Pulmonary Hypertension Syndrome (Ascites)

LAME-UNK=Lameness for unknown/undetermined reasons

KB=Kinky Back (Spondylolisthesis)

TW=Twisted Leg or Slipped Tendon (Perosis)

Normal F=Femur head appears entirely normal

FHS=Proximal Femoral Head Separation (epiphyseolysis; early BCO)

FHT=Proximal Femoral Head Transitional degeneration (BCO)

FHN=Proximal Femoral Head Necrosis (BCO)

Normal T=Tibia head appears entirely normal

THN=Mild Proximal Tibial Head Necrosis (BCO)

THNs=Severe Proximal Tibial Head Necrosis (BCO)

THNc=Caseous Proximal Tibial Head Necrosis (BCO)

TD=Tibial Dyschondroplasia

THN lesions were recorded as being “severe” (THNs) when the growth plate obviously was threatened or damaged by a large THN necrotic void. THN lesions were considered caseous (THNc) when caseous exudates or sequestrae provided gross macroscopic evidence of bacterial infection.

The total incidence of femoral head lesions was calculated as: Total Femur ═(FHS+FHT+FHN). The total incidence of tibial head lesions was calculated as: Total Tibia=(THN+THNs+THNc). The total incidence of lameness was calculated as: Total Lame=(KB+TW+LAME-UNK+TD+Total Femur+Total Tibia). Lameness incidences were calculated based on N=65 per pen. The SigmaStat® ANOVA package (Jandel Scientific, 1994) was used to compare body weights among lines, floor treatments and genders. For comparisons of lameness and lesion incidences, individual birds or individual legs were used as the experimental unit, and the SigmaStat® Z-test procedure was used to compare proportions.

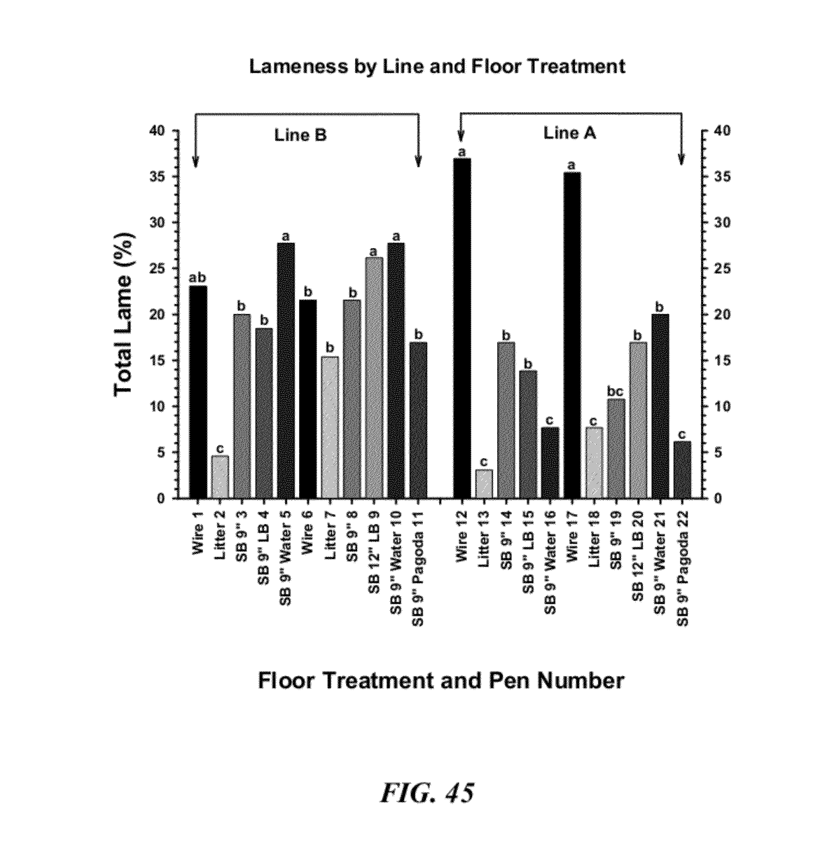

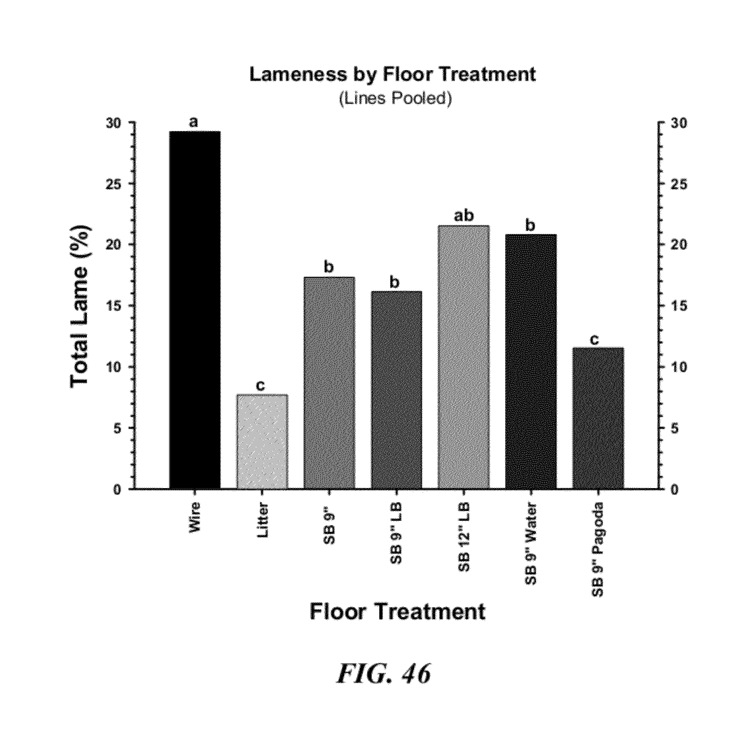

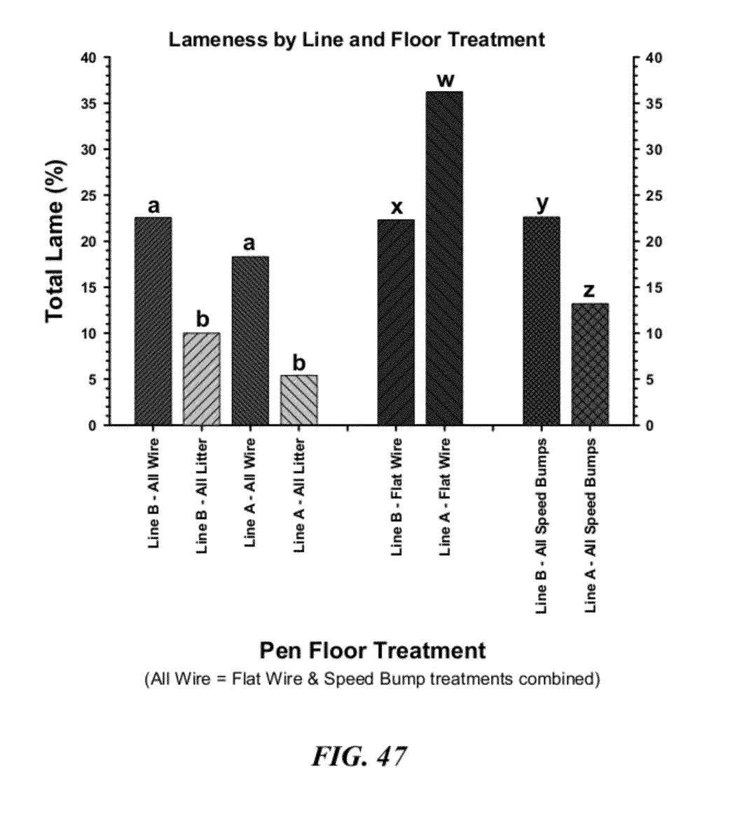

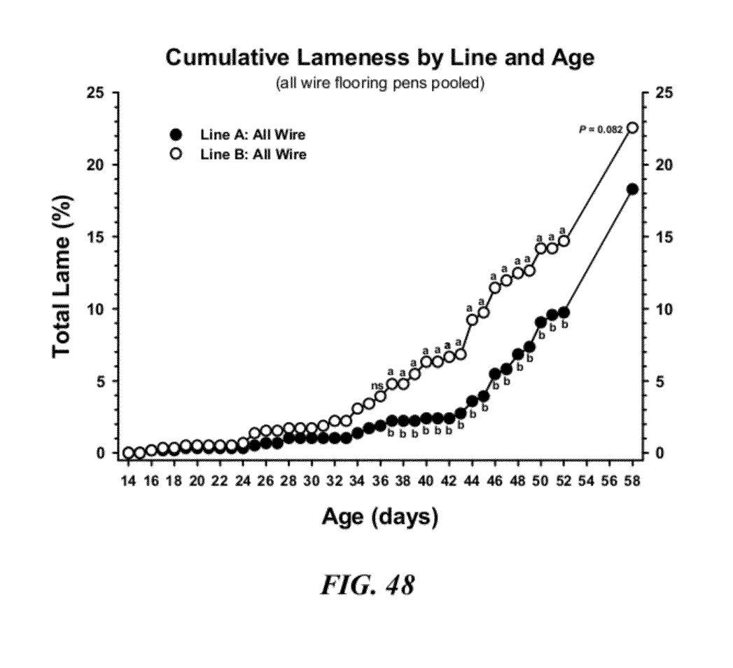

Non-lame mortality was not consistently attributable to floor treatment and therefore was pooled by line. SDS was the major cause of non-lame mortality (1.8% in Line A, 2.2% in Line B; overwhelmingly in males), followed by PHS/ascites (2.0% in Line A, 1.0% in Line B). Unknown causes of mortality (0.4% in each line) and culls for other reasons (0.8% in Line A, 0.4% in Line B) were minimal. Lameness not attributable to BCO (e.g., KB, TW, LAME-UNK, and TD) was minimal and did not differ between genders or lines. Lameness incidences are shown by consecutive pen number (genders pooled) in FIG. 45. Pen-to-pen variation obviously occurred, but within each line the lowest (numerical) incidences of lameness were recorded in floor litter pens and pens with pagoda top speed bumps. The highest lameness incidences for Line A clearly occurred in pens 12 and 17 with flat wire flooring. The highest (numerical) incidences for Line B occurred in pens 5 and 10 with nipple waterers suspended over 9″ speed bumps, and in pen 9 in which a 12″ speed bump was topped with a limbo bar (FIG. 45). Pooling the data by floor treatment (independent of gender, pen and line) confirmed that the lowest incidences of lameness occurred in pens with floor litter or pagoda topped speed bumps (FIG. 46). The highest incidences of lameness developed in pens with flat wire flooring, followed by pens with nipple waterers suspended over 9″ speed bumps or pens with 12″ speed bumps topped with limbo bars. The 9″ normal speed bumps increased overall lameness when compared with floor litter or Pagoda topped speed bumps, but the cumulative totals do not reflect consistent difference between pens with 9″ speed bumps vs. 9″ speed bumps plus limbo bars (FIG. 45 and FIG. 46). Within each line, the combined wire floor treatments (flat wire+all speed bumps pooled) caused significantly more lameness than litter alone, but the cumulative totals for these respective categories did not differ between lines (FIG. 47). Sub-dividing the wire floor treatments demonstrated that birds from Line B had equivalent susceptibilities to flat wire and speed bumps, whereas Line A was more susceptible to flat wire flooring and less susceptible to speed bumps (FIG. 47). The time course for cumulative lameness for birds grown on wire flooring (flat wire+all speed bumps pooled) is shown by line in FIG. 48. Beginning on day 37 and continuing through day 52, the broilers from Line B exhibited significantly more lameness than those from Line A. During the final week, the cumulative incidence of lameness for Line A began to converge on that of Line B (FIG. 48).

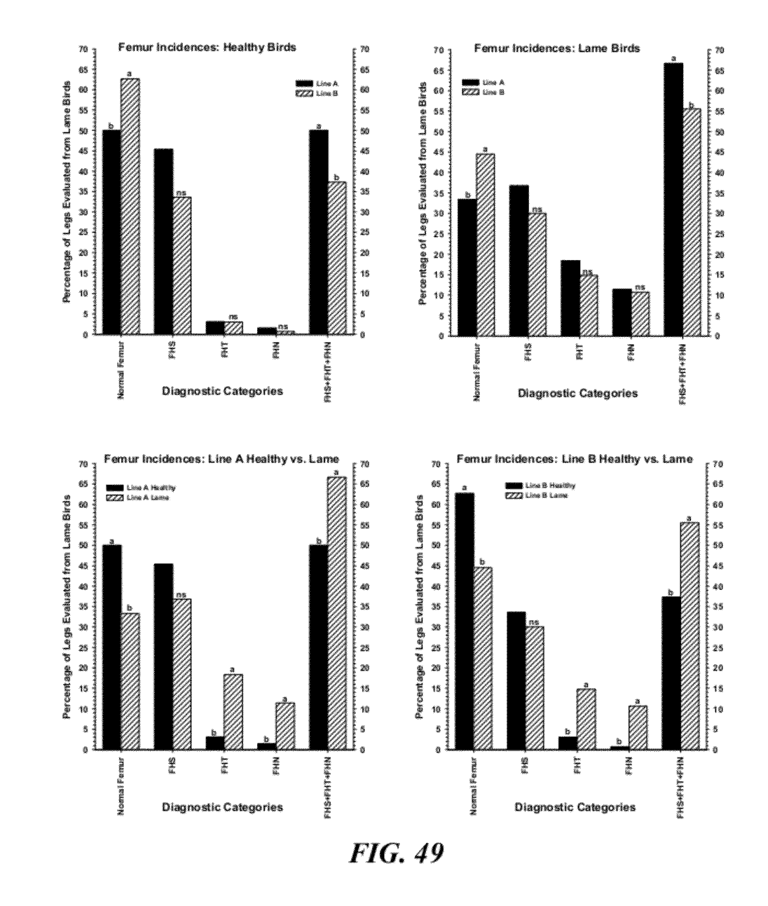

Femur lesion incidences are shown in FIG. 49 comparing: clinically healthy birds by line (upper left panel); lame birds by line (upper right panel); healthy vs. lame in Line A (lower left panel); and, healthy vs. lame in Line B (lower right panel). Both healthy and lame birds from Line A had significantly lower percentages of normal femora and higher percentages of femora with lesions (FHS+FHT+FHN) when compared with healthy and lame birds from Line B (FIG. 49, upper panels). Within each line, lame birds had significantly lower percentages of normal femora and higher percentages of FHT, FHN and FHS+FHT+FHN when compared with healthy birds (FIG. 49, lower panels). The most severe femoral head lesion categories clearly are associated with lameness in both lines.

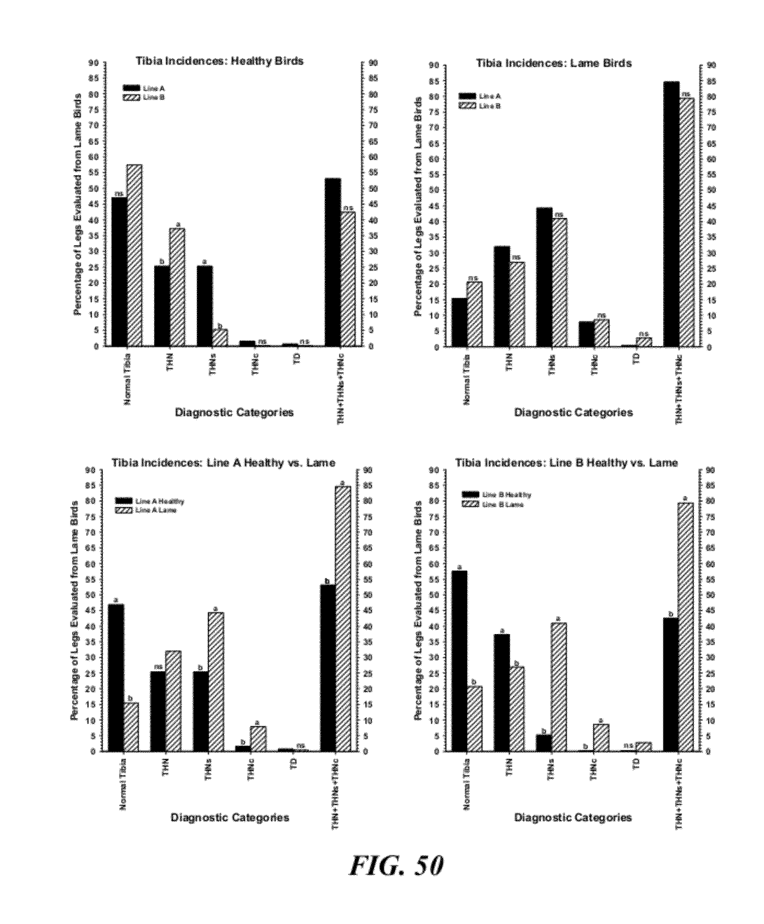

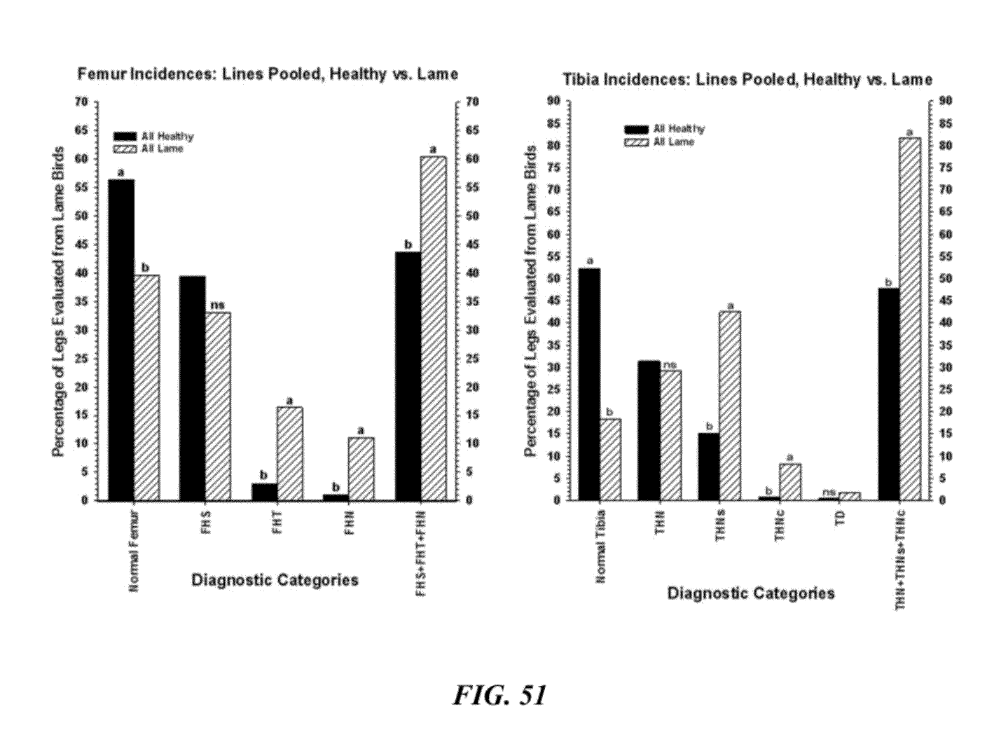

Tibial lesion incidences are shown in FIG. 50 comparing clinically healthy birds by line (upper left panel); lame birds by line (upper right panel); healthy vs. lame in Line A (lower left panel); and healthy vs. lame in Line B (lower right panel. Healthy birds from Line A had significantly lower percentages of THN and higher percentages of THNs when compared with healthy birds from Line B, whereas no difference in tibial lesion incidences was detected for line comparisons of lame birds (FIG. 50, upper panels). Within each line, lame birds had significantly lower percentages of normal tibiae and higher percentages of THNs, THNc and THN+THNs+THNc when compared with healthy birds (FIG. 50, lower panels). Severe lesions of the proximal heads of femora and tibiae clearly were associated with lameness in both lines (FIG. 51).

The results shown that birds from Line A developed significantly more lameness in pens with flat wire flooring and less lameness in pens with speed bumps, whereas for birds from Line B the incidences of lameness were similar in pens with flat wire flooring or speed bumps (FIG. 47). Line differences in susceptibility to wire flooring vs. speed bumps are demonstrated above, but the biological causes for these differences remain to be determined. It is hypothesized that flat wire flooring imposes an inescapable, severe challenge to broilers' legs, and furthermore that lack of access to litter triggers chronic stress. In contrast, speed bumps pose an intermittent, moderate challenge to broilers' legs, and in pens with speed bumps the birds have access to litter most of the time. To the extent that chronic stress and immunosuppression accelerate the progressive development of the most severe BCO lesions, then line differences in susceptibility to lameness on flat wire flooring vs. speed bumps potentially might be associated with differences in immunological responses and/or innate sensitivities to chronic stress and immunosuppression.

Line B developed significantly more Total Lameness (flat wire flooring+speed bumps) than Line A through day 52, but by the end of the experiment the incidence of lameness for Line B was only numerically higher than that for Line A (FIG. 48). Healthy and lame birds from Line A had higher percentages of total femoral lesions (mainly attributable to FHS) when compared with healthy and lame birds from Line B (FIG. 49, both upper panels). Across all of the tibial diagnostic categories only two significant differences were found in comparisons between lines (FIG. 50, both upper panels). The modestly higher prevalence of FHS, THN and THNs lesions per se in clinically healthy birds from Line A (FIG. 49 and FIG. 50, upper left panels) did not translate into significantly more overt lameness in Line A than in Line B (FIG. 47 and FIG. 48). The present and previous studies have conclusively demonstrated that overt lameness is consistently correlated with the development of the more severe categories of femoral (e.g., FHT, FHN) and tibial (e.g., THNs and THNc) lesions (FIG. 49 and FIG. 50, lower panels; FIG. 51). Accordingly, the possibility exists that Line A was innately more capable than Line B of attenuating the progressive deterioration of FHS and THN into the respectively more severe lesion categories that clearly do cause overt lameness. Similar inferences were proposed when Biomin's probiotics and DSM's 20-OH-Vitamin D₃ significantly reduced the incidence of clinical lameness without consistently affecting sub-clinical incidences of FHS or THN.

Whereas, the systems and methods have been described in relation to the drawings and claims, it should be understood that other and further modifications, apart from those shown or suggested herein, may be made within the spirit and scope of this invention.

What is claimed is:

1. A system for culling poultry, said system comprising:
a poultry rearing pen; and
at least one flooring challenge panel installed in said rearing pen; said flooring challenge panel constructed to induce unstable or insecure footing within said rearing pen in order to add torque, stress and strain on key joints of the legs of said poultry reared in said rearing pen.

2. The system of claim 1 wherein said flooring challenge panel is a flat panel, a sloping ramp, an A-Frame and/or a speed bump.

3. The system of claim 2 wherein said flooring challenge panel is portable.

4. The system of claim 2 wherein said flooring challenge panel is sloped at a predetermined angle in excess of 30%.

5. The system of claim 4 wherein said flooring challenge panel has an apex with a height between approximately 6 inches and approximately 12 inches.

6. The system of claim 2 wherein said flooring challenge panel further comprises:
a framework constructed of wood, metal, plastic and/or fiberglass; and
at least one covering comprised of metal, plastic, fiberglass, rubber, plastic coated wire, rubber coated wire and/or expanded metal mesh.

7. The system of claim 1 wherein said rearing pen further comprises at least one feeder and at least one waterer.

8. The system of claim 7 wherein said feeder is separated from said waterer in a manner to induce said poultry reared in said pen to traverse over said flooring challenge panel.

9. The system of claim 7 wherein said flooring challenge panel further comprises a device or overhanging structure for amplifying the challenge imposed on said legs of said poultry reared in said rearing pen.

10. The system of claim 9 wherein said device or overhanging structure is constructed to induce asymmetric twisting torque and lateral/side-to-side shear stresses on key joints of said legs of said poultry reared in said rearing pen.

11. The system of claim 10 wherein said device is constructed to induce said poultry reared in said rearing pen to stand upright while straddling opposing slopes near said apex of said flooring challenge panel.

12. The system of claim 9 wherein said device or overhanging structure is installed in said rearing pen a predetermined distance above an apex of said flooring challenge panel.

13. The system of claim 12 wherein said overhanging structure is a limbo bar or a pagoda top.

14. The system of claim 12 wherein said device is said waterers.

15. The system of claim 7 wherein said waterers are suspended a predetermined distance above an apex of said flooring challenge panel.

16. A flooring challenge system for inducing lameness attributable to osteochondrosis and osteomyelitis of the proximal femur and tibia in poultry, said flooring challenge system comprising:
a poultry rearing pen having at least one poultry attractant;
at least one flooring panel installed in said rearing pen; and
an overhanging device installed in said rearing pen a predetermined distance above an apex of said flooring panel;
wherein said flooring challenge system is constructed to induce unstable or insecure footing within said rearing pen in order to cause asymmetric twisting torque and lateral/side-to-side shear stresses on key joints of the legs of said poultry reared in said rearing pen.

17. The flooring challenge system of claim 16 wherein said flooring panel is a flat panel, a sloping ramp, an A-Frame and/or a speed bump.

18. The flooring challenge system of claim 17 wherein said flooring panel is portable.

19. The flooring challenge system of claim 16 wherein in said flooring panel is sloped at a predetermined angle in excess of 30%.

20. The flooring challenge system of claim 19 wherein said flooring panel has an apex with a height between approximately 6 inches and approximately 12 inches.

21. The flooring challenge system of claim 16 wherein said flooring panel further comprises:
a rigid framework constructed of wood, metal, plastic and/or fiberglass; and
at least one covering comprised of metal, plastic, fiberglass, rubber, plastic coated wire, rubber coated wire and/or expanded metal mesh.

22. The flooring challenge system of claim 16 wherein said poultry attractant further comprises at least one feeder and/or at least one waterer.

23. The flooring challenge system of claim 22 wherein said feeder is separated from said waterer in a manner to induce said poultry reared in said pen to traverse over said flooring panel and underneath said overhanging device.

24. The flooring challenge system of claim 23 wherein said overhanging device is a limbo bar or a pagoda top.

25. The flooring challenge system of claim 22 further comprising said overhanging device constructed to induce said poultry reared in said rearing pen to stand upright while straddling opposing slopes near an apex of said flooring panel.

26. The flooring challenge system of claim 25 wherein said overhanging device is an array of waterers.

27. A method of culling poultry, said method comprising the steps of:
a. installing at least one flooring challenge panel in an poultry rearing pen;
b. rearing said poultry in said pen with said panel installed therein;
c. inducing lameness attributable to osteochondrosis and osteomyelitis of the proximal femur and tibia in said poultry reared in said pen; and
d. after a suitable incidence of lameness has been induced, removing said panel from said pen.

28. The method of claim 27 further comprising the step of constructing said flooring challenge panel in the configuration selected from the group consisting of a flat panel, a sloping ramp, an A-Frame or a speed bump.

29. The method of claim 27 further comprising the step of controlling the relative incidence of lameness induced in step (c).

30. The method of claim 29 further comprising changing at least a portion of said flooring challenge panel to a sloping angle of about at least 30%.

31. The method of claim 27 further comprising the step of inducing said poultry to traverse over said flooring challenge panel installed in said pen.

32. The method of claim 27 further comprising the step of installing at least one overhanging device above said flooring challenge panel.

33. The method of claim 32 further comprising the step of separating a feeder and a waterer in said pen to induce said poultry to traverse over said panel and underneath said overhanging device installed in said pen.

34. The method of claim 32 further comprising the step of installing an array of nipple waterers a predetermined distance above an apex of said flooring challenge panel.

35. The method of claim 27 further comprising administering a therapeutically effective amount of a probiotic to said poultry while rearing said poultry in said pen with said flooring challenge panel installed therein in order to prevent or attenuate lameness.

36. The method of claim 27 further comprising administering a therapeutically effective amount of an antimicrobial to said poultry while rearing said poultry in said pen with said flooring challenge panel installed therein in order to prevent or attenuate lameness.
